(19) United States
(12) Patent Application Publication
(10) Pub. No.: US 2018/0226842 A1
(43) Pub. Date: Aug. 9, 2018

(54) POWER TRANSMITTING SYSTEM AND POWER TRANSMITTER

(71) Applicant: FUJITSU LIMITED, Kawasaki-shi (JP)

(72) Inventors: Akiyoshi UCHIDA, Akashi (JP); Kazuyuki OZAKI, Machida (JP)

(73) Assignee: FUJITSU LIMITED, Kawasaki-shi (JP)

(21) Appl. No.: 15/945,046

(22) Filed: Apr. 4, 2018

Related U.S. Application Data
(63) Continuation of application No. PCT/JP2015/078758, filed on Oct. 9, 2015.

(51) Int. Cl. H02J 50/80; H02J 50/40; H02J 50/12; H02J 7/02

(52) U.S. Cl. CPC H02J 50/80; H02J 7/025; H02J 50/12; H02J 50/40

(57) ABSTRACT

A power transmitting system includes a power transmitter; and power receivers each of which includes a secondary-side resonant coil; and an adjuster configured to adjust an amount of electric power received by the coil. The power transmitter includes a primary-side resonant coil configured to transmit, to the power receivers, electric power; a determination unit configured to determine, based on electric power data related to a rated electric power and received electric power, whether a power receiver whose received electric power is excessive and a power receiver whose received electric power is insufficient are present; and a command output unit configured, upon determining that the power receiver whose received electric power is excessive and the power receiver whose received electric power is insufficient are present, to transmit, to the power receiver whose received electric power is excessive, a command to the adjuster to decrease the amount of the electric power.

### CROSS-REFERENCE TO RELATED APPLICATION

This application is a continuation application of International Application PCT/JP2015/078758 filed on Oct. 9, 2015 and designated the U.S., the entire contents of which are incorporated herein by reference.

### FIELD

The embodiments discussed herein relate to a power transmitting system and a power transmitter.

### BACKGROUND

Conventionally, there exists a non-contact charging apparatus that includes a charging part that is able to charge a plurality of electronic devices in one batch by a non-contact charging method. The non-contact charging apparatus includes an obtaining unit that obtains device information for each of the plurality of electronic devices, and a determination unit that determines whether the electronic devices are ready to be charged in one batch based on the device information obtained by the obtaining unit.

The non-contact charging apparatus includes a charging control unit and a first report unit. In a case where the determination unit determines that all the plurality of electronic devices are ready to be charged in one batch, the charging control unit performs charging in one batch. In a case where the determination unit determines that at least one of the plurality of electronic devices is not ready to be charged in one batch, the first report unit specifies and notifies the least one of the plurality of electronic devices.

In addition, the obtaining unit further obtains, as the device information of the electronic device, reception sensitivity of the reception function for each electronic device. In a case where the determination unit determines that all the plurality of electronic devices are ready to be charged in one batch, the charging control unit performs charging in one batch and determines a charging speed of the charging part based on the reception sensitivity obtained by the obtaining unit (for example, see Patent Document 1).

Because the conventional non-contact charging apparatus determines the charging speed of the charging part based on the reception sensitivity, the charging speed may be slow depending on the reception sensitivity, and there may be a case in which the conventional non-contact charging apparatus cannot perform charging efficiently.

### RELATED-ART DOCUMENTS

### Patent Documents

[Patent Document 1] Japanese Laid-open Patent Publication No. 2011-120361

### SUMMARY

According to an aspect of the embodiments, a power transmitting system includes a power transmitter configured to transmit electric power; and a plurality of power receivers configured to simultaneously receive the electric power from the power transmitter through magnetic field resonance or electric field resonance. Each of the plurality of power receivers includes a secondary-side resonant coil; an adjuster configured to adjust an amount of electric power received by the secondary-side resonant coil; and a power receiving side communication unit configured to perform communication with the power transmitter. The power transmitter includes a primary-side resonant coil configured to transmit, to the secondary-side resonant coil of each of the plurality of power receivers, the electric power through magnetic field resonance or electric field resonance; a power transmitting side communication unit that is able to communicate with the plurality of power receivers; a determination unit configured to determine, based on electric power data related to a rated electric power and received electric power received from each of the plurality of power receivers, whether a power receiver whose received electric power is excessive and a power receiver whose received electric power is insufficient are present; and a command output unit configured, upon the determination unit determining that the power receiver whose received electric power is excessive and the power receiver whose received electric power is insufficient are present, to transmit, to the power receiver whose received electric power is excessive via the power transmitting side communication unit, a command to cause the adjuster to decrease the amount of the electric power.

The object and advantages of the invention will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF DRAWINGS

FIG. 1 is a diagram illustrating a power transmitting system;

FIG. 2 is a diagram illustrating a state in which electric power is transmitted from a power transmitter to electronic devices through magnetic field resonance;

FIG. 3 is a diagram illustrating a state in which electric power is transmitted from the power transmitter to electronic devices through magnetic field resonance;

FIG. 4 is a diagram illustrating a power transmitting apparatus and a power receiver according to a first embodiment;

FIG. 5 is a diagram illustrating electronic devices and the power transmitting apparatus using a power transmitting system according to the first embodiment;

FIG. 6 is a diagram illustrating a relationship between duty cycles of PWM drive patterns and amounts of received electric power of power receivers;

FIG. 7 is a diagram illustrating a relationship between the duty cycle of the PWM drive pattern and the received electric power in the power receiver;

FIG. 8 is a diagram illustrating a configuration of a controller of the power receiver;

FIG. 9 is a diagram illustrating data that is stored in a memory of the power receiver;

FIG. 10 is a diagram illustrating a data structure of electric power data and excess degree data;

FIG. 11 is a diagram illustrating a data structure of adjustment commands that are stored in the memory of the power receiver;

FIG. 12 is a diagram illustrating a configuration of a controller of the power transmitter;

FIG. 13 is a flowchart illustrating a process that is executed by the power transmitter and each power receiver of the power transmitting system according to the first embodiment;

FIGS. 14A to 14D are diagrams illustrating a case in which received electric power of the power receivers is adjusted by the power transmitter of the power transmitting system according to the first embodiment;

FIGS. 15A to 15F are diagrams illustrating a case in which received electric power of the power receivers is adjusted by the power transmitter of the power transmitting system according to the first embodiment;

FIGS. 16A to 16E are diagrams illustrating a case in which received electric power of the power receivers is adjusted by the power transmitter of the power transmitting system according to the first embodiment;

FIGS. 17A to 17E are diagrams illustrating a case in which received electric power of the power receivers is adjusted by the power transmitter of the power transmitting system according to the first embodiment;

FIG. 18 is a diagram illustrating a power receiver according to a first variation example of the first embodiment;

FIG. 19 is a diagram illustrating a power receiver and a power transmitting apparatus according to a second variation example of the first embodiment;

FIG. 20 is a diagram illustrating an internal configuration of a controller of the power receiver according to the second variation example of the first embodiment;

FIG. 21 is a diagram illustrating current paths in a capacitor and an adjuster of the power receiver according to the second variation example of the first embodiment;

FIGS. 22A and 22B are diagrams illustrating two clock signals included in a driving signal and an AC voltage generated in the secondary-side resonant coil of the power receiver according to the second variation example of the first embodiment;

FIG. 23 is a diagram illustrating a simulation result indicating a property of efficiency of electric power reception with respect to a phase difference of the driving signal;

FIG. 24 is a diagram illustrating a relationship between phase differences of the driving signal and the efficiencies of electric power reception of two power receivers;

FIG. 25 is a schematic diagram illustrating a magnetic field resonance type power transmitting system according to a third variation example of the first embodiment;

FIG. 26 is a diagram illustrating a frequency dependency of the power transmitting system;

FIG. 27 is a diagram that describes a method of sweeping a resonant frequency of a coil;

FIG. 28 is a diagram illustrating an example of a controller configuration of the power transmitting system according to the third variation example of the first embodiment;

FIG. 29 is a diagram illustrating a circuit configuration of a bridge type balance circuit of a power receiver according to the third variation example of the first embodiment;

FIG. 30 is a diagram illustrating waveforms of control signals for driving the bridge type balance circuit of the power receiver according to the third variation example of the first embodiment;

FIG. 31 is a diagram illustrating waveforms of control signals for driving the bridge type balance circuit of the power receiver according to the third variation example of the first embodiment;

FIG. 32 is a diagram illustrating waveforms of control signals for driving the bridge type balance circuit of the power receiver according to the third variation example of the first embodiment;

FIG. 33 is a flowchart illustrating a process that is executed by a power transmitter and each power receiver according to a second embodiment;

FIGS. 34A to 34D are diagrams illustrating a case in which received electric power of the power receivers is adjusted by the power transmitter and the power transmitting system according to the second embodiment;

FIG. 35 is a flowchart illustrating a process that is executed by a power transmitter and each power receiver according to a third embodiment; and

FIGS. 36A to 36D are diagrams illustrating a case in which received electric power of the power receivers is adjusted by the power transmitter and the power transmitting system according to the third embodiment.

### DESCRIPTION OF EMBODIMENT

Hereinafter, embodiments, to which power receivers, power transmitters, and power transmitting systems of the present invention are applied, will be described. An object is to provide a power transmitter and a power transmitting system that can adjust efficiently charge power receivers.

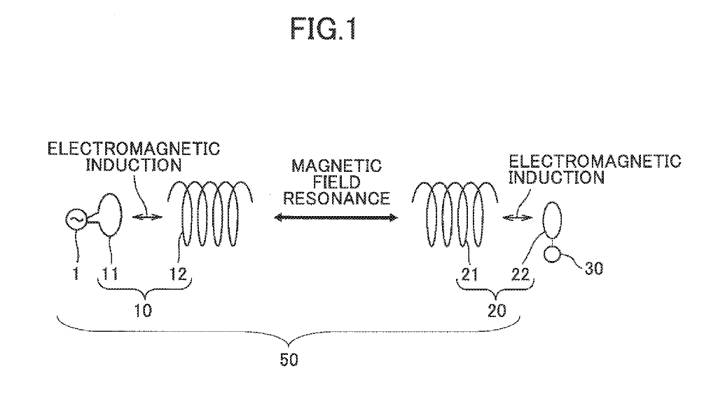

Before describing first to third embodiments, to which power receivers, power transmitters, and power transmitting systems of the present invention are applied, a technical premise of the power receivers, the power transmitters, and the power transmitting systems according to the first to third embodiments will be described with reference to FIG. 1 to FIG. 3.

FIG. 1 is a diagram illustrating a power transmitting system 50.

As illustrated in FIG. 1, the power transmitting system 50 includes an alternating-current (AC) power source 1, a primary-side (power transmitting side) power transmitter 10, and a secondary-side (power receiving side) power receiver 20. The power transmitting system 50 may include a plurality of power transmitters 10 and a plurality of power receivers 20.

The power transmitter 10 includes a primary-side coil 11 and a primary-side resonant coil 12. The power receiver 20 includes a secondary-side resonant coil 21 and a secondary-side coil 22. A load device 30 is coupled to the secondary-side coil 22.

As illustrated in FIG. 1, the power transmitter 10 and the power receiver 20 perform transmission of energy (electric power) from the power transmitter 10 to the power receiver 20 through magnetic field resonance (magnetic-field sympathetic vibration) between the primary-side resonant coil (LC resonator) 12 and the power receiving resonant coil (LC resonator) 21. Here, the electric power can be transmitted from the primary-side resonant coil 12 to the secondary-side resonant coil 21 by not only the magnetic field resonance but also by electric field resonance (electric field sympathetic vibration) or the like. In the following description, the magnetic field resonance will be mainly described as an example.

In the first embodiment, for example, a case is described where a frequency of an AC voltage that the AC power source 1 outputs is 6.78 MHz and a resonant frequency of the primary-side resonant coil 12 and the secondary-side resonant coil 21 is 6.78 MHz.

Note that the electric power transmission from the primary-side coil 11 to the primary-side resonant coil 12 is performed by utilizing electromagnetic induction. Also, the electric power transmission from the secondary-side resonant coil 21 to the secondary-side coil 22 is also performed by utilizing electromagnetic induction.

Although FIG. 1 illustrates a configuration in which the power transmitting system 50 includes the secondary-side coil 22, the power transmitting system 50 is not required to include the secondary-side coil 22. In this case, the load device 30 may be directly coupled to the secondary-side resonant coil 21.

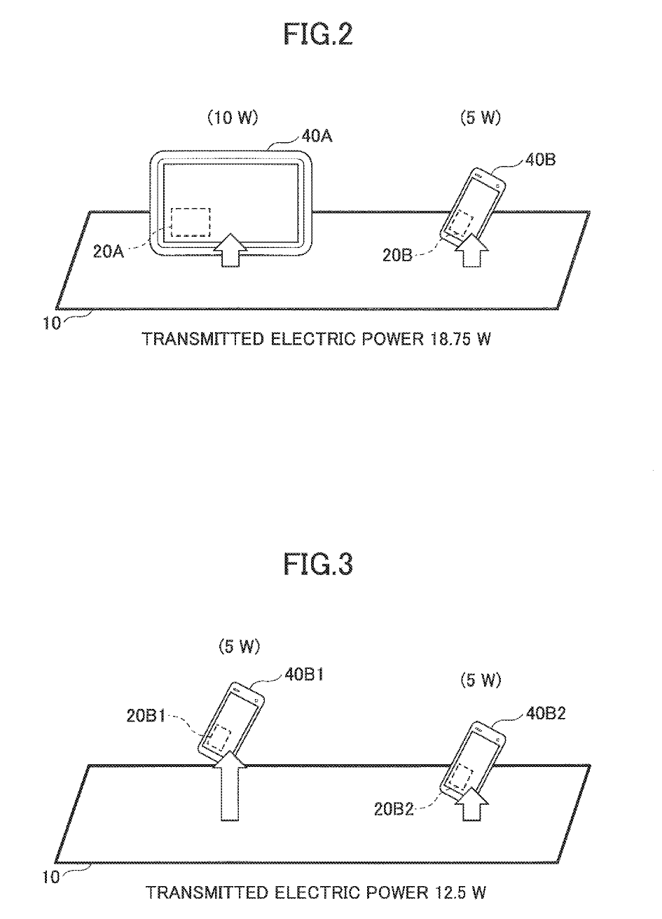

FIG. 2 is a diagram illustrating a state where electric power is transmitted from the power transmitter 10 to electronic devices 40A and 40B through magnetic field resonance.

The electronic devices 40A and 40B are a tablet computer and a smartphone, respectively, and include power receivers 20A and 20B, respectively. Each of the power receivers 20A and 20B has a configuration where the secondary-side coil 22 is removed from the power receiver 20 (see FIG. 1) illustrated in FIG. 1. That is, each of the power receivers 20A and 20B includes the secondary-side resonant coil 21. Note that although the power transmitter 10 is illustrated in a simplified manner in FIG. 2, the power transmitter 10 is coupled to the AC power source 1 (see FIG. 1).

In FIG. 2, each of the electronic devices 40A and 40B is arranged at an equal distance from the power transmitter 10. The power receivers 20A and 20B included in the respective electronic devices 40A and 40B simultaneously receive the electric power from the power transmitter 10 through the magnetic field resonance in a non-contact state.

Here, for example, in a state illustrated in FIG. 2, an efficiency of electric power reception of the power receiver 20A included in the electronic device 40A is 40%, and an efficiency of electric power reception of the power receiver 20B included in the electronic device 40B is 40%.

The respective efficiencies of electric power reception of the power receivers 20A and 20B are expressed as ratios of electric power received by the secondary-side coils 22 of the power receivers 20A and 20B, with respect to electric power transmitted from the primary-side coil 11 coupled to the AC power source 1. Note that in a case where the primary-side resonant coil 12 is directly coupled to the AC power source 1 and the power transmitter 10 does not include the primary-side coil 11, the received electric power may be calculated by using electric power transmitted from the primary-side resonant coil 12 instead of using the electric power transmitted from the primary-side coil 11. In a case where the power receivers 20A and 20B do not include the secondary-side coil 22, received electric power may be calculated by using electric power received by the secondary-side resonant coil 21 instead of using the electric power received by the secondary-side coil 22.

The efficiency of electric power reception of the power receiver 20A and the efficiency of electric power reception of the power receiver 20B are determined depending on specifications of the coils of the power receivers 20A and 20B and of the power transmitter 10 and on distances/orientations between the power transmitter 10 and the respective power receivers 20A and 20B. In FIG. 2, because the power receivers 20A and 20B have the same configuration and are arranged at positions of equal distance/orientation from the power transmitter 10, the efficiency of electric power reception of the power receiver 20A and the efficiency of electric power reception of the power receiver 20B are equal to each other and, as an example, at 40%.

Further, a rated output (rated electric power) of the electronic device 40A is taken as 10 W and a rated output (rated electric power) of the electronic device 40B is taken as 5 W.

In such a case, electric power transmitted from the primary-side resonant coil 12 (see FIG. 1) of the power transmitter 10 is 18.75 W. Here, 18. 75 W can be calculated by a formula of (10 W+5 W)/(40%+40%).

When electric power of 18.75 W is transmitted to the electronic devices 40A and 40B from the power transmitter 10, the power receivers 20A and 20B receive electric power of 15 W in total. Because the power receivers 20A and 20B equally receive the electric power, each of the power receivers 20A and 20B receives electric power of 7.5 W.

As a result, electric power to the electronic device 40A is insufficient by 2.5 W, and electric power to the electronic device 40B is excessive by 2.5 W.

That is, even when electric power of 18.75 W is transmitted from the power transmitter 10 to the electronic devices 40A and 40B, the electronic devices 40A and 40B cannot receive the electric power in a balanced manner. In other words, when the electronic devices 40A and 40B simultaneously receive electric power, the supply balance of electric power is not good.

FIG. 3 is a diagram illustrating a state where electric power is transmitted from the power transmitter 10 to electronic devices 40B1 and 40B2 through magnetic field resonance.

The electronic devices 40B1 and 40B2 are the same type of smartphone and respectively include power receivers 20B1 and 20B2. Each of the power receivers 20B1 and 20B2 is equal to the power receiver 20B illustrated in FIG. 2. That is, each of the power receivers 20B1 and 20B2 includes the secondary-side resonant coil 21. Although a power transmitter 10 is illustrated in a simplified manner in FIG. 3, the power transmitter 10 is coupled to the AC power source 1 (see FIG. 1).

In FIG. 3, an angle (an orientation) of the electronic device 40B1 with respect to the power transmitter 10 is equal to an angle (an orientation) of the electronic device 40B2 with respect to the power transmitter 10. However, the electronic device 40B1 is arranged further away from the power transmitter 10 than the electronic device 40B2 is. The power receivers 20B1 and 20B2 included in the respective electronic devices 40B1 and 40B2 simultaneously receive electric power from the power transmitter 10 through the magnetic field resonance in a non-contact state.

For example, in the state illustrated in FIG. 3, an efficiency of electric power reception of the power receiver 20B1 included in the electronic device 40B1 is 35%, and an efficiency of electric power reception of the power receiver 20B2 included in the electronic device 40B2 is 45%.

Here, because the angle (the orientation) of the electronic device 40B1 with respect to the power transmitter 10 and the angle (the orientation) of the electronic device 40B2 with respect to the power transmitter 10 are equal to each other, the efficiency of electric power reception of the power receiver 20B1 and the efficiency of electric power reception of the power receiver 20B2 are determined depending on distances between the power transmitter 10 and the respective power receivers 20B1 and 20B2. Thus, in FIG. 3, the efficiency of electric power reception of the power receiver 20B1 is lower than the efficiency of electric power reception of the power receiver 20B2. Note that both the rated output of the electronic device 40B1 and the rated output of the electronic device 40B2 are 5 W.

In such a case, electric power transmitted from the primary-side resonant coil 12 (see FIG. 1) of the power transmitter 10 is 12.5 W. Here, 12. 5 W can be calculated by a formula of (5 W+5 W)/(35%+45%).

When electric power of 12.5 W is transmitted to the electronic devices 40B1 and 40B2 from the power transmitter 10, the power receivers 20B1 and 20B2 receive electric power of 10 W in total. Further, because the efficiency of electric power reception of the power receiver 20B1 is 35%, and the efficiency of electric power reception of the power receiver 20B2 is 45% in FIG. 3, the power receiver 20B1 receives electric power of about 4.4 W and the power receiver 20B2 receives electric power of about 5.6 W.

As a result, electric power to the electronic device 40B1 is insufficient by about 0.6 W, and electric power to the electronic device 40B2 is excessive by about 0.6 W.

That is, even when electric power of 12.5 W is transmitted from the power transmitter 10 to the electronic devices 40B1 and 40B2, the electronic devices 40B1 and 40B2 cannot receive electric power in a balanced manner. In other words, when the electronic devices 40B1 and 40B2 simultaneously receive electric power, the supply balance of electric power is not good (has scope for improvement).

Here, in the above description of the supply balance of electric power, the angles (orientations) of the electronic devices 40B1 and 40B2 with respect to the power transmitter 10 are the same and the distances from the power transmitter 10 to the electronic devices 40B1 and 40B2 are different.

However, because the efficiencies of electric power reception are determined depending on the angles (orientations) and the distances between the power receivers 20B1 and 20B2 and the power transmitter 10, the efficiency of electric power reception of the power receiver 20B1 and the efficiency of electric power reception of the power receiver 20B2 become values different from the above described 35% and 45% when angles (orientations) of the electronic devices 40B1 and 40B2 are different from a positional relationship illustrated in FIG. 3.

The efficiency of electric power reception of the power receiver 20B1 and the efficiency of electric power reception of the power receiver 20B2 become different values from each other when angles (orientations) of the electronic devices 40B1 and 40B2, with respect to the power transmitter 10, are different even if the distances from the power transmitter 10 to the electronic devices 40B1 and 40B2 are equal to each other.

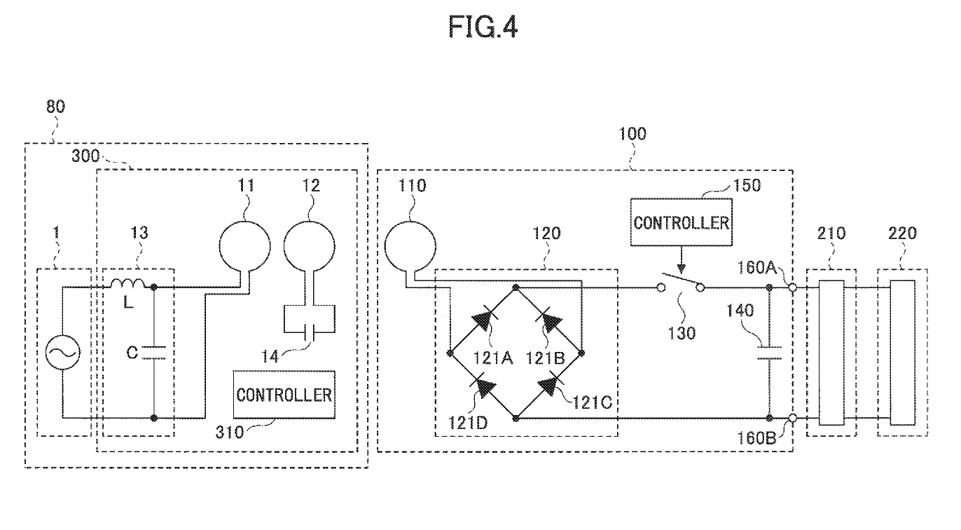

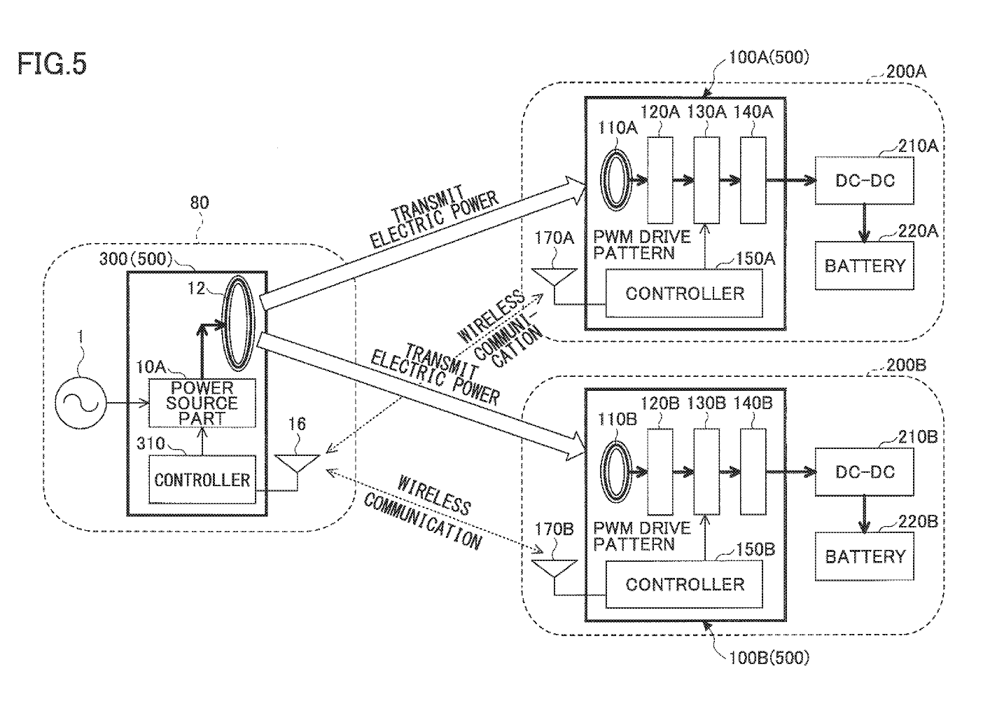

Next, a power transmitting system and a power receiver 100 according to the first embodiment will be described with reference to FIG. 4 and FIG. 5.

FIG. 4 is a diagram illustrating a power transmitting apparatus 80 and the power receiver 100 according to the first embodiment. The power transmitting apparatus 80 includes an alternating-current (AC) power source 1 and a power transmitter 300. The AC power source 1 is similar to that illustrated in FIG. 1.

The power transmitting apparatus 80 includes the AC power source 1 and the power transmitter 300.

The power transmitter 300 includes a primary-side coil 11, a primary-side resonant coil 12, a matching circuit 13, a capacitor 14, and a controller 310.

The power receiver 100 includes a secondary-side resonant coil 110, a rectifier circuit 120, a switch 130, a smoothing capacitor 140, a controller 150, and output terminals 160A and 160B. A DC-DC converter 210 is coupled to the output terminals 160A and 160B, and a battery 220 is coupled to an output side of the DC-DC converter 210. In FIG. 4, a load circuit is the battery 220.

First, the power transmitter 300 will be described. As illustrated in FIG. 4, the primary-side coil 11 is a loop-shaped coil, and is coupled to the AC power source 1 via the matching circuit 13 between two ends of the primary-side coil 11. The primary-side coil 11 is disposed close to but not in contact with the primary-side resonant coil 12. The primary-side coil 11 is electromagnetically coupled to the primary-side resonant coil 12. The primary-side coil 11 is disposed such that the central axis of the primary-side coil 11 matches the central axis of the primary-side resonant coil 12. The central axis of the primary-side coil 11 and the central axis of the primary-side resonant coil 12 are made to match each other in order to inhibit leakage of magnetic flux and to inhibit unnecessary generation of magnetic fields around the primary-side coil 11 and the primary-side resonant coil 12, as well as improving the coupling strength between the primary-side coil 11 and the primary-side resonant coil 12.

The primary-side coil 11 generates magnetic fields by alternating-current (AC) power supplied from the AC power source 1 via the matching circuit 13, and transmits the electric power to the primary-side resonant coil 12 by electromagnetic induction (mutual induction).

As illustrated in FIG. 4, the primary-side resonant coil 12 is disposed close to but not in contact with the primary-side coil 11. The primary-side resonant coil 12 is electromagnetically coupled to the primary-side coil 11. Further, the primary-side resonant coil 12 has a predetermined resonant frequency and is designed to have a very high Q factor. The resonant frequency of the primary-side resonant coil 12 is set to be equal to the resonant frequency of the secondary-side resonant coil 110. The capacitor 14 for adjusting the resonant frequency is coupled in series between the two ends of the primary-side resonant coil 12.

The resonant frequency of the primary-side resonant coil 12 is set to be equal to the frequency of the AC power that the AC power source 1 outputs. The resonant frequency of the primary-side resonant coil 12 is determined depending on an electrostatic capacitance of the capacitor 14 and an inductance of the primary-side resonant coil 12. Hence, the electrostatic capacitance of the capacitor 14 and the inductance of the primary-side resonant coil 12 are set such that the resonant frequency of the primary-side resonant coil 12 is equal to the frequency of the AC power output from the AC power source 1.

The matching circuit 13 is inserted for impedance matching between the primary-side coil 11 and the AC power source 1, and includes an inductor L and a capacitor C.

The AC power source 1 is a power source that outputs AC power having a frequency necessary for the magnetic field resonance, and includes an amplifier that amplifies the output power. The AC power source 1 may, for example, output high frequency AC power from several hundreds of kHz to several tens of MHz.

The capacitor 14 is a variable capacitance capacitor inserted in series between the two ends of the primary-side resonant coil 12. The capacitor 14 is disposed for adjusting the resonant frequency of the primary-side resonant coil 12. The electrostatic capacitance of the capacitor 14 is set by the controller 310.

The controller 310 controls the output frequency and the output voltage of the AC power source 1 and controls the electrostatic capacitance of the capacitor 14. Also, the controller 310 controls an amount of electric power (output) transmitted from the primary-side resonant coil 12 and sets duty cycles of the power receivers 100A and 100B.

The power transmitting apparatus 80 as described above transmits, to the primary-side resonant coil 12 through magnetic induction, AC power supplied from the AC power source 1 to the primary-side coil 11, and transmits the electric power from the primary-side resonant coil 12 to the secondary-side resonant coil 110 of the power receiver 100 through magnetic field resonance.

Next, the secondary-side resonant coil 110 included in the power receiver 100 will be described.

The secondary-side resonant coil 110 has a resonant frequency equal to that of the primary-side resonant coil 12, and is designed to have a very high Q factor. A pair of terminals of the secondary-side resonant coil 110 is coupled to the rectifier circuit 120.

The secondary-side resonant coil 110 outputs, to the rectifier circuit 120, the AC power transmitted from the primary-side resonant coil 12 of the power transmitter 300 through the magnetic field resonance.

The rectifier circuit 120 includes four diodes 121A to 121D. The diodes 121A to 121D are coupled in a bridge-like configuration, and rectify the full wave of the electric power input from the secondary-side resonant coil 110 to output the full-wave rectified power.

The switch 130 is inserted in series on the high potential side line (the upper side line in FIG. 4) of the pair of lines that couple the rectifier circuit 120 to the smoothing capacitor 140. For example, the switch 130 may be a switch that can perform transmission and cutoff of DC voltage at high speed such as a FET.

The electric power on which the full wave rectification has been performed by the rectifier circuit 120 is input to the switch 130. Because the full-wave rectified power can be treated as direct-current power, the switch 130 may be a switch for direct-current. Because a switch having a simple structure such as a FET can be used for the switch 130 for direct-current, the switch 130 can be size-reduced. Here, as switches for alternating-current, there are switches using FETs, a relay, and a TRIAC. Because a relay is a mechanical switch, its size is large and there may be a durability issue in switching the relay at high speed. Also, a TRIAC is unsuitable for high speed switching such as 6.78 MHz. Also, because of including a plurality of FETs, the switch for alternating-current using the FETs is larger than the FET for direct-current, and effects that parasitic capacitance gives to alternating-current occur. Due to the above described reasons, there are advantages regarding use of FET for alternating-current as the switch 130 for size-reduction and for preventing the effects of parasitic capacitance.

Although details of a driving pattern of the switch 130 will be described later below, the switch 130 is driven by the controller 150 through Pulse Width Modulation (PWM). A duty cycle of the PWM drive pattern of the switch 130 is determined based on an adjustment command that is transmitted from the power transmitting apparatus 80. The adjustment command, which is transmitted from the power transmitting apparatus 80 will be described later below.

Further, a frequency of the PWM drive pattern is set to be a frequency less than or equal to an alternating-current frequency at which the secondary-side resonant coil 110 receives electric power.

The smoothing capacitor 140 is coupled to the output side of the rectifier circuit 120, and smoothes the electric power, on which the full-wave rectification is performed by the rectifier circuit 120, and outputs the smoothed power as direct-current power. The output terminals 160A and 160B are coupled to the output side of the smoothing capacitor 140. Because the negative component of AC power has been inverted into the positive component, the electric power on which the full-wave rectification has been performed by the rectifier circuit 120 can be treated as substantially AC power. However, stable DC power can be obtained by using the smoothing capacitor 140 even when ripple is included in the full wave rectified power.

The DC-DC converter 210 is coupled to the output terminals 160A and 160B, and converts the voltage of the direct-current power that is output from the power receiver 100 into the rated voltage of the battery 220 to output the converted voltage. The DC-DC converter 210 lowers the output voltage of the rectifier circuit 120 to the rated voltage of the battery 220 in a case where the output voltage of the rectifier circuit 120 is higher than the rated voltage of the battery 220. The DC-DC converter 210 raises the output voltage of the rectifier circuit 120 to the rated voltage of the battery 220 in a case where the output voltage of the rectifier circuit 120 is lower than the rated voltage of the battery 220.

The battery 220 may be any rechargeable secondary battery that can be repeatedly charged. For example, a lithium ion battery may be used as the battery 220. For example, in a case where the power receiver 100 is included in an electronic device such as a tablet computer or a smartphone, the battery 220 is a main battery of such an electronic device.

In the power transmitting system according to the first embodiment, the power transmitter 300 requests charging rate data from the power receiver 100. The charging rate data is data that indicates a charging rate of the battery 220.

There are various methods for obtaining the charging rate of the battery 220. For example, the charging rate can be calculated by a controller included in the battery 220 based on a voltage between the positive terminal and the negative terminal of the battery 220 with reference to data that indicates a relationship between the voltage between the terminals and the charging rate. In this case, a value of current that flows in the positive terminal or the negative terminal may be used. The charging rate of the battery 220 may be calculated by any calculation method. Also, the battery 220 may transmit, to the controller 150, data indicating the voltage between the terminals as charging rate data, and the controller 150 may calculate the charging rate from the voltage between the terminals.

For example, the primary-side coil 11, the primary-side resonant coil 12, and the secondary-side resonant coil 110 may be made by winding copper wire. However, materials of the primary-side coil 11, the primary-side resonant coil 12, and the secondary-side resonant coil 110 may be metal other than copper (e.g., gold, aluminum, etc.). Further, materials of the primary-side coil 11, the primary-side resonant coil 12, and the secondary-side resonant coil 110 may be different from one another.

In such a configuration, the primary-side coil 11 and the primary-side resonant coil 12 correspond to a power transmitting side, and the secondary-side resonant coil 110 corresponds to a power receiving side.

According to a magnetic field resonance system, magnetic field resonance, generated between the primary-side resonant coil 12 and the secondary-side resonant coil 110, is utilized to transmit electric power from the power transmitting side to the power receiving side. Hence, it is possible to transmit the electric power over a longer distance than that of an electromagnetic induction system that utilizes electromagnetic induction to transmit electric power from the power transmitting side to the power receiving side.

The magnetic field resonance system is more flexible than the electromagnetic induction system with respect to the position gap or the distance between the resonant coils. The magnetic field resonance system thus has an advantage called “free-positioning”.

FIG. 5 is a diagram illustrating electronic devices 200A and 200B and the power transmitting apparatus 80 using a power transmitting system 500 according to the first embodiment.

Although the power transmitting apparatus 80 in FIG. 5 is the same as the power transmitting apparatus 80 illustrated in FIG. 4, configuration elements other than the primary-side coil 11, the controller 310 and the antenna 16 in FIG. 4 are expressed as a power source part 10A. The power source part 10A expresses the primary-side resonant coil 12, the matching circuit 13, and the capacitor 14 collectively. Note that the AC power source 1, the primary-side resonant coil 12, the matching circuit 13, and the capacitor 14 may be treated as the power source part collectively.

The power transmitting apparatus 80 further includes an antenna 16. For example, the antenna 16 may be any antenna that can perform wireless communication in a short distance such as Bluetooth (registered trade mark). The antenna 16 is provided in order to receive, from the power receivers 100A and 100B included in the electronic devices 200A and 200B, data indicating excess/insufficiency or the like of received electric power. The received data is input to the controller 310.

Each of the electronic devices 200A and 200B may be a terminal device such as a tablet computer or a smartphone, for example. The electronic devices 200A and 200B respectively include the power receivers 100A and 100B, DC-DC converters 210A and 210B, and batteries 220A and 220B.

The power receivers 100A and 100B have configurations obtained by adding antennas 170A and 170B to the power receiver 100, which is illustrated in FIG. 4. Each of the DC-DC converters 210A and 210B is similar to the DC-DC converter 210 illustrated in FIG. 4. Further, each of the batteries 220A and 220B is similar to the battery 220 illustrated in FIG. 4.

The power receiver 100A includes a secondary-side resonant coil 110A, a rectifier circuit 120A, a switch 130A, a smoothing capacitor 140A, a controller 150A, and an antenna 170A. The secondary-side resonant coil 110A, the rectifier circuit 120A, the switch 130A, the smoothing capacitor 140A, and the controller 150A respectively correspond to the secondary-side resonant coil 110, the rectifier circuit 120, the switch 130, the smoothing capacitor 140, and the controller 150, which are illustrated in FIG. 4. Note that, in FIG. 5, the secondary-side resonant coil 110A, the rectifier circuit 120A, the switch 130A and the smoothing capacitor 140A are illustrated in a simplified manner, and the output terminals 160A and 160B are omitted.

The power receiver 100B includes a secondary-side resonant coil 110B, a rectifier circuit 120B, a switch 130B, a smoothing capacitor 140B, a controller 150B, and an antenna 170B. The secondary-side resonant coil 110B, the rectifier circuit 120B, the switch 130B, the smoothing capacitor 140B, and the controller 150B respectively correspond to the secondary-side resonant coil 110, the rectifier circuit 120, the switch 130, the smoothing capacitor 140, and the controller 150, which are illustrated in FIG. 4. Note that, in FIG. 5, the secondary-side resonant coil 110B, the rectifier circuit 120B, the switch 130B, and the smoothing capacitor 140B are illustrated in a simplified manner, and the output terminals 160A and 160B are omitted.

For example, the antennas 170A and 170B may be any antenna that can perform wireless communication in a short distance such as Bluetooth (registered trade mark). The antennas 170A and 170B are provided in order to perform data communication with the antenna 16 of the power transmitter 300. The antennas 170A and 170B are coupled to the controllers 150A and 150B of the power receivers 100A and 100B, respectively. The controllers 150A and 150B are examples of a drive controller.

The controller 150A of the power receiver 100A transmits, to the power transmitter 300 via the antenna 170A, data such as data indicating excess/insufficiency or the like of received electric power. Similarly, the controller 150B of the power receiver 100B transmits, to the power transmitter 300 via the antenna 170B, data such as data indicating excess/insufficiency or the like of received electric power.

In a state where the electronic devices 200A and 200B are arranged close to the power transmitting apparatus 80, the electronic devices 200A and 200B can respectively charge the batteries 220A and 220B without contacting the power transmitting apparatus 80. The batteries 220A and 220B can be charged at the same time.

The power transmitting system 500 is structured with the power transmitter 300 and the power receivers 100A and 100B of the configuration elements illustrated in FIG. 5. That is, the power transmitting apparatus 80 and the electronic devices 200A and 200B adopt the power transmitting system 500 that enables electric power transmission in a non-contact state through magnetic field resonance.

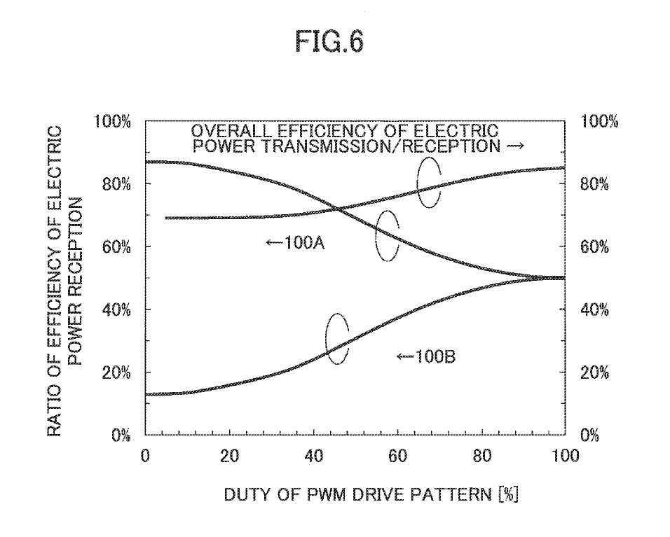

FIG. 6 is a diagram illustrating a relationship between duty cycles of PWM drive patterns and amounts of received electric power of the power receivers 100A and 100B.

Here, a case, in which the duty cycle of the PWM drive pattern that drives the switch 130B of the power receiver 100B is decreased from 100% with respect to a state in which the duty cycle of the PWM drive pattern that drives the switch 130A of the power receiver 100A is fixed to 100%, will be described.

In FIG. 6, the horizontal axis indicates the duty cycle of the PWM drive pattern that drives the switch 130B of the power receiver 100B. Further, the left side vertical axis indicates ratios of the efficiencies of electric power reception of the power receivers 100A and 100B. Further, the right side vertical axis indicates, in percentage, a sum of the efficiencies of electric power reception of the power receivers 100A and 100B.

Here, the ratios of the efficiencies of electric power reception are ratios of the respective efficiencies of electric power reception of the power receivers 100A and 100B to the sum of the efficiencies of electric power reception, when the sum of the efficiencies of electric power reception of the power receivers 100A and 100B is taken as 100%. For example, in a case where both the efficiency of electric power reception of the power receiver 100A and the efficiency of electric power reception of the power receiver 100B are equal to each other and are 40% (sum of the efficiencies of electric power reception is 80%), both the ratio of the efficiency of electric power reception of the power receiver 100A and the ratio of the efficiency of electric power reception of the power receiver 100B are 50%.

The case, in which both the efficiency of electric power reception of the power receiver 100A and the efficiency of electric power reception of the power receiver 100B are equal to each other and are 40%, means a state in which both the efficiency of electric power reception of the power receiver 100A and the efficiency of electric power reception of the power receiver 100B are equal to each other and are 40% when the two power receivers 100A and 100B simultaneously receive electric power from the power transmitter 300. Note that each of the power receivers 100A and 100B has the efficiency of electric power reception of about 85% singly.

Here, for example, it is assumed that, in a state in which both the duty cycle of the PWM drive pattern that drives the switch 130A of the power receiver 100A and the duty cycle of the PWM drive pattern that drives the switch 130B of the power receiver 100B are 100%, both the ratio of the efficiency of electric power reception of the power receiver 100A and the ratio of the efficiency of electric power reception of the power receiver 100B are 50%.

When the duty cycle of the PWM drive pattern that drives the switch 130B of the power receiver 100B is decreased from 100%, in the state in which the duty cycle of the PWM drive pattern that drives the switch 130A of the power receiver 100A is fixed to 100%, the ratio of the efficiency of electric power reception of the power receiver 100B decreases as illustrated in FIG. 6. Further, in accordance with this, the ratio of the efficiency of electric power reception of the power receiver 100A increases.

In this way, when the duty cycle of the PWM drive pattern that drives the switch 130B of the power receiver 100B is decreased, electric current that flows through the power receiver 100B decreases because the amount of received electric power of the power receiver 100B decreases. That is, the impedance of the power receiver 100B is changed depending on the change of the duty cycle.

In electric power transmission using magnetic field resonance, electric power, transmitted from the power transmitter 300 to the power receivers 100A and 100B through the magnetic field resonance, is distributed to the power receivers 100A and 100B. Hence, when the duty cycle of the PWM drive pattern that drives the switch 130B of the power receiver 100B is decreased from 100%, the amount of received electric power of the power receiver 100A increases by the decrease in the amount of received electric power of the power receiver 100B.

Hence, as illustrated in FIG. 6, the ratio of the efficiency of electric power reception of the power receiver 100B decreases. Further, in accordance with this, the ratio of the efficiency of electric power reception of the power receiver 100A increases.

When the duty cycle of the PWM drive pattern that drives the switch 130B of the power receiver 100B decreases to about 10%, the ratio of the efficiency of electric power reception of the power receiver 100B decreases to about 13% and the ratio of the efficiency of electric power reception of the power receiver 100A increases to about 87%.

Then, when the duty cycle of the PWM drive pattern that drives the switch 130B of the power receiver 100B is 100%, the sum of the efficiencies of electric power reception of the power receiver 100A and the power receiver 100B is about 85%. When the duty cycle of the PWM drive pattern that drives the switch 130B of the power receiver 100B is decreased to about 10%, the sum of the efficiencies of electric power reception of the power receiver 100A and the power receiver 100B becomes about 70%.

As described above, when the duty cycle of the PWM drive pattern for driving the switch 130B of the power receiver 100B is decreased from 100% in the state in which the duty cycle of the PWM drive pattern for driving the switch 130A of the power receiver 100A is fixed to 100%, the ratio of the efficiency of electric power reception of the power receiver 100B decreases and the ratio of the efficiency of electric power reception of the power receiver 100A increases. Then, the sum of the efficiency of electric power reception of the power receiver 100A and the efficiency of electric power reception of the power receiver 100B does not largely change from a value around 80%.

In electric power transmission using magnetic field resonance, the sum of the efficiencies of electric power reception of the power receivers 100A and 100B does not largely change even when the duty cycle is changed because electric power, which is transmitted from the power transmitter 300 to the power receivers 100A and 100B through magnetic field resonance, is distributed to the power receivers 100A and 100B.

Similarly, when the duty cycle of the PWM drive pattern for driving the switch 130A of the power receiver 100A is decreased from 100% in a state in which the duty cycle of the PWM drive pattern for driving the switch 130B of the power receiver 100B is fixed to 100%, the ratio of the efficiency of electric power reception of the power receiver 100A decreases and the ratio of the efficiency of electric power reception of the power receiver 100B increases. Then, the sum of the efficiency of electric power reception of the power receiver 100A and the efficiency of electric power reception of the power receiver 100B does not largely change from a value around 80%.

Accordingly, it is possible to adjust the ratio of the efficiency of electric power reception of the power receiver 100A and the ratio of the efficiency of electric power reception of the power receiver 100B by adjusting the duty cycle of the PWM drive pattern that drives either the switch 130A of the power receiver 100A or the switch 130B of the power receiver 100B.

As described above, when the duty cycle of the PWM drive pattern that drives the switch 130A or the switch 130B is changed, the ratios of the efficiencies of electric power reception of the secondary-side resonant coils 110A and 110B of the power receivers 100A and the power receiver 100B are changed.

Hence, according to the first embodiment, the duty cycle of one PWM drive pattern of the PWM drive patterns for the switches 130A and 130B of the power receivers 100A and 100B is changed from a standard duty cycle. For example, the standard duty cycle may be 100%, and in this case, the one duty cycle is set to be an appropriate value less than 100%.

As can be seen from FIG. 6, when the duty cycle of one power receiver (100A or 100B) is decreased, the amount of received electric power of the one power receiver (100A or 100B) decreases. Further, the amount of received electric power of the other power receiver (100A or 100B) increases in a state in which the duty cycle of the other power receiver (100A or 100B) is fixed.

Hence, by decreasing the duty cycle of the PWM drive pattern of one power receiver (100A or 100B), it is possible to reduce the amount of electric power supplied to the one power receiver (100A or 100B) and to increase the amount of electric power supplied to the other power receiver (100A or 100B).

Here, there are upper limit values of electric power that can be received the power receivers 100A and 100B. Hence, when the duty cycle is adjusted to adjust the distribution of received electric power of the two power receivers 100A and 100B, if the received electric power exceeds the upper limit value of the power receiver (100A or 100B), electric power that cannot be received causes loss.

Also, there is a lower limit value (minimum value) of electric power for the power receiver (100A or 100B) for which charging of the battery (220A or 220B) is enabled. Hence, when the duty cycle is decreased to decrease the received electric power, if the received electric power becomes lower than the lower limit value, it becomes impossible to charge the battery (220A or 220B).

Therefore, in order to efficiently charge the power receivers 100A and 100B, when adjusting the duty cycle to adjust the distribution of received electric power of the two power receivers 100A and 100B, it is preferable to consider the upper limit value and the lower limit value for the power receiver (100A or 100B).

Further, at this time, the frequency of the PWM drive pattern is set to be a frequency less than or equal to a frequency of AC power that is transmitted through the magnetic field resonance. More preferably, the frequency of the PWM drive pattern is set to be a frequency less than the frequency of the AC power that is transmitted through the magnetic field resonance. For example, the frequency of the PWM drive pattern may be set to be a frequency less than the frequency of the AC power, which is transmitted through the magnetic field resonance, by about one or two orders of magnitude.

This is because if the frequency of the PWM drive pattern is higher than the frequency of the AC power that is transmitted through the magnetic field resonance, on/off of the switch 130A or 130B is switched in the process of one cycle of full wave rectified electric power and there is a possibility that it becomes impossible to appropriately adjust the amount of electric power.

Accordingly, it is required to set the frequency of the PWM drive pattern to be a frequency less than or equal to the frequency of the AC power that is transmitted through the magnetic field resonance. Further, at that time, by setting the frequency of the PWM drive pattern to a frequency less than the frequency of the AC power, which is transmitted through the magnetic field resonance, by about one or two orders of magnitude, it becomes possible to appropriately adjust the amount of electric power.

For example, in a case where the frequency of the AC power that is transmitted through the magnetic field resonance is 6.78 MHz, the frequency of the PWM drive pattern may be set to be several hundreds of KHz.

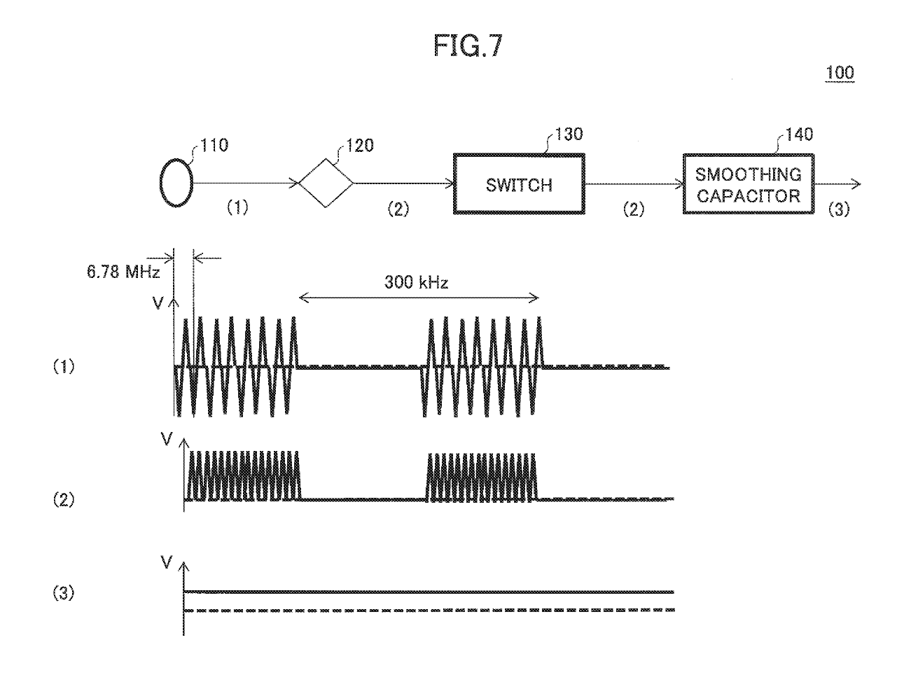

Here, a relationship between the duty cycle of the PWM drive pattern and the received electric power will be described with reference to FIG. 7.

FIG. 7 is a diagram illustrating a relationship between the duty cycle of the PWM drive pattern and the received electric power in the power receiver 100.

In FIG. 7, the secondary-side resonant coil 110, the rectifier circuit 120, the switch 130, and the smoothing capacitor 140 of the power receiver 100 are illustrated in a simplified manner, and electric power waveforms (1), (2), and (3) are illustrated.

The electric power waveform (1) indicates a waveform of electric power that is obtained between the secondary-side resonant coil 110 and the rectifier circuit 120. The electric power waveform (2) indicates a waveform of electric power that is obtained between the rectifier circuit 120 and the switch 130. The electric power waveform (3) indicates a waveform of electric power that is obtained between the switch 130 and the smoothing capacitor 140.

Here, because the electric power waveform at the input side of the switch 130 is substantially equal to the electric power waveform at the output side of the switch 130, the electric power waveform (2) is also an electric power waveform that is obtained between the switch 130 and the smoothing capacitor 140.

Here, it is assumed that the frequency of AC voltage that the AC power source 1 outputs is 6.78 MHz and the resonant frequency of the primary-side resonant coil 12 and the secondary-side resonant coil 21 is 6.78 MHz. Further, it is assumed that the frequency of the PWM pulse of the PWM drive pattern is 300 kHz and the duty cycle is 50%.

As illustrated in FIG. 4, the power receiver 100 has a circuit configuration, which forms a loop between the secondary-side resonant coil 110 and the battery 220, in practice.

Hence, an electric current flows through the loop circuit while the switch 130 is on, but an electric current does not flow through the loop circuit while the switch 130 is off.

The electric power waveform (1) is a waveform of the AC power, which is supplied from the secondary-side resonant coil 110 to the rectifier circuit 120, intermittently flowing in accordance with on/off of the switch 130.

The electric power waveform (2) is a waveform of the electric power, full wave rectified by the rectifier circuit 120, intermittently flowing in accordance with on/off of the switch 130.

The electric power waveform (3) is DC power obtained by smoothing the electric power, full wave rectified by the rectifier circuit 120 and supplied to the smoothing capacitor 140 via the switch 130. A voltage value of the electric power waveform (3) increases as the duty cycle increases, and decreases as the duty cycle decreases.

As described above, the voltage value of the DC power that is output from the smoothing capacitor 140 can be adjusted by adjusting the duty cycle of the drive pattern.

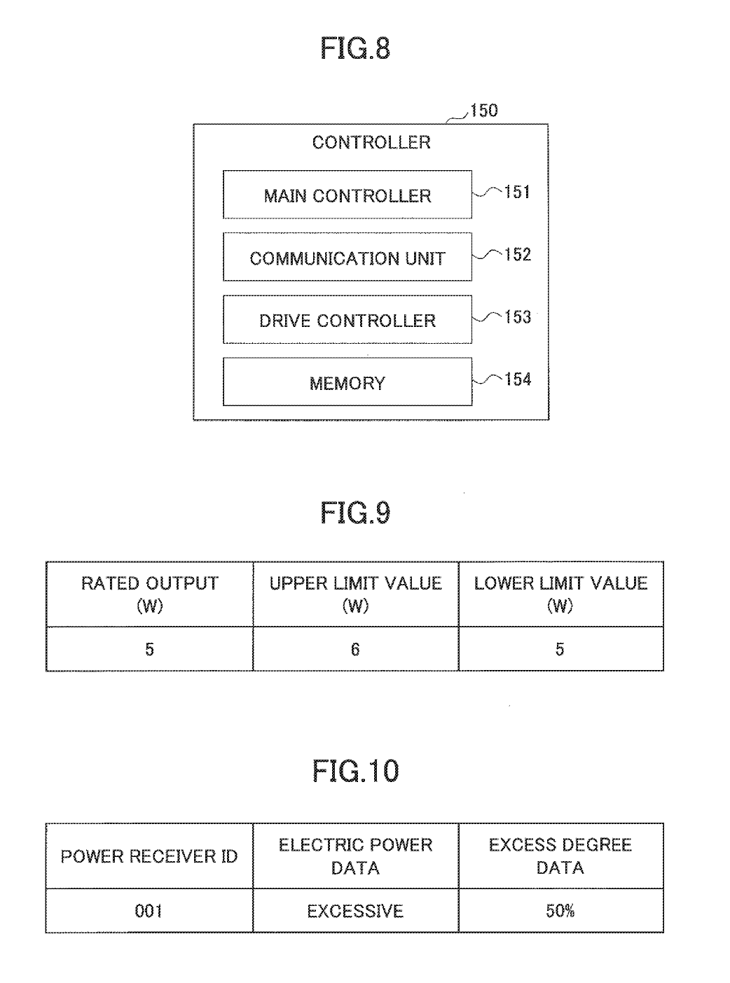

FIG. 8 is a diagram illustrating a configuration of the controller 150. The controller 150 is included in the power receiver 100 illustrated in FIG. 4, and is similar to the controllers 150A and 150B, which are illustrated in FIG. 5.

The controller 150 includes a main controller 151, a communication unit 152, a drive controller 153, and a memory 154.

The main controller 151 controls a control process of the controller 150. Further, the main controller 151 generates electric power data that indicates whether received electric power of the power receiver 100 is excessive, appropriate, or insufficient, and transmits the generated electric power data to the power transmitter 300 via the communication unit 152. Note that the received electric power being appropriate means the received electric power being in a predetermined range considered appropriate.

It is determined, depending on a relationship between an upper limit value and a lower limit value of the received electric power of the power receiver 100, whether the received electric power of the power receiver 100 is excessive, is appropriate, or is insufficient. The upper limit value and the lower limit value of the received electric power are determined depending on a rated output (rated electric power) of the power receiver 100. Accordingly, the electric power data is data related to the rated output and the received electric power of the power receiver 100. Note that a relationship between the upper limit value and the lower limit value of the received electric power and the excess, the appropriateness, or the insufficiency of the received electric power will be described later below.

Further, upon receiving an adjustment command to adjust the duty cycle from the power transmitter 300 via the communication unit 152, the main controller 151 outputs the adjustment command to the drive controller 153. The drive controller 153 adjusts the duty cycle in accordance with the adjustment command.

The communication unit 152 performs wireless communication with the power transmitter 300. For example, when the power receiver 100 performs Near Field Communication with the power transmitter 300 according to Bluetooth (registered trademark), the communication unit 152 is a modem for Bluetooth. The communication unit 152 is an example of a power receiving side communication unit.

The drive controller 153 PWM-drives the switch 130. The drive controller 153 adjusts, based on the adjustment command input from the main controller 151, the duty cycle of the PWM drive pattern that PWM-drives the switch 130. The drive controller 153 is an example of a drive controller that controls and drives the switch 130 and is an example of an adjuster that adjusts the duty cycle of the PWM drive pattern.

The memory 154 stores data that indicates the rated output (rated electric power) of the power receiver 100, the upper limit value of received electric power, and the lower limit value of received electric power. For example, the memory 154 may be a non-volatile memory.

Here, the rated output of the power receiver 100 is the rated output of the battery 220 that is a load device of the power receiver 100.

The upper limit value of the received electric power is an upper limit value of electric power that can charge the battery 220 without generating excessive electric power that is not used when charging the battery 220, which is a load device of the power receiver 100. That is, if the received electric power of the power receiver 100 exceeds the upper limit value of the received electric power, excessive electric power, which is not used to charge the battery 220, occurs when charging the battery 220.

The lower limit value of the received electric power is a minimum value of electric power that can charge the battery 220, which is a load device of the power receiver 100. That is, if the received electric power of the power receiver 100 becomes less than the lower limit value of the received electric power, it becomes impossible to charge the battery 220.

FIG. 9 is a diagram illustrating data that is stored in the memory 154.

As illustrated in FIG. 9, the data indicating the rated output of the power receiver 100, the upper limit value of the received electric power, and the lower limit value of the received electric power are stored in the memory 154. FIG. 9 illustrates, as an example, the upper limit value and the lower limit value of the received electric power in a case where the rated output of the power receiver 100 is 5 W. The upper limit value of the received electric power is 6 W and the lower limit value of the received electric power is 5 W.

Using the upper limit value and the lower limit value of the received electric power, the main controller 151 may determine that the received electric power is insufficient when the received electric power is less than 5 W, for example. That is, the main controller 151 may determine that the received electric power is insufficient in a case of the received electric power <5 W.

Further, when the received electric power is equal to or greater than 5 W and equal to or less than 6 W, the main controller 151 may determine that the received electric power is appropriate. That is, the main controller 151 may determine that the received electric power is appropriate in a case of 5 W≤the received electric power≤6 W.

Further, when the received electric power is higher than 6 W, the main controller 151 may determine that the received electric power is excessive. That is, the main controller 151 may determine that the received electric power is excessive in a case of 6 W<the received electric power.

Further, in a case where the rated output is 10 W, the upper limit value of the received electric power is 12 W, and the lower limit value of the received electric power is 10 W, for example, the main controller 151 may make a determination as follows.

The main controller 151 may determine that the received electric power is insufficient when the received electric power is less than 10 W, for example. That is, the main controller 151 may determine that the received electric power is insufficient in a case of the received electric power <10 W.

Further, when the received electric power is equal to or greater than 10 W and equal to or less than 12 W, the main controller 151 may determine that the received electric power is appropriate. That is, the main controller 151 may determine that the received electric power is appropriate in a case of 10 W≤the received electric power≤12 W.

Further, when the received electric power is higher than 12 W, the main controller 151 may determine that the received electric power is excessive. That is, the main controller 151 may determine that the received electric power is excessive in a case of 12 W<the received electric power.

In a case where the main controller 151 determines that the received electric power is insufficient, the main controller 151 transmits, to the power transmitter 300, electric power data indicating that the received electric power is insufficient. Also, in a case where the main controller 151 determines that the received electric power is appropriate, the main controller 151 transmits, to the power transmitter 300, electric power data indicating that the received electric power is appropriate. Also, in a case where the main controller 151 determines that the received electric power is excessive, the main controller 151 transmits, to the power transmitter 300, electric power data indicating that the received electric power is excessive.

Further, in a case where the received electric power is excessive, the main controller 151 transmits, to the power transmitter 300, data (excess degree data) indicating a degree (excess degree) by which the received electric power is excessive together with the electric power data. The excess degree data indicates a degree by which the received electric power exceeds the upper limit value. For example, when the upper limit value is 6 W and the received electric power is 9 W, the excess degree data indicates 50%.

FIG. 10 is a diagram illustrating a data structure of electric power data and excess degree data.

The electric power data and the excess degree data generated by the main controller 151 are stored in the memory 154 in association with an ID (Identification) of the power receiver 100.

The electric power data indicates whether the received electric power of the power receiver 100 is excessive, is appropriate, or is insufficient. For example, the electric power data can be indicated by a 2-bit data value. For example, the data value indicating the excess may be set to be “10”, the data value indicating the appropriateness may be set to be “01”, and the data value indicating the insufficiency may be set to be “00”.

When the received electric power is excessive, the excess degree data is data indicating, by a numerical value, the degree of the excess. Because the excess degree data is data generated when the received electric power is excessive, when the received electric power is appropriate or insufficient, excess degree data is not generated. When the received electric power is appropriate or insufficient, there is no data value for the excess degree data.

FIG. 10 illustrates, as an example, data in which the ID of the power receiver 100 is 001, the electric power data indicates the excess, and the excess degree data indicates 50%. Note that the electric power data and the excess degree data may be indicated by one set of data without distinguishing them. For example, when the received electric power is excessive, the degree of the excess may be indicated by a positive numerical value. When the received electric power is appropriate, the degree may be indicated by ‘0’ (zero). When the received electric power is insufficient, the degree of the insufficiency may be indicated by a negative numerical value.

Further, upon receiving the electric power data as described above, the power transmitter 300 transmits, to the power receiver 100, an adjustment command to increase the duty cycle, an adjustment command by which the degree of adjusting the duty cycle is zero, or an adjustment command to decrease the duty cycle.

Upon the power receiver 100 receiving one of the adjustment commands from the power transmitter 300, the drive controller 153 adjusts the duty cycle of the PWM drive pattern for PWM-driving the switch 130 based on the adjustment command input from the main controller 151.

More specifically, upon an adjustment command to increase the duty cycle being input from the main controller 151, the drive controller 153 increases the duty cycle of the PWM drive pattern for PWM-driving the switch 130. The degree by which the duty cycle is increased by the adjustment command may be set in advance in the power receiver 100. For example, the degree by which the duty cycle is increased by the adjustment command may be held by the drive controller 153 as a fixed value or may be stored in the memory 154.

Upon an adjustment command by which the degree of adjusting the duty cycle is zero being input from the main controller 151, the drive controller 153 maintains the duty cycle of the PWM drive pattern. That is, in this case, the duty cycle is not changed.

Upon an adjustment command to decrease the duty cycle being input from the main controller 151, the drive controller 153 decreases the duty cycle of the PWM drive pattern for PWM-driving the switch 130.

The degree by which the duty cycle is decreased by the adjustment command may be set in advance in the power receiver 100. For example, the degree by which the duty cycle is decreased by the adjustment command may be held by the drive controller 153 as a fixed value or may be stored in the memory 154.

Note that the power transmitter 300 may store, in the memory 360, data that indicates the degree by which the duty cycle is decreased by the adjustment command for each power receiver 100 and may transmit the stored data to each power receiver 100. In this case, when updating firmware used to perform a control process using an adjustment command, the power transmitter 300 may obtain data that indicates a degree for a new model of a power receiver.

Note that the degree by which the duty cycle is decreased by the adjustment command may be equal to the degree by which the duty cycle is increased by the adjustment command.

Also, the degree by which the duty cycle is decreased by the adjustment command may be set to be a larger value as the rated output of the power receiver 100 is higher.

Note that an adjustment command to increase the duty cycle, an adjustment command by which the degree of adjusting the duty cycle is zero, and an adjustment command to decrease the duty cycle can be realized by 2-bit data, for example.

For example, a 2-bit data value of the adjustment command to increase the duty cycle may be set to be ‘10’, a 2-bit data value of the adjustment command by which the degree of adjusting the duty cycle is zero may be set to be ‘01’, and a 2-bit data value of the adjustment command to decrease the duty cycle may be set to be ‘00’.

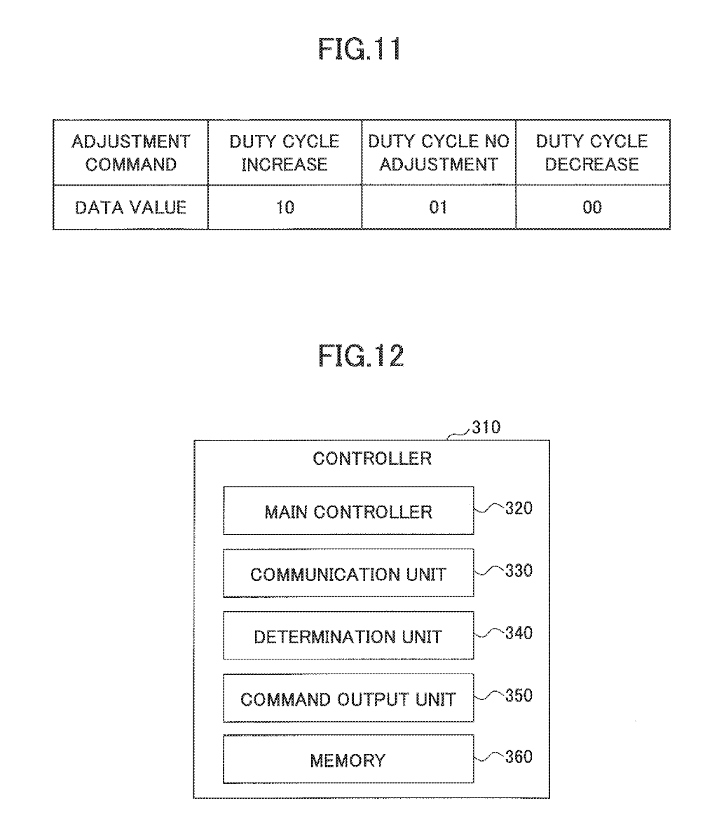

In a case where such adjustment commands are used, data as illustrated in FIG. 11 may be stored in the memory 154.

FIG. 11 is a diagram illustrating a data structure of adjustment commands that are stored in the memory 154.

As an example, a 2-bit data value of the adjustment command to increase the duty cycle is ‘10’, a 2-bit data value of the adjustment command by which the degree of adjusting the duty cycle is zero is ‘01’, and a 2-bit data value of the adjustment command to decrease the duty cycle is ‘00’.

By storing such data for adjustment commands in the memory 154, upon receiving an adjustment command from the power transmitter 300, the drive controller 153 of the power receiver 100 can determine, with reference to the data for the adjustment commands stored in the memory 154, the content of the adjustment command received from the power transmitter 300. Then, the drive controller 153 drives the switch 130 in accordance with the adjustment command received from the power transmitter 300. At this time, the duty cycle of the PWM drive pattern for driving the switch 130 is increased, is decreased, or maintained without being adjusted, in accordance with the adjustment command.

FIG. 12 is a diagram illustrating a configuration of the controller 310. The controller 310 is included in the power transmitter 300, which is illustrated in FIG. 4 and FIG. 5.

Herein, an example of a case will be described where the power transmitter 300 (see FIG. 5) communicates with two or more power receivers 100 to control the received electric power.

The controller 310 includes a main controller 320, a communication unit 330, a determination unit 340, a command output unit 350, and a memory 360.

The main controller 320 controls a control process of the controller 310.

The communication unit 330 performs wireless communication with each power receiver 100. For example, when the power transmitter 300 performs Near Field Communication with the power receiver 100 according to Bluetooth (registered trademark), the communication unit 330 is a modem for Bluetooth.

The communication unit 330 receives the electric power data from each power receiver 100. The electric power data received from each power receiver 100 indicates that the received electric power of the power receiver 100 is excessive, is appropriate, or is insufficient.

The determination unit 340 determines, based on the electric power data received from each power receiver 100, whether a power receiver 100 whose received electric power is excessive, a power receiver 100 whose received electric power is insufficient, and a power receiver 100 whose received electric power is in an appropriate range are present. Also, the determination unit 340 determines, based on the electric power data received from each power receiver 100, whether both a power receiver 100 whose received electric power is excessive and a power receiver 100 whose received electric power is insufficient are present.

Upon the determination unit 340 determining that both a power receiver 100 whose received electric power is excessive and a power receiver 100 whose received electric power is insufficient are present, the command output unit 350 transmits, to the power receiver 100 whose received electric power is excessive via the communication unit 330, an adjustment command to decrease the duty cycle. In this case, when there are a plurality of power receivers 100 whose received electric power is excessive, the command output unit 350 transmits, to each of the plurality of power receivers 100 whose received electric power is excessive, an adjustment command to decrease the duty cycle.

Upon the determination unit 340 determining that one or more power receivers 100 whose received electric power is excessive are present and the received electric power of the remaining power receiver 100 is appropriate, the command output unit 350 transmits, to the one or more power receivers 100 whose received electric power is excessive via the communication unit 330, an adjustment command to decrease the duty cycle. Further, in this case, the command output unit 350 transmits, to the power receivers 100 whose received electric power is appropriate via the communication unit 330, an adjustment command not to adjust the duty cycle.

Upon the determination unit 340 determining that one or more power receivers 100 whose received electric power is insufficient are present and the received electric power of the remaining power receiver 100 is appropriate, the command output unit 350 transmits, to the one or more power receivers 100 whose received electric power is insufficient via the communication unit 330, an adjustment command to increase the duty cycle. Further, in this case, the command output unit 350 transmits, to the power receiver 100 whose received electric power is appropriate via the communication unit 330, an adjustment command not to adjust the duty cycle.

Upon the determination unit 340 determining that a plurality of power receivers 100 whose received electric power is appropriate are present, the command output unit 350 transmits, to all the plurality of power receivers 100 via the communication unit 330, an adjustment command not to adjust the duty cycle.

Note that the command output unit 350 adds a power receiver ID to an adjustment command, and transmits the adjustment command to a power receiver 100 specified by the power receiver ID.

The memory 360 stores data for adjustment commands the same as the data for the adjustment commands stored in the memory 154 of the power receiver 100. This is because the duty cycle of the power receiver 100 can be adjusted from the power transmitter 300 by using the same data for the adjustment commands.

As an example, a 2-bit data value of the adjustment command to increase the duty cycle is ‘10’, a 2-bit data value of the adjustment command by which the degree of adjusting the duty cycle is zero is ‘01’, and a 2-bit data value of the adjustment command to decrease the duty cycle is ‘00’.

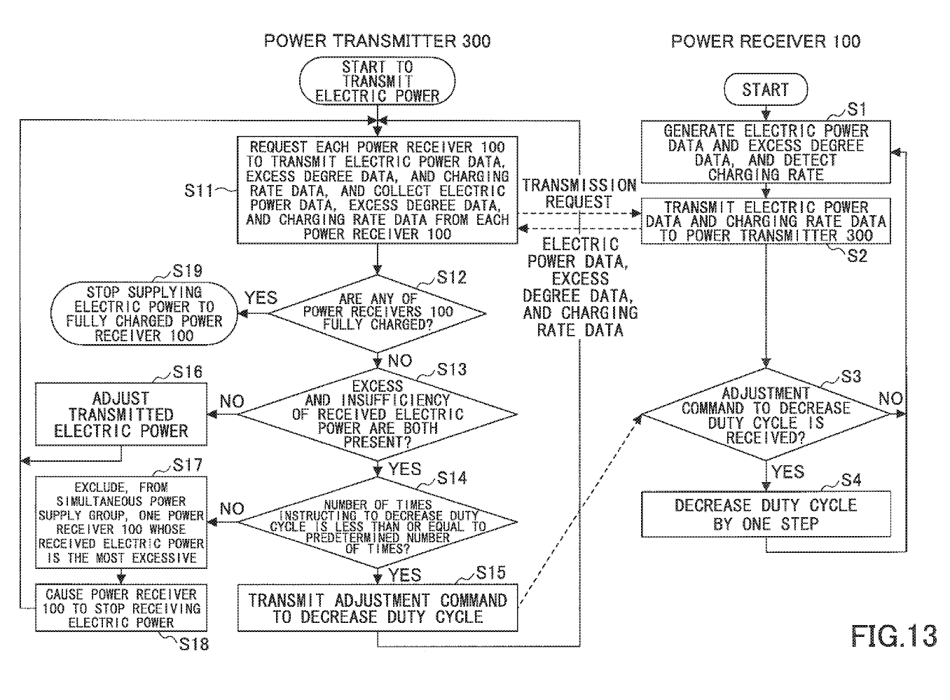

FIG. 13 is a flowchart illustrating a process that is executed by the power transmitter 300 and each power receiver 100 of the power transmitting system 500 according to the first embodiment. Although the power transmitter 300 and each power receiver 100 independently perform the process, data flow between the power transmitter 300 and each power receiver 100 is illustrated here for describing the entire flow.

Here, when a plurality of power receivers 100 simultaneously receive electric power transmitted from the power transmitter 300, the transmitted electric power of the power transmitter 300 and the received electric power of the plurality of power receivers 100 are optimized. The received electric power is optimized by optimizing the duty cycle of the PWM drive pattern of each power receiver 100.

Note that simultaneous power supply means that a plurality of power receivers 100 simultaneously receive electric power transmitted from the power transmitter 300, and the plurality of power receivers 100 that receive the electric power through the simultaneous power supply are treated as a simultaneous power supply group.

The power transmitter 300 starts to transmit the electric power (START TO TRANSMIT ELECTRIC POWER). The electric power is output from the primary-side resonant coil 12 of the power transmitter 300. Note that preset initial output electric power may be output from the primary-side resonant coil 12 immediately after the start of transmitting the electric power.

Further, upon being switched to a power receiving mode, each power receiver 100 starts a process (START).

In step S1, each power receiver 100 receives the electric power from the power transmitter 300 through magnetic field resonance, generates electric power data and excess degree data, and detects a charging rate of the battery 220.

In step S11, the power transmitter 300 requests each power receiver 100 to transmit the electric power data, the excess degree data, and the charging rate data, and collects the electric power data, the excess degree data, and the charging rate data from each power receiver 100.

In step S2, each power receiver 100 transmits, to the power transmitter 300, the electric power data generated in step S1 and the charging rate data that indicates the detected charging rate.

Upon transmitting the electric power data, the excess degree data, and the charging rate data to the power transmitter 300 in step S2, each power receiver 100 determines in step S3 whether an adjustment command to decrease the duty cycle of the PWM drive pattern has been received.

After the power transmitter 300 completes the process of step S11, each power receiver 100 waits over a predetermined time period required to complete the process of step S15 that will be described later below, and determines whether an adjustment command to decrease the duty cycle of the PWM drive pattern has been received.

When not receiving an adjustment command to decrease the duty cycle of the PWM drive pattern from the power transmitter 300 after waiting over the predetermined time period (NO in step S3), each power receiver 100 returns the flow to step S1.

In step S12, the power transmitter 300 determines whether any of the power receivers 100 are fully charged based on the charging rate data received from each power receiver 100. This is because it is not necessary to transmit the electric power to fully charged power receivers 100.

With respect to the power receivers 100 that are not fully charged determined in step S12, the determination unit 340 determines whether both a power receiver 100 whose received electric power is excessive and a power receiver 100 whose received electric power is insufficient are present in step S13. When both a power receiver 100 whose received electric power is excessive and a power receiver 100 whose received electric power is insufficient are present, the power transmitter 300 makes the following determination in order to decrease the duty cycle of the PWM drive pattern of the power receiver 100 whose received electric power is excessive.

Upon determining that both a power receiver 100 whose received electric power is excessive and a power receiver 100 whose received electric power is insufficient are present (YES in step S13), the power transmitter 300 determines whether a number of times of instructing the power receiver 100, whose received electric power is excessive, to decrease the duty cycle is less than or equal to a predetermined number of times in step S14.

This is because, if the number of times of instructing to decrease the duty cycle is large, the efficiency of electric power reception of the power receiver 100 may be overly decreased. Hence, the number of times of instructing to decrease the duty cycle is limited.

Further, the predetermined number of times may be set to be an optimum number of times through an experiment or the like. Further, for example, the predetermined number of times may be set to be a larger value as the rated output of the power receiver 100 is higher. This is because a range in which the received electric power can be adjusted by decreasing the duty cycle is wider as the rated output of the power receiver 100 is higher.

Further, for example, data indicating the predetermined number of times may be counted for each power receiver 100 by the main controller 320 of the power transmitter 300, or may be counted by each power receiver 100 and transmitted to the power transmitter 300 when performing the process of step S14.

Upon determining that the number of times of instructing the power receiver 100, whose received electric power is excessive, to decrease the duty cycle is less than or equal to the predetermined number of times (YES in step S14), the power transmitter 300 transmits the adjustment command to decrease the duty cycle of the PWM drive pattern of the power receiver 100 whose received electric power is excessive in step S15. This is for improving the entire balance of received electric power of the plurality of power receivers 100 by decreasing the duty cycle of the PWM drive pattern of the power receiver 100 whose received electric power is excessive to decrease the received electric power.

Note that in a case where there are a plurality of power receivers 100 whose received electric power is excessive in step S15, the power transmitter 300 transmits, to all the plurality of power receivers 100 whose received electric power is excessive, an adjustment command to decrease the duty cycle.

Upon completing the process of step S15, the power transmitter 300 returns the flow to step S11.

Upon the adjustment command to decrease the duty cycle of the PWM drive pattern being transmitted to the power receiver 100 whose received electric power is excessive in step S15, the power receiver 100, which has received the adjustment command, decreases in step S4 the duty cycle of the PWM drive pattern by one step.

Upon determining that there is not a state in which both a power receiver 100 whose received electric power is excessive and a power receiver 100 whose received electric power is insufficient are present (NO in step S13), the power transmitter 300 adjusts the electric power transmitted from the primary-side resonant coil 12 in step S16.

In step S16, when one or more power receivers 100 whose received electric power is excessive are present and the received electric power of the remaining power receiver 100 is appropriate, the power transmitter 300 decreases the transmitted electric power by predetermined electric power.

In step S16, when one or more power receivers 100 whose received electric power is insufficient are present and the received electric power of the remaining power receiver 100 is appropriate, the power transmitter 300 increases the transmitted electric power by predetermined electric power.

In step S16, upon the determination unit 340 determining that a plurality of power receivers 100 whose received electric power is appropriate are present, the power transmitter 300 maintains the transmitted electric power. That is, the power transmitter 300 maintains the transmitted electric power at that time without changing the transmitted electric power.

Note that the power transmitter 300 maintaining the transmitted electric power at that time without changing the transmitted electric power corresponds to the adjustment degree of the transmitted electric power being zero.

Data that indicates the predetermined electric power at the time when the power transmitter 300 decreases the transmitted electric power and the predetermined electric power at the time when the power transmitter 300 increases the transmitted electric power may be stored in advance in the memory 360. Note that the predetermined electric power at the time of decreasing the transmitted electric power may differ from the predetermined electric power at the time of increasing the transmitted electric power.

Upon completing the process of step S16, the power transmitter 300 returns the flow to step S11.

Upon determining that the number of execution times of decreasing the duty cycle is greater than the predetermined number of times (NO in step S14), the power transmitter 300 excludes in step S17, from the simultaneous power supply group, one power receiver 100 whose received electric power is the most excessive.

The one power receiver 100, for which the number of execution times of decreasing the duty cycle is greater than the predetermined number of times and whose received electric power is the most excessive, is a power receiver 100, whose received electric power has not fall within an appropriate range despite the fact that the duty cycle has been decreased a number of times greater by one than the predetermined number of times. Hence, such a power receiver 100 is excluded from the simultaneous power supply group.

Note that the one power receiver 100 whose received electric power is the most excessive may be determined based on the excess degree data. Also, in a case where the number of power receivers 100 whose received electric power is excessive is one in step S17, the one power receiver 100 whose received electric power is excessive may be excluded from the simultaneous power supply group without using the excess degree data.

In step S18, the power transmitter 300 causes the power receiver 100, excluded from the simultaneous power supply group in step S17, to stop receiving the electric power. For example, the power transmitter 300 may transmit, to the power receiver 100, an adjustment command to set the duty cycle to be 0% to stop receiving the electric power.

Upon completing the process of step S18, the power transmitter 300 returns the flow to step S11.

Note that upon determining in step S12 that any one of the power receivers 100 is fully charged, the power transmitter 300 stops in step S19 supplying the electric power to the power receiver 100 fully charged.

In this case, the power transmitter 300 may transmit an adjustment command to set the duty cycle to be 0% to the fully charged power receiver 100 determined in step S12. Further, power receivers 100 that have not yet been fully charged may be charged by continuously performing the process illustrated in FIG. 13.

By repeatedly executing the above described process, it is possible to charge the power receivers 100. That is, by detecting whether the received electric power is excessive or insufficient for each power receiver 100 and adjusting, in accordance with the detection result, the duty cycles of the PWM drive patterns of the power receivers 100, it is possible to make the received electric power of the plurality of power receivers 100 closer to an appropriate range gradually.

Therefore it is possible to provide the power transmitting system 500 and the power transmitter 300 that can efficiently charge power receivers 100.

Note that each power receiver 100 always detects a power receiving state during receiving electric power from the power transmitter 300, and constantly transmits, in response to a request from the power transmitter 300 in step S11, electric power data, excess degree data, and charging rate data to the power transmitter 300. When the received electric power of one power receiver 100 among the plurality of power receivers 100 being charged becomes zero or becomes disconnected from communication, the power transmitter 300 may determine that the one power receiver 100 has become away from a chargeable area and may stop transmitting the electric power to the one power receiver 100. Subsequently, the power transmitter 300 may charge remaining power receivers 100 by continuously performing the process that is illustrated in FIG. 13.

Further, in a case where received electric power of all the power receivers 100 is insufficient and the output of the power transmitter 300 is the maximum output, the power transmitter 300 may stop transmitting the electric power by determining that an abnormal state occurs in which the transmitted electric power is insufficient or the efficiencies of electric power reception of the power receivers 100 are excessively low.

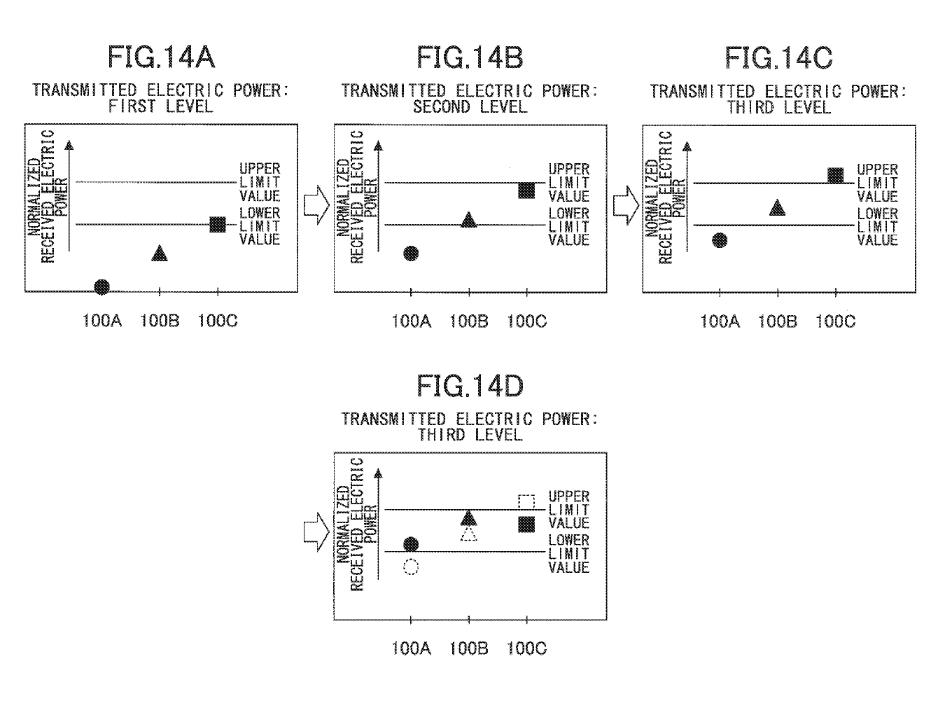

Next, with reference to FIG. 14 to FIG. 17, cases will be described in which received electric power of the power receivers 100 is adjusted by the power transmitter 300 and the power transmitting system 500 according to the first embodiment.

FIG. 14 to FIG. 17 are diagrams illustrating cases in which received electric power of the power receivers 100 is adjusted by the power transmitter 300 and the power transmitting system 500 according to the first embodiment. In FIG. 14 to FIG. 17, three power receivers 100A, 100B, and 100C are used for description.

The vertical axis in FIG. 14 to FIG. 17 indicates electric power that is obtained by subtracting, from the respective received electric power of the power receivers 100A, 100B, and 100C, the respective rated outputs. Here, electric power that is obtained by subtracting the rated output from the received electric power is referred to as normalized received electric power.

The upper limit values and the lower limit values of received electric power for the respective power receivers 100A, 100B, and 100C may differ from each other. Thus, FIG. 14 to FIG. 17 illustrate electric power levels such that the level of normalized received electric power can be compared in a manner in which the levels of the upper limit values and the lower limit values of the received electric power of the power receivers 100A, 100B, and 100C are matched.

In FIG. 14A, the normalized received electric power of the power receiver 100A is the lowest, the normalized received electric power of the power receiver 100B is at an intermediate value, and the normalized received electric power of the power receiver 100C is the highest.

The normalized received electric power of the power receiver 100A and the normalized received electric power of the power receiver 100B are both lower than the lower limit value, and the normalized received electric power of the power receiver 100C is at the lower limit value. That is, the received electric power for each of the power receivers 100A and 100B is insufficient, and the received electric power for the power receiver 100C is appropriate.

Note that the state that is illustrated in FIG. 14A is immediately after the power transmitter 300 starts transmitting electric power, and the transmitted electric power is at a predetermined low value. For this reason, the transmitted electric power is at a first level.

In such a state, in the flowchart that is illustrated in FIG. 13, NO is determined in step S13, and thus the transmitted electric power of the power transmitter 300 is increased from the first level by predetermined electric power in step S16. FIG. 14B illustrates a state in which the transmitted electric power has been increased from that in the state that is illustrated in FIG. 14A. In FIG. 14B, the transmitted electric power is at a second level.

In FIG. 14B, the normalized received electric power of each of the power receivers 100A, 100B, and 100C is greater than that in FIG. 14A.

In FIG. 14B, the normalized received electric power of the power receiver 100A is lower than the lower limit value, the normalized received electric power of the power receiver 100B is substantially equal to the lower limit value of the normalized received electric power, and the normalized received electric power of the power receiver 100C is between the lower limit value and the upper limit value. That is, the received electric power for the power receiver 100A is insufficient, and the received electric power for each of the power receivers 100B and 100C is appropriate.

In such a state, in the flowchart that is illustrated in FIG. 13, NO is determined in step S13, and thus the transmitted electric power of the power transmitter 300 is increased from the second level by the predetermined electric power in step S16. FIG. 14C illustrates a state in which the transmitted electric power has been increased from that in the state that is illustrated in FIG. 14B. In FIG. 14C, the transmitted electric power is at a third level.

In FIG. 14C, the normalized received electric power of each of the power receivers 100A, 100B, and 100C is greater than that in FIG. 14B.

In FIG. 14C, the normalized received electric power of the power receiver 100A is lower than the lower limit value, the normalized received electric power of the power receiver 100B is between the lower limit value and the upper limit value, and the normalized received electric power of the power receiver 100C is higher than the upper limit value. That is, the received electric power for the power receiver 100A is insufficient, the received electric power for the power receiver 100B is appropriate, and the received electric power for the power receiver 100C is excessive.

In such a state, in the flowchart that is illustrated in FIG. 13, YES is determined in step S13, YES is determined in step S14, and the duty cycle of the power receiver 100C is decreased in step S15. FIG. 14D illustrates a state in which the duty cycle of the power receiver 100C has been decreased from that in the state that is illustrated in FIG. 14C. Note that in FIG. 14D, the transmitted electric power is maintained at the third level.

In FIG. 14D, the normalized received electric power of each of the power receivers 100A and 100B is greater than that in FIG. 14C, and the normalized received electric power of the power receiver 100C is lower than that in FIG. 14C.

In FIG. 14D, the normalized received electric power of each of the power receivers 100A, 100B, and 100C is between the lower limit value and the upper limit value. That is, the received electric power for each of the power receivers 100A, 100B, and 100C is appropriate.

Therefore, by adjusting the transmitted electric power of the power transmitter 300 and the duty cycle of the power receiver 100C, a state can be obtained in which all the power receivers 100A, 100B, and 100C can be charged at the same time.

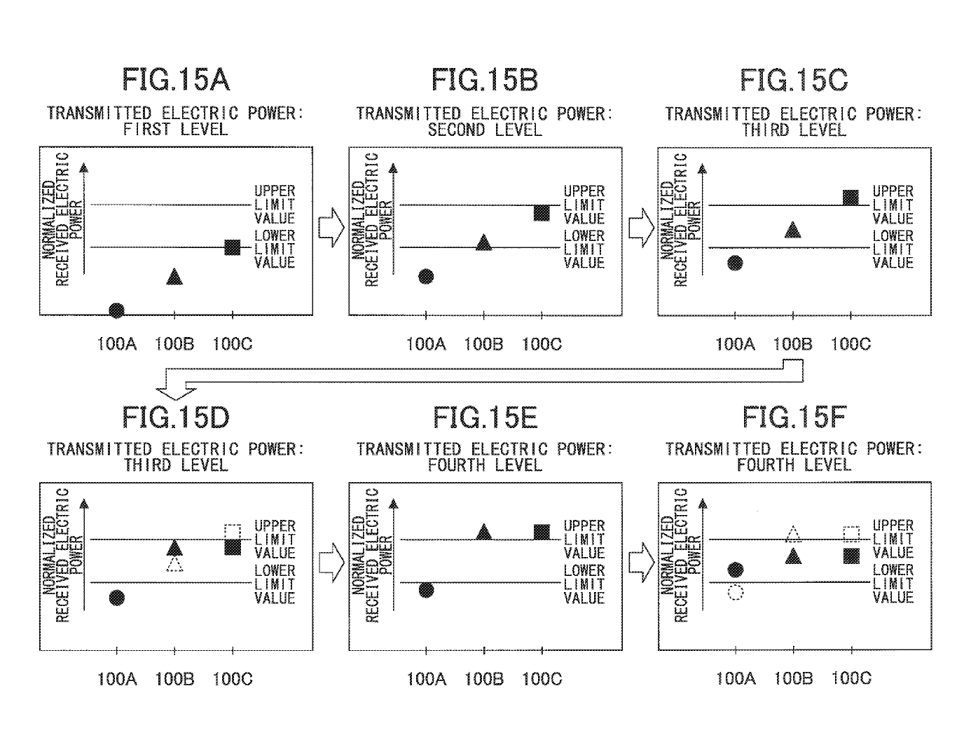

Power receivers 100A, 100B, and 100C used for description of FIG. 15 differ from the power receivers 100A, 100B, and 100C used for description of FIG. 14 in the degree of decreasing the duty cycle by an adjustment command.

The states illustrated in FIGS. 15A to 15C are similar to the states illustrated in FIGS. 14A to 14C. The state illustrated in FIG. 15A transitions to the state illustrated in FIG. 15C by increasing the transmitted electric power from that illustrated in FIG. 15A in a stepwise manner.

In a state of FIG. 15C, in the flowchart that is illustrated in FIG. 13, YES is determined in step S13, YES is determined in step S14, and the duty cycle of the power receiver 100C is decreased in step S15. FIG. 15D illustrates a state in which the duty cycle of the power receiver 100C has been decreased from that in the state that is illustrated in FIG. 14C. Note that in FIG. 15D, the transmitted electric power is maintained at the third level.

In FIG. 15D, the normalized received electric power of each of the power receivers 100A and 100B is greater than that in FIG. 15C, and the normalized received electric power of the power receiver 100C is lower than that in FIG. 15C.

In FIG. 15D, the normalized received electric power of the power receiver 100A is lower than the lower limit value, and the normalized received electric power of the power receivers 100B and 100C is between the lower limit value and the upper limit value. That is, the received electric power for the power receiver 100A is insufficient and the received electric power for each of the power receivers 100B and 100C is appropriate.

In the state of FIG. 15D, in the flowchart that is illustrated in FIG. 13, NO is determined in step S13, and thus the transmitted electric power of the power transmitter 300 is increased from the third level by the predetermined electric power in step S16. FIG. 15E illustrates a state in which the transmitted electric power has been increased from that in the state that is illustrated in FIG. 15D. In FIG. 15E, the transmitted electric power is at a fourth level.

In FIG. 15E, the normalized received electric power of each of the power receivers 100A, 100B, and 100C is greater than that in FIG. 15D.

In FIG. 15E, the normalized received electric power of the power receiver 100A is lower than the lower limit value, the normalized received electric power of each of the power receivers 100B and 100C is higher than the upper limit value. That is, the received electric power for the power receiver 100A is insufficient, and the received electric power for each of the power receivers 100B and 100C is excessive.

In such a state, in the flowchart that is illustrated in FIG. 13, YES is determined in step S13, YES is determined in step S14, and the duty cycles of the power receivers 100B and 100C are decreased in step S15. FIG. 15F illustrates a state in which the duty cycles of the power receivers 100B and 100C have been decreased from those in the state that is illustrated in FIG. 15E. Note that in FIG. 15F, the transmitted electric power is maintained at the fourth level.

In FIG. 15F, electric power corresponding to the decrease of the received electric power of the power receivers 100B and 100C is received by the power receiver 100A. Thereby, in FIG. 15F, the normalized received electric power of the power receiver 100A is greater than that in FIG. 15E, and the normalized received electric power of each of the power receivers 100B and 100C is lower than that in FIG. 15E.

As a result, the normalized received electric power of each of the power receivers 100A, 100B, and 100C is between the lower limit value and the upper limit value. That is, the received electric power for each of the power receivers 100A, 100B, and 100C is appropriate.

Therefore, by adjusting the transmitted electric power of the power transmitter 300 and the duty cycles of the power receivers 100B and 100C, a state can be obtained in which all the power receivers 100A, 100B, and 100C can be charged at the same time.

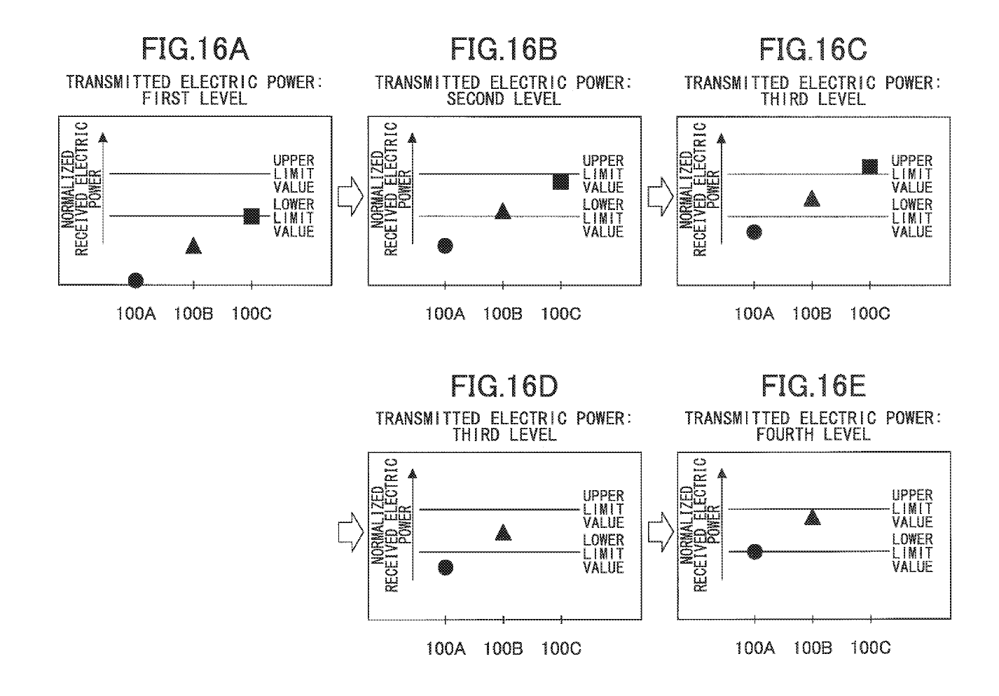

Although the power receivers 100A, 100B, and 100C used for description of FIG. 16 are similar to the power receivers 100A, 100B, and 100C used for description of FIG. 14, at the time point of reaching the state of FIG. 16A, the number of instruction times to decrease the duty cycle of the power receiver 100C has reached a number of times greater by one than the predetermined number of times in step S14 of FIG. 13.

The states illustrated in FIGS. 16A to 16C are similar to the states illustrated in FIGS. 14A to 14C. The state illustrated in FIG. 16A transitions to the state illustrated in FIG. 16C by increasing the transmitted electric power from that illustrated in FIG. 16A in a stepwise manner.

In the state of FIG. 16C, in the flowchart that is illustrated in FIG. 13, YES is determined in step S13 and NO is determined in step S14 because the number of instruction times to decrease the duty cycle is greater than the predetermined number of times by one. Then, in step S17, the power receiver 100C, whose received electric power is excessive, is excluded from the simultaneous power supply group. FIG. 16D illustrates a state in which the power receiver 100C has been excluded from the state that is illustrated in FIG. 16C. Note that in FIG. 16D, the transmitted electric power is maintained at the third level.

In comparison with FIG. 16C, in FIG. 16D, the power receiver 100C disappears and the normalized received electric power of each of the power receivers 100A and 100B has not changed.

In FIG. 16D, the normalized received electric power of the power receiver 100A is lower than the lower limit value and the normalized received electric power of the power receiver 100B is between the lower limit value and the upper limit value. That is, the received electric power for the power receiver 100A is insufficient, and the received electric power for the power receiver 100B is appropriate.

In the state of FIG. 16D, in the flowchart that is illustrated in FIG. 13, NO is determined in step S13, and thus the transmitted electric power of the power transmitter 300 is increased from the third level by the predetermined electric power in step S16. FIG. 16E illustrates a state in which the transmitted electric power has been increased from that in the state that is illustrated in FIG. 16D. In FIG. 16E, the transmitted electric power is maintained at the fourth level.

In FIG. 16E, the normalized received electric power of each of the power receivers 100A and 100B is greater than that in FIG. 16D, and the normalized received electric power of each of the power receivers 100A and 100B is between the lower limit value and the upper limit value. That is, the received electric power for each of the power receivers 100A and 100B is appropriate.

Therefore, by adjusting the transmitted electric power of the power transmitter 300 and the duty cycle of the power receiver 100C, a state can be obtained in which the power receivers 100A and 100B can be charged at the same time.

Note that the power receiver 100C may be charged by sorting the power receiver 100C into another power supply group differing from that of the power receivers 100A and 100B.

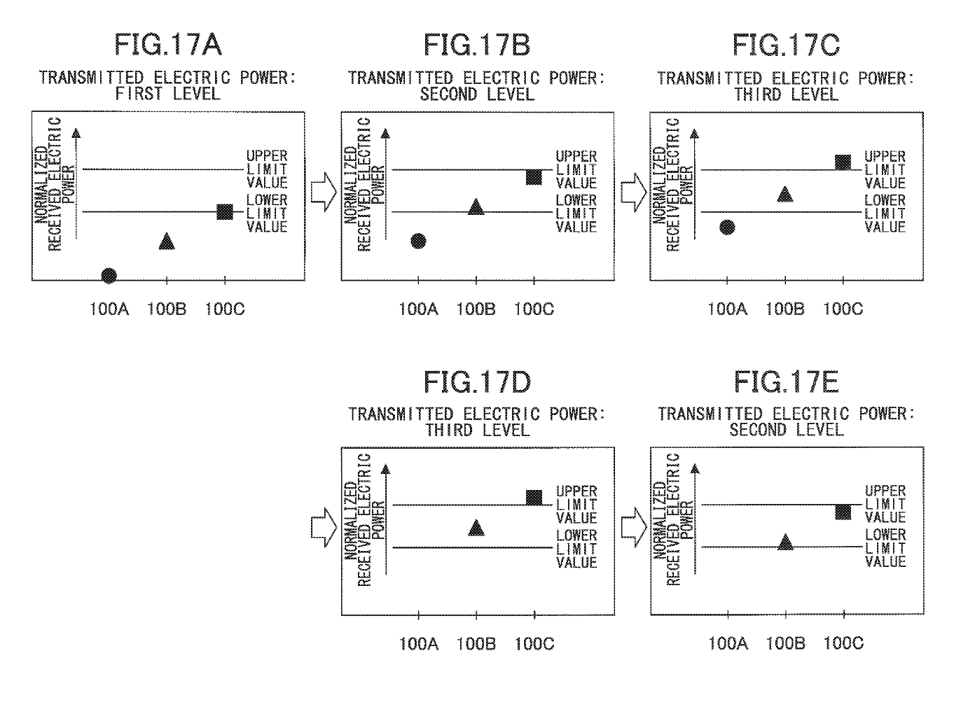

Power receivers 100A, 100B, and 100C used for description of FIG. 17 are similar to the power receivers 100A, 100B, and 100C used for description of FIG. 16. However, FIG. 17 differs from FIG. 16 in that the power transmitter 300 performs a control process to exclude, from the simultaneous power supply group, one power receiver 100 whose received electric power is the most insufficient in step S17 of FIG. 13.

The states illustrated in FIGS. 17A to 17C are similar to the states illustrated in FIGS. 14A to 14C. The state illustrated in FIG. 17A transitions to the state illustrated in FIG. 17C by increasing the transmitted electric power from that illustrated in FIG. 17A in a stepwise manner.

In the state of FIG. 17C, in the flowchart that is illustrated in FIG. 13, YES is determined in step S13 and NO is determined in step S14 because the number of instruction times to decrease the duty cycle is greater than the predetermined number of times by one. Then, in step S17, the power receiver 100A, whose received electric power is insufficient, is excluded from the simultaneous power supply group. FIG. 17D illustrates a state in which the power receiver 100A has been excluded from the state that is illustrated in FIG. 17C. Note that in FIG. 17D, the transmitted electric power is maintained at the third level.

In comparison with FIG. 17C, in FIG. 17D, the power receiver 100A disappears and the normalized received electric power of each of the power receivers 100B and 100C has not changed.

In FIG. 17D, the normalized received electric power of the power receiver 100B is between the lower limit value and the upper limit value and the normalized received electric power of the power receiver 100C is higher than the upper limit value. That is, the received electric power for the power receiver 100B is appropriate and the received electric power for the power receiver 100C is excessive.

In the state of FIG. 17D, in the flowchart that is illustrated in FIG. 13, NO is determined in step S13, and thus the transmitted electric power of the power transmitter 300 is decreased from the third level by the predetermined electric power in step S16. FIG. 17E illustrates a state in which the transmitted electric power has been decreased from that in the state that is illustrated in FIG. 17D. In FIG. 17E, the transmitted electric power is at the second level.

In FIG. 17E, the normalized received electric power of each of the power receivers 100B and 100C is lower than that in FIG. 17D, and the normalized received electric power of each of the power receivers 100B and 100C is between the lower limit value and the upper limit value. That is, the received electric power for each of the power receivers 100A and 100B is appropriate.

Therefore, by adjusting the transmitted electric power of the power transmitter 300 and the duty cycle of the power receiver 100A, a state can be obtained in which the power receivers 100B and 100C can be charged at the same time.

Note that the power receiver 100A may be charged by sorting the power receiver 100A into another power supply group differing from that of the power receivers 100B and 100C.

As described above, according to the power transmitting system 500 and the power transmitter 300 of the first embodiment, the transmitted electric output of the power transmitter 300 and duty cycles of PWM drive patterns of power receivers 100 are adjusted in accordance with whether the received electric power of each of the plurality of power receivers 100 is either excessive, insufficient, or appropriate. Whether the received electric power of each power receiver 100 is either excessive, insufficient, or appropriate corresponds to the power receiving state of the power receiver 100.

Such an adjustment can be realized by repeatedly executing a loop process illustrated in FIG. 13 in accordance with the power receiving states of the plurality of power receivers 100.

That is, for adjusting the transmitted electric output of the power transmitter 300 and the duty cycles of the PWM drive patterns of the power receivers 100, without calculating a coupling factor between the secondary-side resonant coil 110 of each power receiver 100 and the primary-side resonant coil 12 of the power transmitter 300, it is possible to realize a state in which simultaneous power supply can be performed easily and simply based on the power receiving states of the plurality of power receivers 100.

Therefore it is possible to provide the power transmitting system 500 and the power transmitter 300 that can efficiently charge power receivers 100.

Note that in the embodiment described above, electric power data, which indicates whether received electric power is excessive, appropriate, or insufficient, is generated by each power receiver 100 and the generated electric power data is transmitted to the power transmitter 300 such that the determination unit 340 determines whether the received electric power is excessive, appropriate, or insufficient based on the electric power data.

However, the electric power data may be data that indicates a rated output of each power receiver 100 and an upper limit value and a lower limit value of received electric power. Then, each power receiver 100 may transmit such electric power data to the power transmitter 300, and the controller 310 of the power transmitter 300 may determine, based on the electric power data that indicates the rated output of the power receiver 100 and the upper limit value and the lower limit value of received electric power, whether the received electric power is excessive, appropriate, or insufficient.

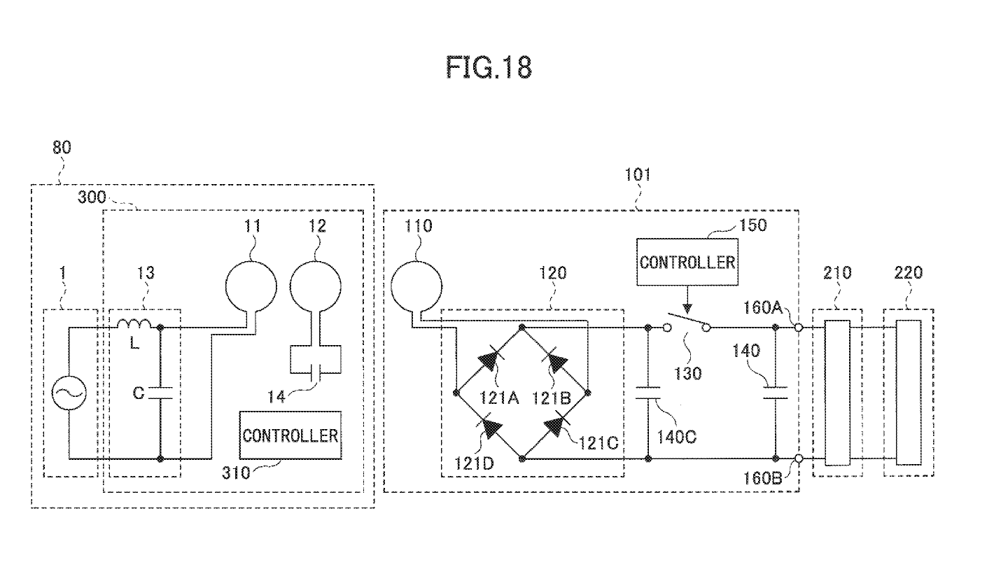

Further, in the embodiment described above, the switch 130 is directly coupled to the output side of the rectifier circuit 120. However, a power receiver 101 having a circuit configuration as illustrated in FIG. 18 may be used.

FIG. 18 is a diagram illustrating the power receiver 101 of a variation example of the embodiment. The power receiver 101 has a configuration in which a smoothing capacitor 140C has been added between the rectifier circuit 120 and the switch 130 in the power receiver 100 that is illustrated in FIG. 4. With this, electric power, on which the full wave rectification has been performed by the rectifier circuit 120, can be input to the switch 130 after being smoothed. Therefore, if effects of ripple included in the full wave rectified power occur, the effects of the ripple are effectively prevented, for example.

Further, in the above embodiment described as an example, each of the electronic devices 200A and 200B is a terminal device such as a tablet computer or a smartphone. However, each of the electronic devices 200A and 200B may be any electronic device that includes a chargeable battery such as a node Personal Computer (PC), a portable phone terminal, a portable game machine, a digital camera, or a video camera, for example.

Although the duty cycles of the PWM drive patterns for PWM-driving the switches 130 of the power receivers 100 are adjusted in the embodiment described above, the embodiment may be modified as follows.

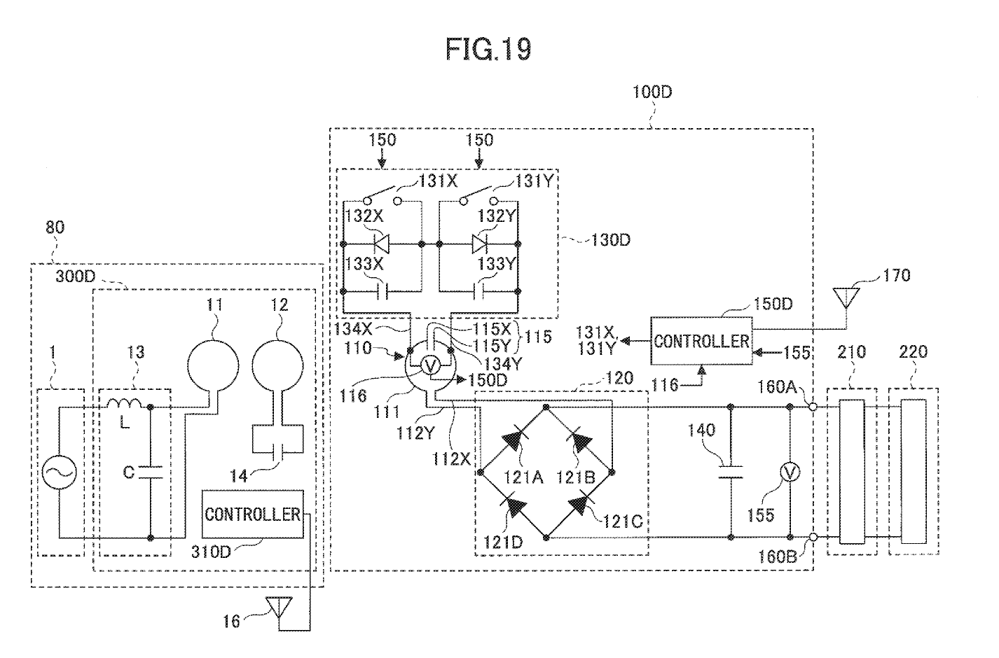

FIG. 19 is a diagram illustrating a power receiver 100D and a power transmitting apparatus 80 according to the first embodiment.

The transmitting apparatus 80 includes an AC power source 1 and a power transmitter 300D.

The power transmitter 300D includes a primary-side coil 11, a primary-side resonant coil 12, a matching circuit 13, a capacitor 14, a controller 310D, and an antenna 16. The power transmitter 300D is obtained by replacing the controller 310 of the power transmitter 300, which is illustrated in FIG. 4, with the controller 310D.

The controller 310D differs from the controller 310 in adjusting an adjustor 130D of the power receiver 100D.

The power receiver 100D includes a secondary-side resonant coil 110, a capacitor 115, a voltmeter 116, a rectifier circuit 120, an adjuster 130D, a smoothing capacitor 140, a controller 150D, a voltmeter 155, output terminals 160A and 160B, and an antenna 170. A DC-DC converter 210 is coupled to the output terminals 160A and 160B, and a battery 220 is coupled to an output side of the DC-DC converter 210.

The secondary-side resonant coil 110 has a resonant frequency equal to that of the primary-side resonant coil 12, and is designed to have a very high Q factor. The secondary-side resonant coil 110 includes a resonant coil part 111, and terminals 112X and 112Y. Here, although the resonant coil part 111 is substantially equivalent to the secondary-side resonant coil 110, a configuration, in which the terminals 112X and 112Y are provided on both ends of the resonant coil part 111, is treated as the secondary-side resonant coil 110.

In the resonant coil part 111, the capacitor 115 for adjusting the resonant frequency is inserted in series. Further, the adjuster 130D is coupled in parallel with the capacitor 115. Further, the terminals 112X and 112Y are provided on both ends of the resonant coil part 111. The terminals 112X and 112Y are coupled to the rectifier circuit 120. The terminals 112X and 112Y are examples of a first terminal and a second terminal, respectively.

The secondary-side resonant coil 110 is coupled to the rectifier circuit 120 without introducing a secondary-side coil. In a state where resonance generation is enabled by the adjuster 130D, the secondary-side resonant coil 110 outputs, to the rectifier circuit 120, the AC power transmitted from the primary-side resonant coil 12 of the power transmitter 300D through the magnetic field resonance.

The capacitor 115 is inserted in series with the resonant coil part 111 for adjusting the resonant frequency of the secondary-side resonant coil 110. The capacitor 115 includes the terminals 115X and 115Y. Further, the adjuster 130D is coupled in parallel with the capacitor 115.

The voltmeter 116 is coupled in parallel with the capacitor 115, to measure the voltage between both terminals of the capacitor 115. The voltmeter 116 detects the voltage of the AC power received by the secondary-side resonant coil 110, and transmits a signal indicating the voltage to the controller 150D. The AC voltage measured by the voltmeter 116 is used for synchronizing a driving signal that drives switches 131X and 131Y.

The rectifier circuit 120 includes four diodes 121A to 121D. The diodes 121A to 121D are coupled in a bridge-like configuration, and rectify the full wave of the electric power input from the secondary-side resonant coil 110 to output the full-wave rectified power.

The adjuster 130D is coupled in parallel with the capacitor 115 in the resonant coil part 111 of the secondary-side resonant coil 110.

The adjuster 130D includes the switches 131X and 131Y, diodes 132X and 132Y, capacitors 133X and 133Y, and the terminals 134X and 134Y.

The switches 131X and 131Y are coupled in series with each other between the terminals 134X and 134Y. The switches 131X and 131Y are examples of a first switch and a second switch, respectively. The terminals 134X and 134Y are coupled to the terminals 115X and 115Y of the capacitor 115, respectively. Therefore, the series circuit of the switches 131X and 131Y is coupled in parallel with the capacitor 115.

The diode 132X and the capacitor 133X are coupled in parallel with the switch 131X. The diode 132Y and the capacitor 133Y are coupled in parallel with the switch 131Y. The diodes 132X and 132Y have their respective anodes coupled to each other, and have their respective cathodes coupled to the capacitor 115. That is, the diodes 132X and 132Y are coupled so that the respective rectification directions are opposite.

Note that the diodes 132X and 132Y are examples of a first rectifier and a second rectifier, respectively. Also, the adjuster 130D is not required to include the capacitors 133X and 133Y.

As the switch 131X, the diode 132X, and the capacitor 133X, FETs (Field Effect Transistors) may be used, for example. The body diode between the drain and source of a P-channel or N-channel FET may be coupled to have the rectification direction of the diode 132X as in the figure. When using an N-channel FET, the source corresponds to the anode of the diode 132X and the drain corresponds to the cathode of the diode 132X.

Also, the switch 131X is implemented by switching the coupling state between the drain and the source by receiving the driving signal output from the controller 150D as input into the gate. Also, the capacitor 133X is implemented by the parasitic capacitance between the drain and the source.

Similarly, as the switch 131Y, the diode 132Y, and the capacitor 133Y, FETs may be used, for example. The body diode between the drain and source of a P-channel or N-channel FET may be coupled to have the rectification direction of the diode 132Y as in the figure. When using an N-channel FET, the source corresponds to the anode of the diode 132Y and the drain corresponds to the cathode of the diode 132Y.

Also, the switch 131Y is implemented by switching the coupling state between the drain and the source by receiving the driving signal output from the controller 150D as input into the gate. Also, the capacitor 133Y is implemented by the parasitic capacitance between the drain and the source.

Note that the switch 131X, the diode 132X, and the capacitor 133X are not limited to those implemented by FETs, but may be implemented by having a switch, a diode, and a capacitor coupled in parallel. This is the same for the switch 131Y, the diode 132Y, and the capacitor 133Y.

The switches 131X and 131Y can be turned on/off in the phases opposite to each other. When the switch 131X is off and the switch 131Y is on, the power receiver 100D is in a state where a resonance current may flow in the adjuster 130D in a direction going from the terminal 134X to the terminal 134Y through the capacitor 133X and the switch 131Y, and the resonance current may flow in the capacitor 115 from the terminal 115X to the terminal 115Y. That is, the power receiver 100D in FIG. 19 transitions to a state where the resonance current may flow in the secondary-side resonant coil 110 in the clockwise direction.

Also, when the switch 131X is on and the switch 131Y is off, the electric current path generated in the adjuster 130D goes from the terminal 134X to the terminal 134Y through the switch 131X and the diode 132Y. Because this electric current path is parallel with the capacitor 115, the current stops flowing in the capacitor 115.

Therefore, when the power receiver 100D transitions from a state where the switch 131X is off, the switch 131Y is on, and hence, the resonance current flows in the secondary-side resonant coil 110 in the clockwise direction, to a state where the switch 131X is on and the switch 131Y is off, the resonance current stops occurring. This is because the capacitor is no longer included in the electric current path.

When the switch 131X is on and the switch 131Y is off, the power receiver 100D is in a state where a resonance current may flow in the adjuster 130D in a direction going from the terminal 134Y to the terminal 134X through the capacitor 133Y and the switch 131X and the resonance current may flow in the capacitor 115 from the terminal 115Y to the terminal 115X. That is, the power receiver 100D in FIG. 19 transitions to a state where the resonance current may flow in the secondary-side resonant coil 110 in the counterclockwise direction.

Also, when the switch 131X is off and the switch 131Y is on, the electric current path generated in the adjuster 130D goes from the terminal 134Y to the terminal 134X through the switch 131Y and the diode 132X. Because this electric current path is parallel with the capacitor 115, the current stops flowing in the capacitor 115.

Therefore, when the power receiver 100D transitions from a state where the switch 131X is on, the switch 131Y is off, and hence, the resonance current flows in the secondary-side resonant coil 110 in the counterclockwise direction, to a state where the switch 131X is off and the switch 131Y is on, the resonance current stops occurring. This is because the capacitor is no longer included in the electric current path.

The adjuster 130D switches the switches 131X and 131Y as described above to switch between a state where the resonance current may be generated, and a state where the resonance current is not generated. The switches 131X and 131Y are switched by a driving signal output from the controller 150D.

The frequency of the driving signal is set to the AC frequency received by the secondary-side resonant coil 110.

The switches 131X and 131Y cut off the AC current at a high frequency as described above. For example, the adjuster 130D having two FETs combined can cut off the AC current at high speed.

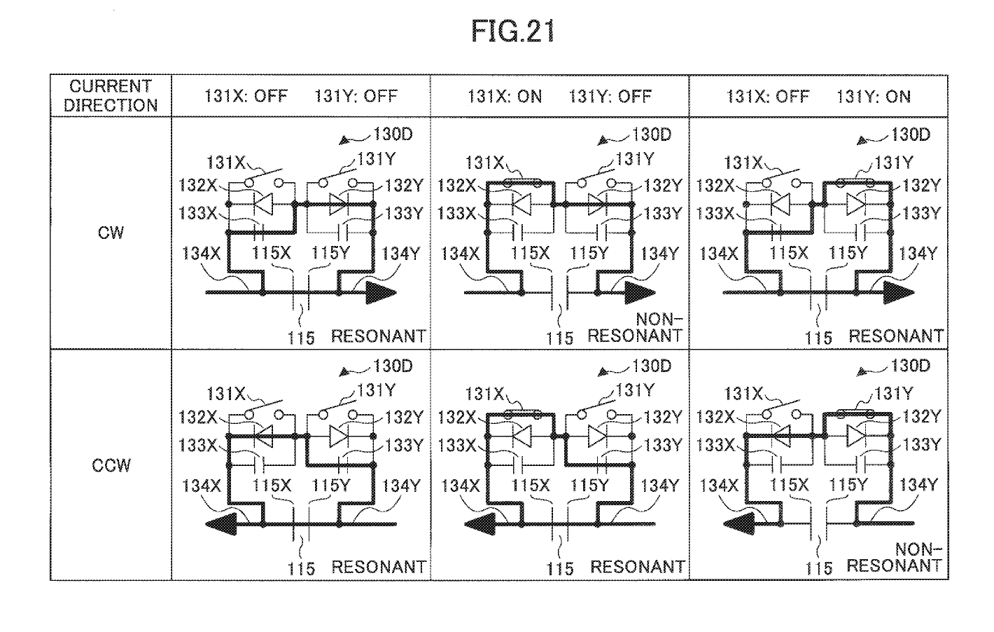

Note that the driving signal and operations of the adjuster 130D will be described later below with reference to FIG. 21.

The smoothing capacitor 140 is coupled to the output side of the rectifier circuit 120, and smoothes the electric power, on which the full-wave rectification is performed by the rectifier circuit 120, and outputs the smoothed power as direct-current power. The output terminals 160A and 160B are coupled to the output side of the smoothing capacitor 140. Because the negative component of AC power has been inverted into the positive component, the electric power on which the full-wave rectification has been performed by the rectifier circuit 120 can be treated as substantially AC power. However, stable DC power can be obtained by using the smoothing capacitor 140 even when ripple is included in the full wave rectified power.

Note that a line, which couples an upper side terminal of the smoothing capacitor 140 and the output terminal 160A, is a higher voltage side line, and a line, which couples a lower side terminal of the smoothing capacitor 140 and the output terminal 160B, is a lower voltage side line.

The controller 150D stores, in an internal memory, data that indicates the rated output of the battery 220. Further, in response to a request from the controller 310D of the power transmitter 300D, the controller 150D measures electric power (received electric power), which the power receiver 100D receives from the power transmitter 300D, and transmits the data, which indicates the received electric power, to the power transmitter 300D via the antenna 170.

Further, upon receiving data that indicates a phase difference from the power transmitter 300D, the controller 150D uses the received phase difference to generate a driving signal to drive the switches 131X and 131Y. Note that the received electric power may be obtained by the controller 150D based on a voltage V measured by the voltmeter 155 and on an internal resistance value R of the battery 220. The received electric power P may be calculated by a formula of P=V²/R.

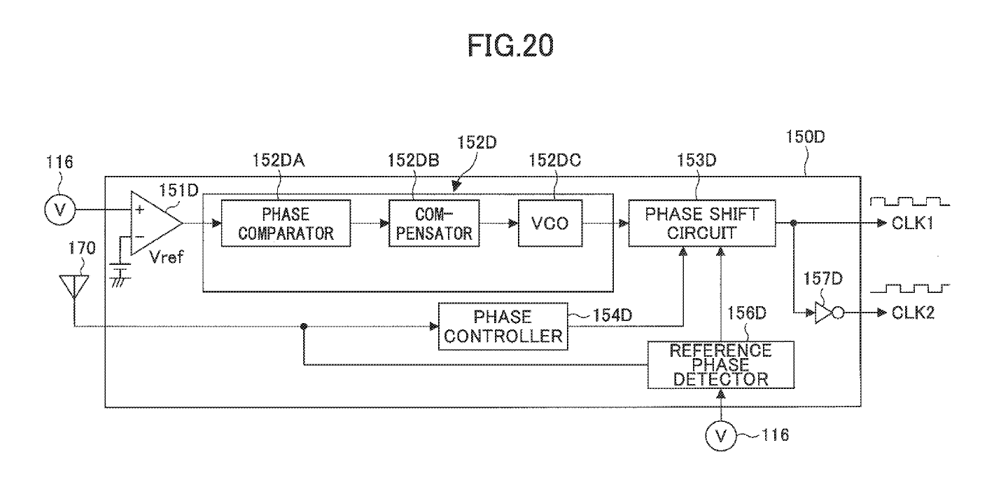

Here, the controller 150D will be described with reference to FIG. 20. FIG. 20 is a diagram illustrating an internal configuration of the controller 150D.

The controller 150D includes a comparator 151D, a PLL (Phase Locked Loop circuit) 152D, a phase shift circuit 153D, a phase controller 154D, an inverter 157D, and a reference phase detector 156D.

The comparator 151D compares an AC voltage detected by the voltmeter 116 with a predetermined reference voltage Vref, and outputs a clock signal to the PLL 152D.

The PLL 152D includes a phase comparator 152DA, a compensator 152DB, and a VCO (Voltage Controlled Oscillator) 152DC. The phase comparator 152DA, the compensator 152DB, and the VCO 152DC are coupled in series, and coupled to have the output of VCO 152DC fed back to the phase comparator 152DA. Configured as such, the PLL 152D outputs a clock signal that is synchronized with the signal input from the comparator 151D.

The phase shift circuit 153D is coupled on the output side of the PLL 152D, and based on a signal indicating the phase difference that is input from the phase controller 154D, shifts the phase of the clock signal output from the PLL 152D with respect to the reference phase, and outputs the shifted clock signal. As the phase shift circuit 153D, a phase shifter may be used, for example.

Upon receiving the signal indicating the phase difference transmitted from the power transmitter 300D as input, the phase controller 154D converts the signal indicating the phase difference into a signal for the phase shift circuit 153D, and outputs the converted signal.

The clock signal whose phase has been shifted by the phase difference with respect to the reference phase based on the signal input from the phase controller 154D, is branched off in two ways; one is output as it is as a clock signal CLK1, and the other is inverted by the inverter 157D, and output as a clock signal CLK2. The clock signals CLK1 and CLK2 are control signals output by the controller 150D.

The reference phase detector 156D controls the amount of shift by which the phase shift circuit 153D shifts the phase of the clock signal, so as to adjust the phase of the clock signal output by the phase shift circuit 153D with respect to the clock signal output by the PLL 152D, and to detect the phase at which the maximum efficiency of electric power reception is obtained.

Then, the reference phase detector 156D holds the detected phase in its internal memory as the reference phase. The operating point at which the efficiency of electric power reception reaches the maximum is a point at which the voltage value detected by the voltmeter 116 reaches the maximum. Therefore, the reference phase detector 156D adjusts the amount of shift of the phase given in the phase shift circuit 153D to detect a point at which the voltage value detected by the voltmeter reaches the maximum, and holds the phase at the operating point in its internal memory as the reference phase.

Here, the clock signal output by the PLL 152D corresponds to the phase of the AC voltage through magnetic field resonance detected by the voltmeter 116. Therefore, adjusting the amount of shift of the phase given by the phase shift circuit 153D to the clock signal output by the PLL 152D is controlling, in the phase shift circuit 153D, the amount of shift of the phase of the clock signal with respect to the voltage waveform detected by the voltmeter 116.

The reference phase is a phase of the clock signals CLK1 and CLK2 with respect to the AC voltage at which the maximum efficiency of electric power reception is obtained. For adjusting the received electric power with this this reference phase treated as 0 degrees, the phase difference of the phase of the clock signals CLK1 and CLK2 with respect to the reference phase (0 degrees) is adjusted in the phase shift circuit 153D.

Here, because a phase of the AC voltage is not detected, the amount of shift of the phase given by the phase shift circuit 153D to the clock signals CLK1 and CLK2 with which the maximum efficiency of electric power reception is obtained is treated as the reference phase.

Note that although the embodiment is described here in which the phase of the clock signal output from the PLL 152D is adjusted by the phase shift circuit 153D with respect to the AC voltage detected by the voltmeter 116, an ammeter may be used instead of the voltmeter 116, to adjust the phase of the clock signal in the phase shift circuit 153D with respect to the AC current.

The voltmeter 155 is coupled between the output terminals 160A and 160B. The voltmeter 155 is used to calculate the received electric power of the power receiver 100D. Because in comparison with a case of measuring received electric power by measuring an electric current, losses are low by obtaining the received electric power based on the voltage V measured by the voltmeter 155 and on the internal resistance value R of the battery 220 as described above, thus it is a preferable measuring method. However, the received electric power of the power receiver 100D may also be calculated by measuring the electric current and the voltage. When measuring the electric current, a Hall Element, a magnetic resistance element, a detection coil, a resistor, or the like may be used for the measurement.

The DC-DC converter 210 is coupled to the output terminals 160A and 160B, and converts the voltage of the direct-current power that is output from the power receiver 100D into the rated voltage of the battery 220 to output the converted voltage. The DC-DC converter 210 lowers the output voltage of the rectifier circuit 120 to the rated voltage of the battery 220 in a case where the output voltage of the rectifier circuit 120 is higher than the rated voltage of the battery 220. The DC-DC converter 210 raises the output voltage of the rectifier circuit 120 to the rated voltage of the battery 220 in a case where the output voltage of the rectifier circuit 120 is lower than the rated voltage of the battery 220.

The battery 220 may be any rechargeable secondary battery that can be repeatedly charged. For example, a lithium ion battery may be used as the battery 220. For example, in a case where the power receiver 100D is included in an electronic device such as a tablet computer or a smartphone, the battery 220 is a main battery of such an electronic device.

For example, the primary-side coil 11, the primary-side resonant coil 12, and the secondary-side resonant coil 110 may be made by winding copper wire. However, materials of the primary-side coil 11, the primary-side resonant coil 12, and the secondary-side resonant coil 110 may be metal other than copper (e.g., gold, aluminum, etc.). Further, materials of the primary-side coil 11, the primary-side resonant coil 12, and the secondary-side resonant coil 110 may be different from one another.

In such a configuration, the primary-side coil 11 and the primary-side resonant coil 12 correspond to a power transmitting side, and the secondary-side resonant coil 110 corresponds to a power receiving side.

According to a magnetic field resonance system, magnetic field resonance, generated between the primary-side resonant coil 12 and the secondary-side resonant coil 110, is utilized to transmit electric power from the power transmitting side to the power receiving side. Hence, it is possible to transmit the electric power over a longer distance than that of an electromagnetic induction system that utilizes electromagnetic induction to transmit electric power from the power transmitting side to the power receiving side.

The magnetic field resonance system is more flexible than the electromagnetic induction system with respect to the position gap or the distance between the resonant coils. The magnetic field resonance system thus has an advantage called “free-positioning”.

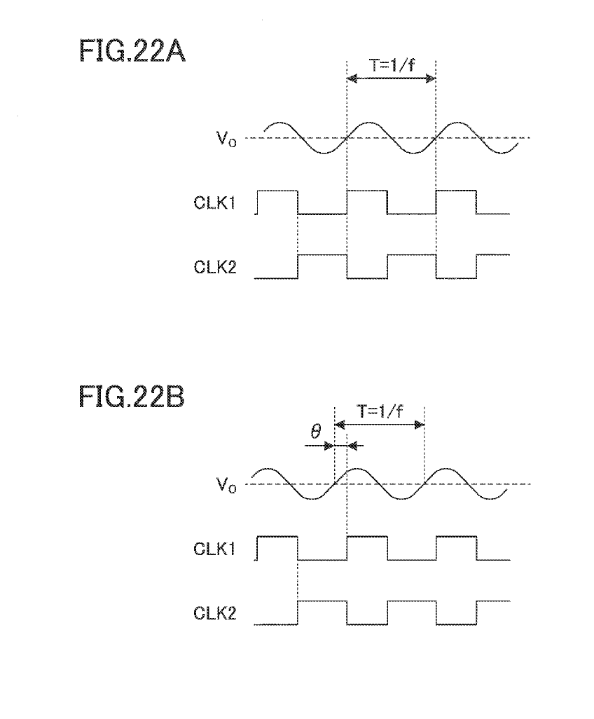

Next, current paths generated when the switches 131X and 131Y are driven by the driving signal will be described with reference to FIG. 21 and FIG. 22.

FIG. 21 is a diagram illustrating current paths in the capacitor 115 and the adjuster 130D. In FIG. 21, as in FIG. 19, an electric current direction will be referred to as the clockwise (CW) direction for an electric current flowing from the terminal 134X to the terminal 134Y through the capacitor 115 or the inside of the adjuster 130D. Also, an electric current direction will be referred to as the counterclockwise (CCW) direction for an electric current flowing from the terminal 134Y to the terminal 134X through the capacitor 115 or the inside of the adjuster 130D.

First, in a case where the switches 131X and 131Y are both off and an electric current flows clockwise (CW), a resonance current flows in the direction from the terminal 134X to the terminal 134Y through the capacitor 133X and the diode 132Y, and the resonance current flows in the capacitor 115 from the terminal 115X to the terminal 115Y. Therefore, the resonance current flows in the secondary-side resonant coil 110 in the clockwise direction.

In a case where the switches 131X and 131Y are both off and an electric current flows counterclockwise (CCW), a resonance current flows in the direction from the terminal 134Y to the terminal 134X through the capacitor 133Y and the diode 132X, and the resonance current flows in the capacitor 115 from the terminal 115Y to the terminal 115X. Therefore, the resonance current flows in the secondary-side resonant coil 110 in the counterclockwise direction.

In a case where the switch 131X is on, the switch 131Y is off, and an electric current flows clockwise (CW), the electric current path generated in the adjuster 130D goes from the terminal 134X to the terminal 134Y through the switch 131X and the diode 132Y. Because this electric current path is parallel with the capacitor 115, the current stops flowing in the capacitor 115. Therefore, the resonance current does not flow in the secondary-side resonant coil 110. Note that in this case, even if the switch 131Y is turned on, the resonance current does not flow in the secondary-side resonant coil 110.

In a case where the switch 131X is on, the switch 131Y is off, and an electric current flows counterclockwise (CCW), a resonance current flows in the adjuster 130D in the direction from the terminal 134Y to the terminal 134X through the capacitor 133Y and the switch 131X, and the resonance current flows in the capacitor 115 from the terminal 115Y to the terminal 115X. Therefore, the resonance current flows in the secondary-side resonant coil 110 in the counterclockwise direction. Note that electric current also flows in the diode 132X, which is parallel with the switch 131X.

In a case where the switch 131X is off, the switch 131Y is on, and an electric current flows clockwise (CW), a resonance current flows in the adjuster 130D in the direction from the terminal 134X to the terminal 134Y through the capacitor 133X and the switch 131Y, and the resonance current flows in the capacitor 115 from the terminal 115X to the terminal 115Y. Therefore, the resonance current flows in the secondary-side resonant coil 110 in the clockwise direction. Note that electric current also flows in the diode 132Y, which is parallel with the switch 131Y.

In a case where the switch 131X is off, the switch 131Y is on, and an electric current flows counterclockwise (CCW), the electric current path generated in the adjuster 130D goes from the terminal 134Y to the terminal 134X through the switch 131Y and the diode 132X. Because this electric current path is parallel with the capacitor 115, the current stops flowing in the capacitor 115. Therefore, the resonance current does not flow in the secondary-side resonant coil 110. Note that in this case, even if the switch 131X is turned on, the resonance current does not flow in the secondary-side resonant coil 110.

Note that the electrostatic capacitance that contributes to the resonant frequency of the resonance current is determined depending on the capacitor 115 and the capacitor 133X or 133Y. Therefore, it is desirable that the electrostatic capacitance of the capacitor 133X is equal to the electrostatic capacitance of the capacitor 133Y.

FIGS. 22A and 22B are diagrams illustrating an AC voltage generated in the secondary-side resonant coil 110 and two clock signals included in a driving signal.

An AC voltage V₀ illustrated in FIG. 22A and FIG. 22B is indicated by a waveform having the same frequency as the power transmission frequency, is an AC voltage generated, for example, in the secondary-side resonant coil 110, and detected by the voltmeter 116 (see FIG. 4). Also, the clock signals CLK1 and CLK2 are two clock signals included in a driving signal. For example, the clock signal CLK1 is used to drive the switch 131X, and the clock signal CLK2 is used to drive the switch 131Y. The clock signals CLK1 and CLK2 are examples of a first signal and a second signal, respectively.

In FIG. 22A, the clock signals CLK1 and CLK2 are synchronized with the AC voltage V₀. That is, the frequency of the clock signals CLK1 and CLK2 is equal to the frequency of the AC voltage V₀, and the phase of the clock signal CLK1 is equal to the phase of the AC voltage V₀. Note that the clock signal CLK2 has a phase different from that of the clock signal CLK1 by 180 degrees, namely, the opposite phase.

In FIG. 22A, the period T of the AC voltage V₀ is the reciprocal of the frequency f, and the frequency f is 6.78 MHz.

As illustrated in FIG. 22A, the clock signals CLK1 and CLK2 synchronizing with the AC voltage V₀ may be generated by the controller 150D using the PLL 152D in a state where the switches 131X and 131Y are turned off, and further in a state where the power receiver 100D receives electric power from the power transmitter 300D and generates a resonance current in the secondary-side resonant coil 110.

In FIG. 22B, the phases of the clock signals CLK1 and CLK2 are behind the AC voltage V₀ by 0 degrees. Such clock signals CLK1 and CLK2 having the phase difference of 0 degrees with respect to the AC voltage V₀ may be generated by the controller 150D using the phase shift circuit 153D.

The controller 150D adjusts the phase difference of the two clock signals CLK1 and CLK2 with respect to the AC voltage V₀, to detect a phase at which the maximum efficiency of electric power reception is obtained. The phase at which the maximum efficiency of electric power reception obtained is a phase at which the electric power received by the power receiver 100D reaches the maximum, and the received electric power reaches the maximum when the resonance state continues over the entire period of one cycle because of the phase difference of the two clock signals CLK1 and CLK2 with respect to the AC voltage V₀. Therefore, the controller 150D increases and decreases the phase difference of the two clock signals CLK1 and CLK2 with respect to the AC voltage V₀ to detect the phase difference that makes the received electric power maximum, and treats the detected phase difference as 0 degrees.

Then, based on the phase difference that makes the received electric power the maximum (0 degrees) and data received from the power transmitter 300D indicating the phase difference, the controller 150D sets the phase difference of the two clock signals with respect to the AC voltage V₀ in the phase shift circuit 153D.

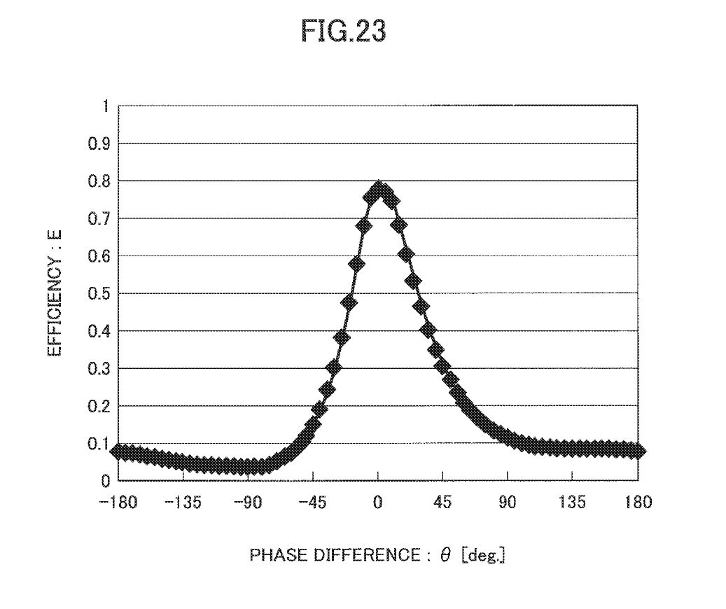

Next, with reference to FIG. 23, the efficiency of electric power reception of the power receiver 100D will be described when receiving the electric power from the power transmitter 300D in a case where the phase difference of the driving signal is adjusted.

FIG. 23 is a diagram illustrating a simulation result indicating a property of efficiency of electric power reception with respect to a phase difference of a driving signal. The phase difference on the horizontal axis indicates the phase difference of the two clock signals with respect to the AC voltage V₀ where 0 degrees is set as the phase difference making the received electric power maximum. The efficiency of electric power reception on the vertical axis indicates the ratio of electric power output by the power receiver 100D (Pₒᵤₜ) to electric power input into the power transmitter 300D by the AC power supply 1 (Pᵢₙ) (see FIG. 1). The efficiency of electric power reception is equal to the efficiency of electric power transmission between the power transmitter 300D and the power receiver 100D.

Note that the frequency of the electric power transmitted by the power transmitter 300D is 6.78 MHz, and the frequency of the driving signal is set to be the same. Also, the state where the phase difference is 0 degrees is a state where the resonance through magnetic resonance is generated in the secondary-side resonant coil 110 over the entire period of one cycle of the resonance current, and the resonance current is flowing in the secondary-side resonant coil 110. An increase of the phase difference means that the period during which the resonance is not generated in the secondary-side resonant coil 110 becomes longer in one cycle of the resonance current. Therefore, the state where the phase difference is 180 degrees is a state where the resonance current does not flow in the secondary-side resonant coil 110 at all, theoretically.

As illustrated in FIG. 23, when the phase difference is increased from 0 degrees, the efficiency of electric power reception decreases. When the phase difference becomes approximately 60 degrees or greater, the efficiency of electric power reception becomes approximately 0.1 or less. In this way, changing the phase difference of the two clock signals with respect to the AC voltage V₀ changes the amount of electric power of the resonance current flowing in the secondary-side resonant coil 110, and changes the efficiency of electric power reception.

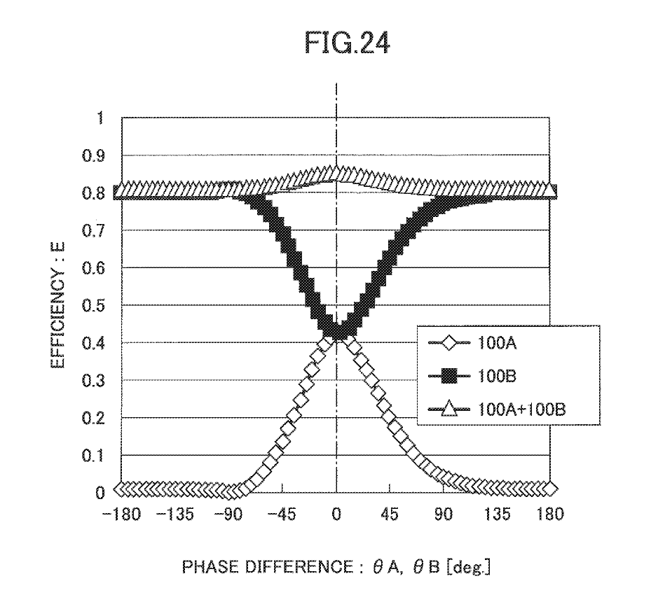

FIG. 24 is a diagram illustrating a relationship between the phase differences of the driving signal and the efficiencies of electric power reception of two power receivers A and B.

Each of the two power receivers A and B is similar to the power receiver 100D, which is illustrated in FIG. 19. Here, for when the power transmitter 300D transmits electric power to the two power receivers A and B, a method by which the controller 150D of the power receiver A controls the adjuster 130D of the power receiver A when power is transmitted from the power transmitter 300D to the two power receivers A and B, and a method by which the controller 150D of the power receiver B controls the adjuster 130D of the power receiver B will be described.

A case will be described here where the phase difference of the driving signal for driving the adjuster 130D of the power receiver A is changed from the phase difference (0 degrees) at which the efficiency of electric power reception reaches the maximum, in a state where the phase difference of the driving signal for driving the adjuster 130D of the power receiver B is fixed to the phase difference (0 degrees) at which the efficiency of electric power reception reaches the maximum.

In FIG. 24, the horizontal axis indicates the phase difference θA of the driving signal for driving the adjuster 130D of the power receiver A and the phase difference θB of the driving signal for driving the adjuster 130D of the power receiver B. Also, the vertical axis on the left indicates the respective efficiencies of electric power reception of the power receivers A and B, and the total value of the efficiencies of electric power reception of the power receivers A and B.

In a state where the phase difference of the driving signal for driving the adjuster 130D of the power receiver B is fixed to 0 degrees, when the phase difference of the driving signal for driving the adjuster 130D of the power receiver A is increased or decreased from 0 degrees, as illustrated in FIG. 24, the ratio of the efficiency of electric power reception of the power receiver A decreases. The efficiency of electric power reception of the power receiver A is the maximum when the phase difference is 0 degrees. Also, the ratio of the efficiency of electric power reception of the power receiver B increases in response to a decrease of the efficiency of electric power reception of the power receiver A.

In this way, when the phase difference of the driving signal for driving the adjuster 130D of the power receiver A is changed, the amount of electric power received by the power receiver A decreases, and therefore the electric current flowing in the power receiver A also decreases. That is, changing the phase difference changes the impedance of the power receiver A.

In simultaneous electric power transmission using magnetic field resonance, electric power, transmitted from the power transmitter 300D to the power receivers A and B through the magnetic field resonance, is distributed to the power receivers A and B. Therefore, when the phase difference of the driving signal for driving the adjuster 130D of the power receiver A is changed from 0 degrees, the amount of electric power to be received by the power receiver B increases by the decreased amount of the electric power to be received by the power receiver A.

Therefore, as illustrated in FIG. 24, the ratio of the efficiency of electric power reception of the power receiver A decreases. Further, in response to the decrease of the ratio of the efficiency of electric power reception of the power receiver A, the ratio of the efficiency of electric power reception of the power receiver B increases.

When the phase difference of the driving signal for driving the adjuster 130D of the power receiver A changes to approximately ±90 degrees, the ratio of the efficiency of electric power reception of the power receiver A decreases to nearly 0, and the ratio of the efficiency of electric power reception of the power receiver B increases to approximately 0.8.

Then, the sum of the efficiencies of electric power reception of the power receivers A and B is approximately 0.85 when the phase difference of the driving signal for driving the adjuster 130D of the power receiver A is 0 degrees. Upon the phase difference of the driving signal for driving the adjuster 130D of the power receiver A decreasing to approximately ±90 degrees, the sum of the efficiencies of electric power reception of the power receivers A and B becomes approximately 0.8.

In this way, while the phase difference of the driving signal for driving the adjuster 130D of the power receiver B is fixed to 0 degrees, when the phase difference of the driving signal for driving the adjuster 130D of the power receiver A is changed from 0 degrees, the ratio of the efficiency of electric power reception of the power receiver A decreases, and the ratio of the efficiency of electric power reception of the power receiver B increases. Also, the sum of the efficiencies of electric power reception of the power receivers A and B does not change largely from a value around 0.8.

In simultaneous electric power transmission using magnetic field resonance, electric power, transmitted from the power transmitter 300D to the power receivers A and B through the magnetic field resonance, is distributed to the power receivers A and B. Therefore, even if the phase difference changes, the sum of the efficiencies of electric power reception of the power receivers A and B does not largely change.

Similarly, while the phase difference of the driving signal for driving the adjuster 130D of the power receiver A is fixed to 0 degrees, when the phase difference of the driving signal for driving the adjuster 130D of the power receiver B is decreased from 0 degrees, the ratio of the efficiency of electric power reception of the power receiver B decreases, and the ratio of the efficiency of electric power reception of the power receiver A increases. Also, the sum of the efficiencies of electric power reception of the power receivers A and B does not largely change from a value around 0.8.

Therefore, by adjusting either the phase difference of the driving signal for driving the adjuster 130D of the power receiver A or the phase difference of the driving signal for driving the adjuster 130D of the power receiver B, the ratios of the efficiencies of electric power reception of the power receivers A and B can be adjusted.

As described above, upon changing the phase difference of the driving signal for driving the adjuster 130D of the power receiver A or B, the ratios of the efficiencies of electric power reception of the secondary-side resonant coils 110A and 110B of the power receivers A and B are changed.

Hence, here, one of the phase difference of the driving signal for the adjuster 130D of the power receiver A and the phase difference of the driving signal for the adjuster 130D of the power receiver B is changed from a reference phase difference. For example, a phase difference at which the efficiency of electric power reception is the maximum is defined as the reference phase difference (0 degrees), in which case, the other phase difference is changed from 0 degrees.

At this time, determination, as to whether to change the phase difference of the driving signal of the adjuster 130D of the power receiver A or to change the phase difference of the driving signal of the adjuster 130D of the power receiver B from the reference phase difference, is made as follows.

First, a first value, obtained by dividing the rated output of the battery 220 of the power receiver A by the efficiency of electric power reception of the secondary-side resonant coil 110 of the power receiver A and a second value, obtained by dividing the rated output of the battery 220 of the power receiver B by the efficiency of electric power reception of the secondary-side resonant coil 110 of the power receiver B, are calculated.

Then, the phase difference of the driving signal corresponding to the power receiver (A or B), having the smaller value among the first value and the second value, is increased from 0 degrees to an appropriate phase difference.

The value, obtained by dividing the rated output by the efficiency of electric power reception, indicates an amount of electric power (required amount of electric power transmission) to be transmitted from the power transmitter 300D to the power receiver A or B. The required amount of electric power transmission is an amount of electric power to be transmitted from the power transmitter 300D so that the power receiver (A or B) receives the electric power without generating excessive electric power and insufficient electric power.

Accordingly, by reducing an amount of electric power supplied to the power receiver (A or B) of which the required amount of electric power transmission is smaller, it is possible to increase an amount of electric power supplied to the power receiver (A or B) of which the required amount of electric power transmission is larger. As a result, it is possible to improve the balance between the amount of electric power supplied to the power receiver A and the amount of electric power supplied to the power receiver B.

As can be seen from FIG. 24, when the phase difference of one power receiver (A or B) is decreased, the amount of received electric power of the one power receiver (A or B) decreases. Further, the amount of received electric power of the other power receiver (A or B) increases in a state in which the phase difference of the other power receiver (A or B) is fixed to 0 degrees.

Hence, by changing, from the reference phase difference (0 degrees), the phase difference of the driving signal corresponding to the power receiver (A or B) of which the required amount of electric power transmission is smaller, it is possible to reduce the amount of electric power supplied to the power receiver (A or B) of which the required amount of electric power transmission is smaller and to increase the amount of electric power supplied to the power receiver (A or B) of which the required amount of electric power transmission is larger.

As described above, the controller 150D of the power receiver A and the controller 150D of the power receiver B change the phase difference of the driving signal for driving the adjuster 130D of the power receiver A and the phase difference of the driving signal for driving the adjuster 130D of the power receiver B, to control the amounts of electric power received by the power receivers A and B.

Further, the embodiment may be modified as follows.

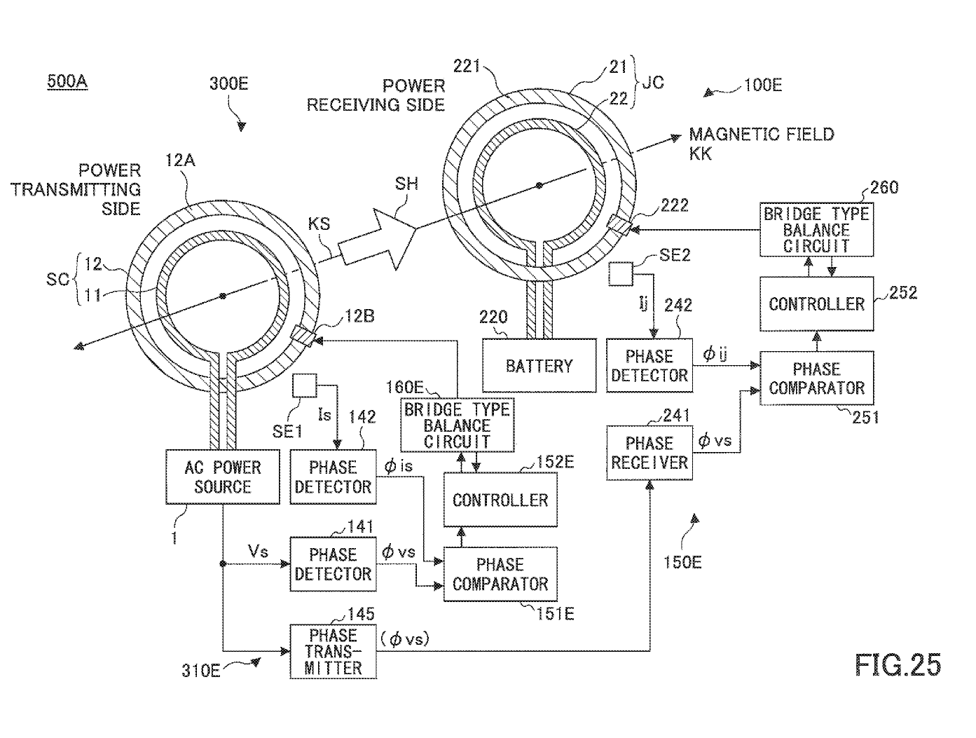

FIG. 25 is a schematic diagram illustrating a magnetic field resonance type power transmitting system 500A according to a third variation example of the first embodiment. The power transmitting system 500A includes a power transmitter 300E and a power receiver 100E.

In FIG. 25, a power transmitting coil SC includes a primary-side coil 11 and a primary-side resonant coil 12. The primary-side coil 11 is made by winding multiple turns of a metal wire such as a copper wire or an aluminum wire in a circumferential manner, and an alternating-current voltage (high frequency voltage) is applied by an AC power source 1 to both ends of the primary-side coil 11.

The primary-side resonant coil 12 includes a coil 12A made by winding a metal wire such as a copper wire or an aluminum wire in a circumferential manner and a capacitor 12B coupled to both ends of the coil 12A. The coil 12A and the capacitor 12B form a resonant circuit. The resonant frequency f₀ is expressed by the following formula (1).

$${f}_{0} = \frac{1}{2 π \sqrt{LC}} \qquad ( 1 )$$

Note that L is the inductance of the coil 12A, and C is the capacitance of the capacitor 12B.

The coil 12A of the primary-side resonant coil 12 is a one turn coil, for example. As the capacitor 12B, various types of capacitors can be used, but a capacitor with a small loss and a sufficient resistance to voltage is preferable. In the present embodiment, in order to make the resonant frequency variable, a variable capacitor is used as the capacitor 12B. As the variable capacitor, for example, a variable capacity device made by using a MEMS technology is used. The variable capacitor may also be a variable capacity device (varactor) using a semiconductor.

The primary-side coil 11 and the primary-side resonant coil 12 are placed to be electromagnetically coupled closely to each other. For example, the primary-side coil 11 and the primary-side resonant coil 12 are placed on the same plane and concentrically. That is, for example, they are placed in a state in which the primary-side coil 11 is fit into the inner circumference side of the primary-side resonant coil 12. Alternatively, the primary-side coil 11 and the primary-side resonant coil 12 may be placed coaxially with a suitable distance.

In this state, when an AC voltage is supplied from the AC power source 1 to the primary-side coil 11, a resonant current flows in the primary-side resonant coil 12 through electromagnetic induction due to an alternating magnetic field generated in the primary-side coil 11. That is, electric power is supplied from the primary-side coil 11 to the primary-side resonant coil 12 through electromagnetic induction.

A power receiving coil JC includes a secondary-side resonant coil 21 and a secondary-side coil 22. The secondary-side resonant coil 21 includes a coil 221 made by winding a metal wire such as a copper wire or an aluminum wire in a circumferential manner and a capacitor 222 coupled to both ends of the coil 221. The resonant frequency f₀ of the secondary-side resonant coil 21 is expressed by the above formula (1) based on the inductance of the coil 221, and the capacitance of the capacitor 222.

The coil 221 of the secondary-side resonant coil 21 is a one turn coil, for example. As the capacitor 222, various types of capacitors can be used as described above. In the present embodiment, in order to make the resonant frequency variable, a variable capacitor is used as the capacitor 222. As the variable capacitor, for example, a variable capacity device made by using a MEMS technology is used. The variable capacitor may also be a variable capacity device (varactor) using a semiconductor.

The secondary-side coil 22 is made by winding multiple turns of a metal wire such as a copper wire or an aluminum wire in a circumferential manner, and a battery 220 that is a load is coupled to both ends of the secondary-side coil 22.

The secondary-side resonant coil 21 and the secondary-side coil 22 are placed to be electromagnetically coupled closely to each other. For example, the secondary-side resonant coil 21 and the secondary-side coil 22 are placed on the same plane and concentrically. That is, for example, they are placed in a state in which the secondary-side coil 22 is fit into the inner circumference side of the secondary-side resonant coil 21. Alternatively, the secondary-side resonant coil 21 and the secondary-side coil 22 may be placed coaxially with a suitable distance.

In this state, when a resonant current flows in the secondary-side resonant coil 21, an electric current flow in the secondary-side coil 22 through electromagnetic induction due to an alternating magnetic field is generated by the resonant current. That is, through electromagnetic induction, electric power is transmitted from the secondary-side resonant coil 21 to the secondary-side coil 22.

In order to transmit electric power wirelessly through magnetic field resonance, the power transmitting coil SC and the power receiving coil JC are placed with each other within a suitable distance range such that their coil planes are parallel to each other and their coil axis centers correspond with each other or does not shift from each other so much, as illustrated in FIG. 25. For example, when the diameter of the primary-side resonant coil 12 and of the secondary-side resonant coil 21 is approximately 100 mm, the power transmitting coil SC and the power receiving coil JC are placed within a distance range of several hundreds of mm.

In the power transmitting system 500A illustrated in FIG. 25, a direction along the coil axis center KS is a main radiation direction of the magnetic field KK, and a direction going from the power transmitting coil SC to the power receiving coil JC is a power transmitting direction SH.

Here, when both the resonant frequency fs of the primary-side resonant coil 12 and the resonant frequency fj of the secondary-side resonant coil 21 match the frequency fd of the AC power source 1, the maximum electric power is transmitted. However, if those resonant frequencies fs and fj differ from each other, or the resonant frequencies fs and fj differ from frequency fd of the AC power source 1, the transmitted electric power decreases, and the efficiency decreases.

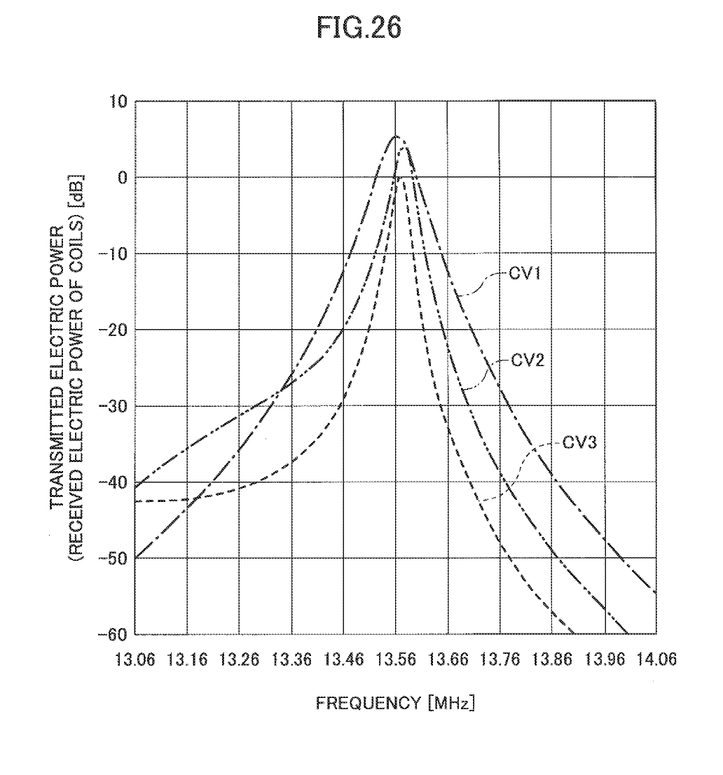

FIG. 26 is a diagram illustrating a frequency dependency of the power transmitting system.

That is, in FIG. 26, the horizontal axis is the frequency fd [MHz] of the AC power source 1, and the vertical axis is the magnitude of the transmitted electric power [dB]. The curve CV1 indicates a case in which the resonant frequency fs of the primary-side resonant coil 12 matches the resonant frequency fj of the secondary-side resonant coil 21. In this case, according to FIG. 26, the resonant frequencies fs and fj are 13.56 MHz.

Meanwhile, the curves CV2 and CV3 indicate cases in which the resonant frequency fj of the secondary-side resonant coil 21 is higher than the resonant frequency fs of the primary-side resonant coil 12 by 5% and 10%, respectively.

In FIG. 26, when the frequency fd of the AC power source 1 is 13.56 MHz, although the maximum electric power is transmitted in the curve CV1, the transmitted electric power sequentially decreases in the curves CV2 and CV3. Meanwhile, when the frequency fd of the AC power source 1 shifts from 13.56 MHz, the transmitted electric power decreases in all of the curves CV1 to CV3 except when slightly shifting upward.

Therefore, it is required to cause the resonant frequencies fs and fj of the primary-side resonant coil 12 and the secondary-side resonant coil 21 to match the frequency fd of the AC power source 1 as closely as possible.

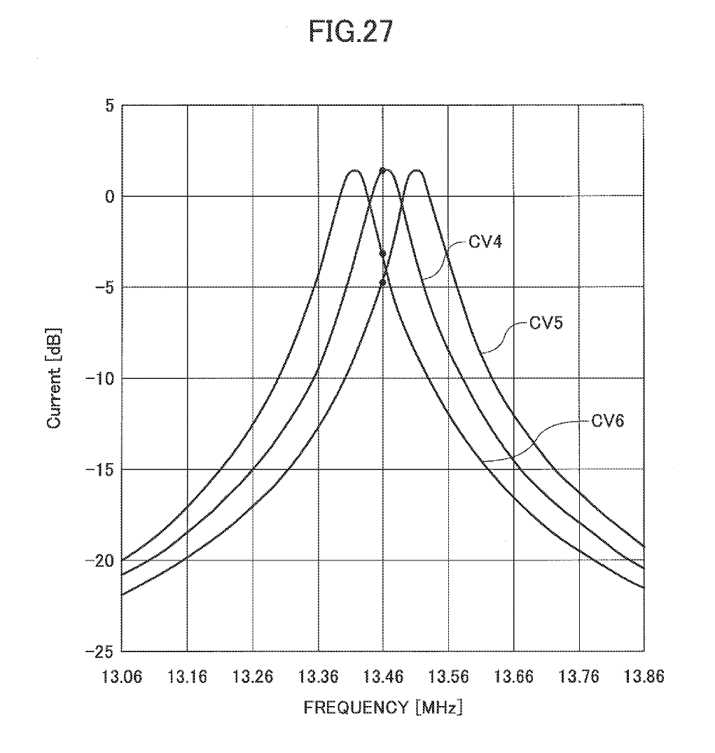

FIG. 27 is a diagram that describes a method of sweeping the resonant frequency of a coil.

In FIG. 27, the horizontal axis is the frequency [MHz] and the vertical axis is the magnitude [dB] of an electric current that flows in a coil. The curve CV4 indicates a case in which the resonant frequency of the coil matches the frequency fd of the AC power source 1. In this case, in FIG. 27, the resonant frequency is 10 MHz.

In addition, the curves CV5 and CV6 indicates cases in which the resonant frequency of the coil is higher or lower with respect to the frequency fd of the AC power source 1.

In FIG. 27, the maximum current flows in the case of the curve CV4, but the electric current is decreased in both cases of the curves CV5 and CV6. Note that when the Q factor of the coil is high, the effect of the deviation of the resonant frequency on the decrease in the electric current or the transmitted electric current is large.

Therefore, in the power transmitting system 500A according to the third variation example of the first embodiment, resonant frequency control is performed by the controller 310E and the controller 150E, using the phase φvs of the AC power source 1 and the phases φis and φij of electric current flowing in the primary-side resonant coil 12 and the secondary-side resonant coil 21.

Here, the controller 310E detects the phase φvs of the voltage Vs supplied to the power transmitting coil SC and the phase φis of the electric current Is that flows in the power transmitting coil SC, and varies the resonant frequency fs of the power transmitting coil SC such that the phase difference Δφs between them becomes a target value φms. Data indicating the target value φms is stored in an internal memory of the controller 152E, which will be described later below.

That is, the controller 310E includes an electric current detection sensor SE1, phase detectors 141 and 142, and a phase transmitter 145.

The electric current detection sensor SE1 detects the electric current Is that flows in the primary-side resonant coil 12. As the electric current detection sensor SE1, a Hall element, a magnetic resistant element, a detection coil or the like may be used. The electric current detection sensor SE1 outputs a voltage signal according to the waveform of the electric current Is, for example.

The phase detector 141 detects the phase φvs of the voltage Vs supplied to the primary-side coil 11. The phase detector 141 outputs, for example, a voltage signal according to the voltage Vs. In this case, the voltage Vs may be output without any changes, or may be output with voltage division by a suitable resistor to be output. Therefore, the phase detector 141 may be constituted by a simple electric wire, or by one or more resistors.

The phase detector 142 detects the phase φis of the electric current Is that flows in the primary-side resonant coil 12, based on the output from the electric current detection sensor SE1. The phase detector 142 outputs, for example, a voltage signal according to the waveform of the electric current Is. In this case, the phase detector 142 may output the output of the electric current detection sensor SE1 without any changes. Therefore, the electric current detection sensor SE1 may be configured to also act as the phase detector 142.

The phase transmitter 145 transmits information about the phase φvs of the voltage Vs supplied to the primary-side coil 11 to the controller 150E wirelessly, for example.

The phase transmitter 145 transmits, for example, a voltage signal in accordance with the waveform of the voltage Vs as an analog signal or a digital signal. In this case, in order to improve the S/N ratio, the voltage signal in accordance with the waveform of the voltage Vs may be multiplied by an integer and transmitted.

The controller 150E detects the phase φvs of the voltage VS supplied to the power transmitting coil SC and the phase φij of the electric current IJ that flows in the power receiving coil JC, and varies the resonant frequency fj of the power receiving coil JC such that the phase difference Δφj between the phase φvs and the phase φij becomes a predetermined target value φmj.

That is, the controller 150E includes a current detection sensor SE2, a phase receiver 241, and a phase detector 242.

The electric current detection sensor SE2 detects the electric current Ij that flows in the secondary-side resonant coil 21. As the electric current detection sensor SE2, a Hall element, a magnetic resistant element, a detection coil, or the like may be used. The electric current detection sensor SE2 outputs a voltage signal in accordance with the waveform of the electric current Ij, for example.

The phase receiver 241 receives information about the phase φvs transmitted from the phase transmitter 145, and outputs the received information. When the voltage signal has been multiplied in the phase transmitter 145, frequency dividing is performed to reset the voltage signal at the phase receiver 241. The phase receiver 241 outputs a voltage signal in accordance with the voltage Vs, for example.

The phase detector 242 detects the phase φij of the electric current Ij that flows in the secondary-side resonant coil 21, based on the output from the electric current detection sensor SE2. The phase detector 242 outputs, for example, a voltage signal in accordance with the waveform of the electric current Ij. In this case, the phase detector 242 may output the output of the electric current detection sensor SE2 without any changes. Therefore, the electric current detection sensor SE2 may be configured to also act as the phase detector 242.

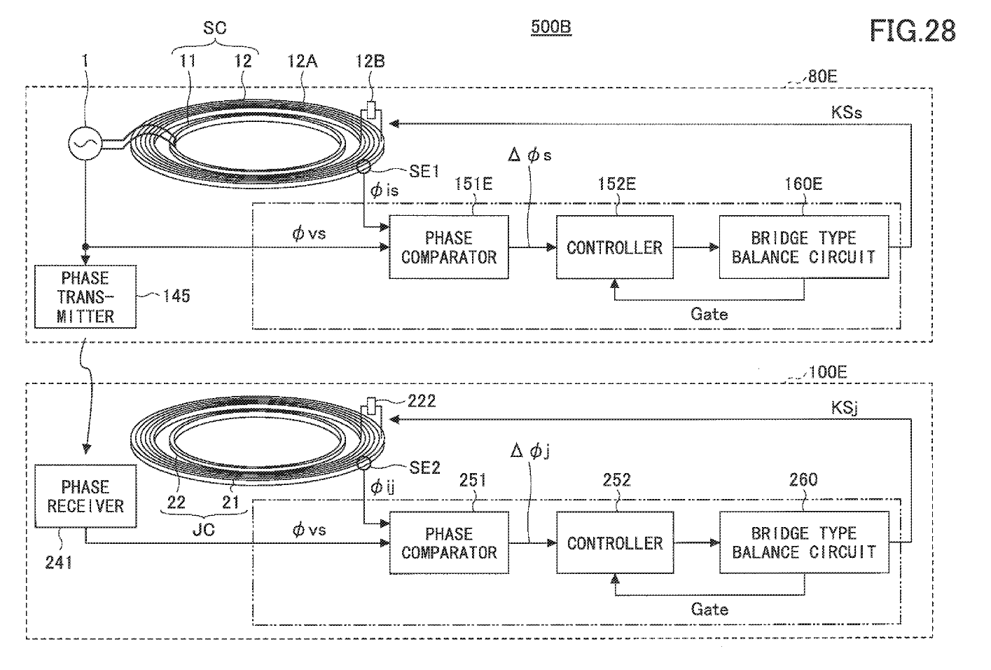

Hereinafter, more detailed descriptions will be provided with reference to FIG. 28. Note that in FIG. 28, the same numerals are assigned to the elements having the same function as the elements illustrated in FIG. 25, and their descriptions may be omitted or simplified.

FIG. 28 is a diagram illustrating an example of a controller configuration of the power transmitting system 500B according to the third variation example of the first embodiment.

In FIG. 28, the power transmitting system (power transmitting device) 500B includes a power transmitting apparatus 80E and a power receiver 100E.

The power transmitting apparatus 80E includes the AC power source 1, the power transmitting coil SC that includes the primary-side coil 11 and the primary-side resonant coil 12, a resonant frequency controller CTs, and the like.

The power receiver 100E includes the power receiving coil JC that includes the secondary-side resonant coil 21 and the secondary-side coil 22, a resonant frequency controller CTj, and the like.

The resonant frequency controller CTs at the power transmitting side includes the phase comparator 151E, the controller 152E, and a bridge type balance circuit 160E. The phase comparator 151E is an example of a phase detector or a second phase detector. The controller 152E is an example of a resonant frequency controller or a second resonant frequency controller. The bridge type balance circuit 160E is an example of a bridge circuit or a second bridge circuit.

The phase comparator 151E compares the phase φis of the electric current Is detected by the electric current detection sensor SE1 with the phase φvs of the voltage Vs of the AC power source 1, and outputs the phase difference Δφs, which is the difference between the phases.

The controller 152E sets and stores the target value φms of the phase difference Δφs. Therefore, an internal memory is provided in the controller 152E for storing the target value φms. As the target value φms, for example, “−π” or “a value obtained by adding an appropriate correction value a to −π”, or the like is set as described later below.

Note that the target value φms may be set by selecting from one or more sets of data stored in advance, or by a command from a CPU, a keyboard, or the like.

Based on the phase difference Δφs output by the phase comparator 151E and a gate signal Gate input from the bridge type balance circuit 160E, the controller 152E generates and outputs a driving signal for driving four switch elements SW1 to SW4 included in the bridge type balance circuit 160E such that the phase difference becomes the target value φms. Note that because the target value φms is set to be opposite with respect to the target phase difference Δφs, when the absolute values of the phase difference Δφs and the target value φms are the same, the sum of the phase difference Δφs and the target value φms is 0.

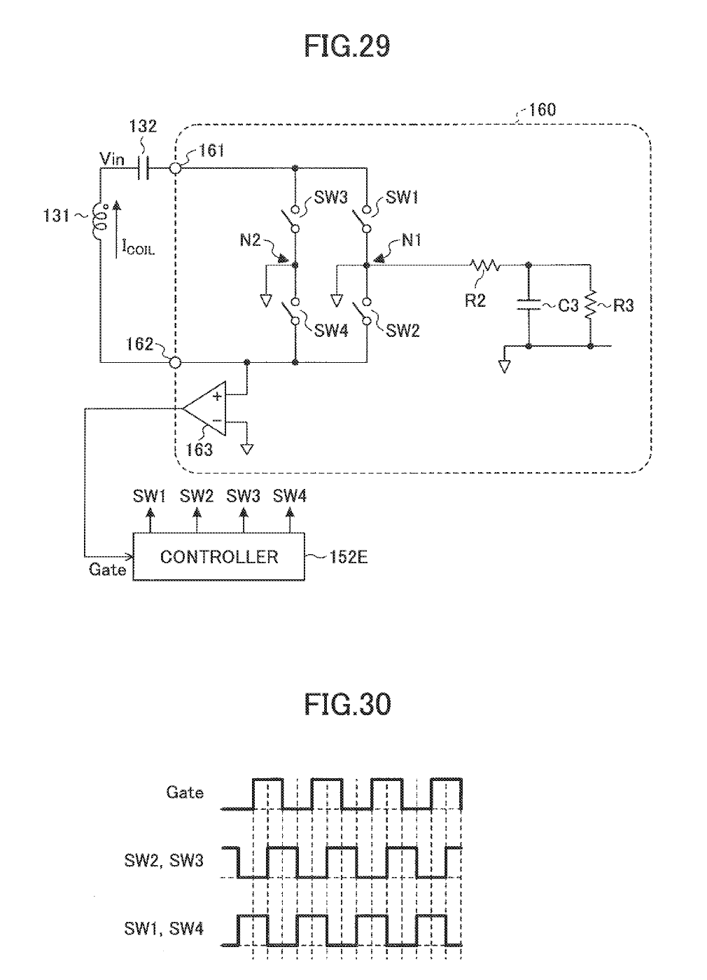

The bridge type balance circuit 160E shifts the resonant frequency of the coil 12A such that the phase difference output by the phase comparing section 151E becomes the target value φms based on the control signal input from the controller 152E. Note that a circuit configuration and an operation of the bridge type balance circuit 160E will be described later below with reference to FIG. 29 to FIG. 32.

The resonant frequency controller CTj at the power receiving side includes a target value setting unit, a phase comparator 251, a controller 252, and a bridge type balance circuit 260. The bridge type balance circuit 260 is an example of a first bridge circuit. The phase comparator 251 is an example of a first phase detector. The controller 252 is an example of a first resonant frequency controller.

The controller 252 sets and stores the target value φmj of the phase difference Δφj. As the target value φmj, for example, a value obtained by adding “−π/2” to the target value φms in the controller 310E is set as described later below. That is, “−3π/2” is set as the target value φmj. Alternatively, a value obtained by adding an appropriate correction value b to “−3π/2” or the like may be set. Note that a method of setting the target value φmj and the like are similar to those for the target value φms.

An operation and a configuration of each element of the resonant frequency controller CTj at the power receiving side are similar to the operation and the configuration of each element of the resonant frequency controller CTs at the power transmitting side described above.

Note that the controller 310E, the controller 150E, the resonant frequency controllers CTs and CTj, and the like in the power transmitting system 500A or 500B can be realized by software or hardware, or a combination of software and hardware. For example, a computer including a CPU, a memory such as a ROM and a RAM, and other peripheral elements may be used, and an appropriate computer program may be executed by the CPU. In that case, an appropriate hardware circuit may be used together.

FIG. 29 is a diagram illustrating a circuit configuration of the bridge type balance circuit 160E.

The bridge type balance circuit 160E includes terminals 161 and 162, a comparator 163, switch elements SW1, SW2, SW3 and SW4, resistors R2 and R3, and a capacitor C3.

The switch elements SW1, SW2, SW3 and SW4 are coupled in an H-bridge manner, a midpoint between the switch elements SW1 and SW2 is a node N1, and a midpoint between the switch elements SW3 and SW4 is a node N2. Further, the switch element SW1 and the switch element SW3 are coupled to the terminal 161, and the switch elements SW2 and SW4 are coupled to the terminal 162.

One end of the capacitor C3 and one end of the resistor R3 are coupled to the node N1 via the resistor R2. The resistor R3 and the capacitor C3 are coupled in parallel with each other. Note that the other end of the resistor R3 and the other end of the capacitor C3 are grounded.

The switch elements SW1 to SW4 are controlled on/off by a control signal input from the controller 152E.

The terminal 161 is coupled to one end of the capacitor 12B (the right side terminal in FIG. 29). The other end of the capacitor 12B (the left side terminal in FIG. 29) is coupled to one end of the coil 12A (the upper side terminal in FIG. 29). The terminal 162 is coupled to the other end of the coil 12A (the lower side terminal in FIG. 29).

The non-inverting input terminal of the comparator 163 is coupled between the terminal 162 and the switch elements SW2 and SW4, and the inverting input terminal of the comparator 163 is grounded. A voltage value indicating a coil current ICOIL flowing in the coil 12A is input to the non-inverting input terminal of the comparator 163.

Further, the output terminal of the comparator 163 is coupled to the controller 152E, and the comparator 163 is input to the non-inverting input terminal. The comparator 163 inputs, to the controller 152E, the gate signal Gate indicating the comparison result of the voltage value indicating the coil current ICOIL with the ground potential.

Such a bridge type balance circuit 160E performs control such that the output of the phase comparator 151E becomes zero in a case where duty cycles of the control signals SW1 to SW4 input from the controller 152E to the switch elements SW1 to SW4 are 50% and a phase difference between the control signals SW1 and SW4 and the control signals SW2 and SW3 is 180 degrees.

However, according to the present embodiment, the resonant frequency of the coil 12A is shifted by shifting the balance operating point of the bridge type balance circuit 160E such that the output of the phase comparator 151E becomes the target value φms.

Note that although FIG. 29 illustrates a circuit configuration of the bridge type balance circuit 160E, a circuit configuration of the bridge type balance circuit 260 is similar to that of the bridge type balance circuit 160E (see FIG. 25 and FIG. 28). In a case of the bridge type balance circuit 260, the capacitor 222 and the secondary-side resonant coil 22 are coupled instead of the capacitor 12B and the coil 12A, and the switch elements SW1 to SW4 are driven by the control signals SW1 to SW4 output from the controller 252. Hence, an illustration of the circuit configuration of the bridge type balance circuit 260 is omitted here.

FIG. 30 to FIG. 32 are diagrams illustrating waveforms of the control signals SW1 to SW4 for driving the bridge type balance circuit 160E according to the third variation example of the first embodiment.

FIG. 30 illustrates the gate signal Gate and the control signals SW1 to SW4. The gate signal Gate illustrated in FIG. 30 has signal levels obtained by binarizing a sinusoidal waveform of the coil current ICOIL having a predetermined resonant frequency flowing in the coil 12A into H level (‘1’) and L level (‘0’). Hence, the gate signal Gate is a signal whose duty cycle is 50%.

The controller 152E includes a phase shifter circuit and outputs the control signals SW2 and SW3 obtained by delaying the phase of the gate signal Gate by 90 degrees, and the control signals SW1 and SW4 obtained by respectively inverting the control signals SW2 and SW3.

Similar to the gate signal Gate, the duty cycles of the control signals SW1 to SW4 illustrated in FIG. 30 are 50%, and the phase difference between the control signals SW1 and SW4 and the control signals SW2 and SW3 is 180 degrees. FIG. 30 illustrates the control signals SW1 to SW4 for which control is performed such that the output of the phase comparator 151E becomes zero.

The bridge type balance circuit 160E simultaneously controls on/off of the switch elements SW1 and SW4 based on the control signals SW1 and SW4. Also, the bridge type balance circuit 160E simultaneously controls, based on the control signals SW2 and SW3, on/off of the switch elements SW2 and SW3 at phases opposite to those of the switch elements SW1 and SW4. Thereby, an operating point of the bridge type balance circuit 160E converges to a balance operating point determined depending on duty cycles or phases of the control signals SW1 to SW4.

According to the present embodiment, when the duty cycles of the control signals SW1 to SW4 are 50%, the operating point of the bridge type balance circuit 160E converges to the balance operating point realized by the control signals SW1 to SW4 of which the duty cycles are 50%. Thereby, the output of the phase comparator 151E becomes zero.

Also, when the duty cycles of the control signals SW1 to SW4 are 50%±Δ% (A≠0%), the operating point of the bridge type balance circuit 160E converges to the balance operating point realized by the control signals SW1 to SW4 of which the duty cycles are 50%±Δ %. The balance operating point in a case where the duty cycles are 50%±Δ % differs from the balance operating point in a case where the duty cycles are 50%.

According to the present embodiment, by setting the duty cycles of the control signals SW1 to SW4 to be 50%±Δ % to shift the balance operating point, control is performed such that the output of the phase comparator 151E becomes the target value φms.

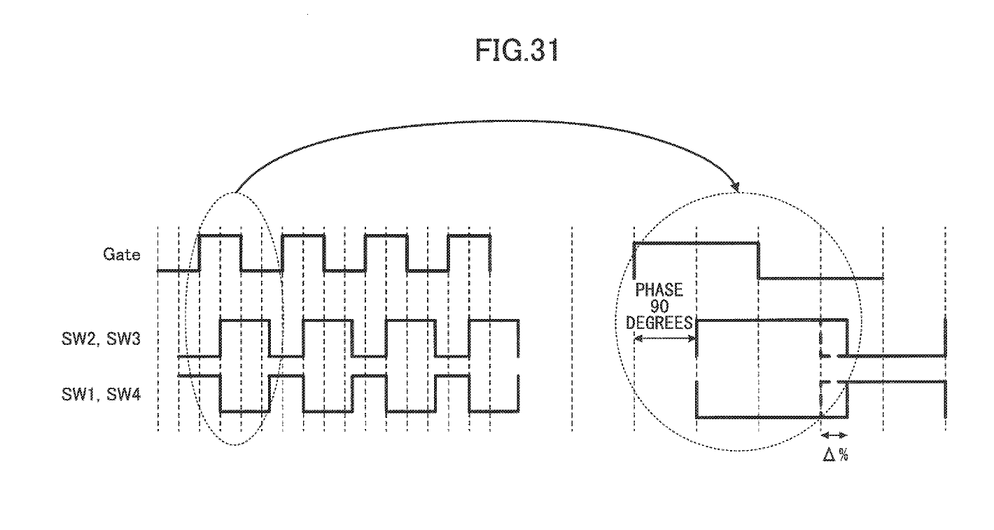

FIG. 31 illustrates waveforms of control signals SW1 to SW4 obtained by changing the duty cycles and fixing the phase difference with respect to the gate signal Gate.

As illustrated in the right part of FIG. 31, the controller 152E changes the duty cycles of the control signals SW1 to SW4. As a result, the ratio of on-periods to off-periods of the switch elements SW1 to SW4 of the bridge type balance circuit 160E is changed, and the resonant frequency of the coil 12A can be shifted. According to the present embodiment, the controller 152E changes the duty cycles of the control signals SW1 to SW4 such that the output of the phase comparator 151E becomes the target value φms.

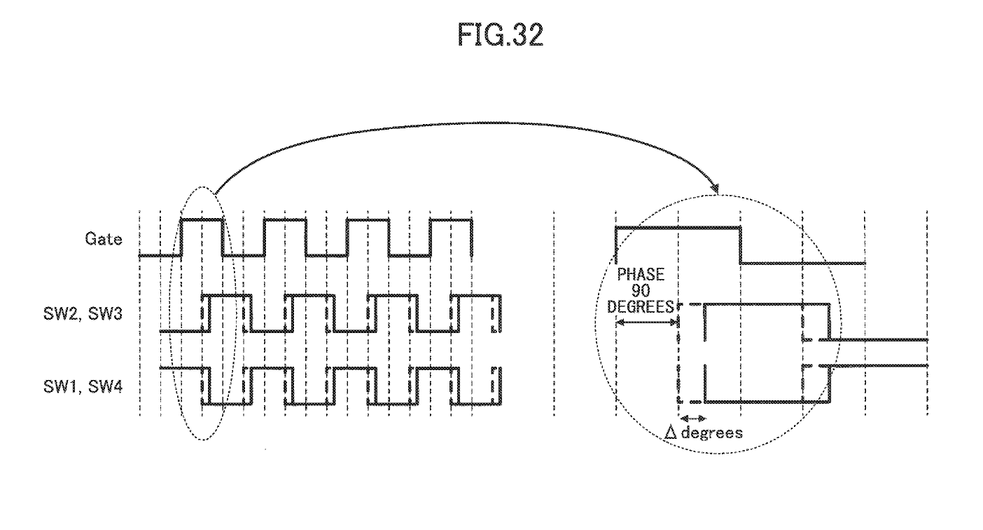

FIG. 32 illustrates waveforms of control signals SW1 to SW4 obtained by changing the phase difference and fixing the duty cycles with respect to the gate signal Gate.

As illustrated in the right part of FIG. 32, the controller 152E changes the phases of the control signals SW1 to SW4. As a result, the on/off timings of the switch elements SW1 to SW4 of the bridge type balance circuit 160E are changed, and the resonant frequency of the coil 12A can be shifted. According to the present embodiment, the controller 152E changes the duty cycles of the control signals SW1 to SW4 such that the output of the phase comparator 151E becomes the target value φms.

According to the present embodiment, the controller 152E changes the duty cycles or the phase difference of the control signals SW1 to SW4 with respect to the gate signal Gate to perform control such that an operating point at which the output of the phase comparator 151E becomes zero is shifted to an operating point at which the output of the phase comparator 151E becomes the target value φms.

As described above, by changing resonant conditions, the resonant frequency can be changed, and the distribution of electric power can be adjusted when there are a plurality of power receivers.

### Second Embodiment

A flowchart according to a second embodiment is obtained by changing a part of the flowchart of FIG. 13 according to the first embodiment.

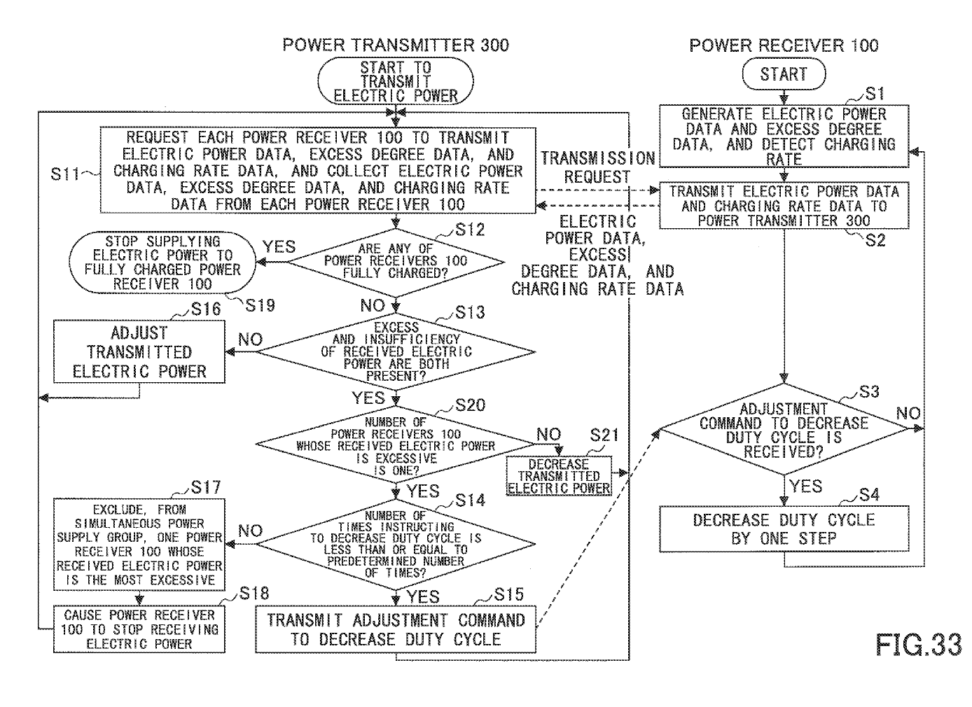

FIG. 33 is a flowchart illustrating a process that is executed by a power transmitter 300 and each power receiver 100 according to the second embodiment. Because configurations of the power transmitter 300 and the power receivers 100 are respectively similar to those of the power transmitter 300 and the power receivers 100 of the first embodiment, their descriptions are omitted here by incorporating the descriptions in the first embodiment.

Further, steps S1 to S19 illustrated in FIG. 33 are the same as steps S1 to S19 illustrated in FIG. 13. In the flowchart that is illustrated in FIG. 33, steps S20 and S21 are added to the flowchart that is illustrated in FIG. 13. Therefore, the same reference numerals are given to the same elements as those in the first embodiment, and the description thereof will be omitted as appropriate.

In the flowchart that is illustrated in FIG. 33, upon the controller 310 of the power transmitter 300 determining that both a power receiver 100 whose received electric power is excessive and a power receiver 100 whose received electric power is insufficient are present (YES in step S13), the flow goes to step S20.

The power transmitter 300 determines whether the number of power receivers 100 whose received electric power is excessive is one in step S20.

Upon determining that the number of power receivers 100 whose received electric power is excessive is one (YES in step S20), the power transmitter 300 causes the flow to go to step S14. Subsequently, a process similar to that of the flowchart of the first embodiment is performed.

Upon determining that the number of power receivers 100 whose received electric power is excessive is not one (YES in step S20), the power transmitter 300 decreases the transmitted electric power by predetermined electric power in step S21. This is because when there are a plurality of power receivers 100 whose received electric power is excessive, the balance for all the power receivers 100 may be improved by decreasing the transmitted electric power.

Upon completing the process of step S21, the power transmitter 300 returns the flow to step S11.

Therefore, similar to the first embodiment, according to the second embodiment, it is possible to provide the power transmitting system 500 and the power transmitter 300 that can efficiently charge power receivers 100.

When both a power receiver 100 whose received electric power is excessive and a power receiver 100 whose received electric power is insufficient are present and a plurality of power receivers 100 whose received electric power is excessive are present, the balance for all the power receivers 100 can be improved by decreasing the transmitted electric power.

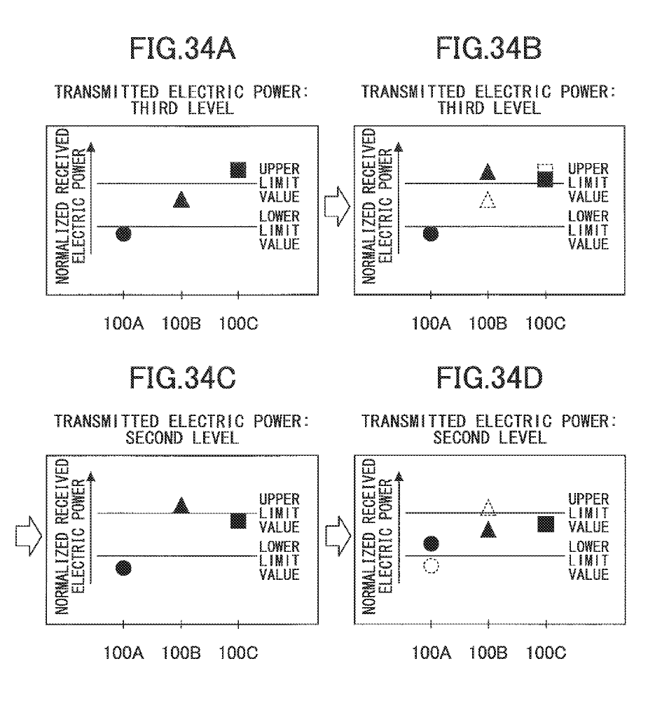

FIGS. 34A to 34D are diagrams illustrating a case in which received electric power of the power receivers 100 is adjusted by the power transmitter 300 and the power transmitting system 500 according to the second embodiment.

Similar to FIG. 14C, in FIG. 34A, the normalized received electric power of the power receiver 100A is lower than the lower limit value, the normalized received electric power of the power receiver 100B is between the lower limit value and the upper limit value, and the normalized received electric power of the power receiver 100C is higher than the upper limit value. That is, the received electric power for the power receiver 100A is insufficient, the received electric power for the power receiver 100B is appropriate, and the received electric power for the power receiver 100C is excessive.

In such a state, in the flowchart that is illustrated in FIG. 33, YES is determined in step S13, YES is determined in step S20, YES is determined in step S14, and thus the duty cycle of the power receiver 100C is decreased in step S15.

FIG. 34B illustrates a state in which the duty cycle of the power receiver 100C has been decreased from that in the state that is illustrated in FIG. 34A. Note that in FIG. 34B, the transmitted electric power is maintained at the third level.

In FIG. 34B, the normalized received electric power of the power receiver 100A does not change from that in FIG. 34B, the normalized received electric power of the power receiver 100B is greater than that in FIG. 34A, and the normalized received electric power of the power receiver 100C is lower than that in FIG. 34A.

In FIG. 34B, the normalized received electric power of the power receiver 100A is lower than the lower limit value, the normalized received electric power of the power receiver 100B is higher than the upper limit value, and the normalized received electric power of the power receiver 100C is higher than the upper limit value.

That is, the received electric power for the power receiver 100A is insufficient and the received electric power for each of the power receivers 100B and 100C is excessive.

In this case, in the flowchart that is illustrated in FIG. 33, YES is determined in step S13, NO is determined in step S20 and thus the transmitted electric power is decreased by the predetermined electric power in step S21.

FIG. 34C illustrates a state in which the transmitted electric power has been decreased from that in the state that is illustrated in FIG. 34B. Note that in FIG. 34C, the transmitted electric power is decreased to the second level.

In FIG. 34C, the normalized received electric power of the power receiver 100A is lower than the lower limit value, the normalized received electric power of the power receiver 100B is higher than the upper limit value, and the normalized received electric power of the power receiver 100C is between the lower limit value and the upper limit value. That is, the received electric power for the power receiver 100A is insufficient, the received electric power for the power receiver 100B is excessive, and the received electric power for the power receiver 100C is appropriate.

In such a state, in the flowchart that is illustrated in FIG. 33, YES is determined in step S13, YES is determined in step S20, YES is determined in step S14, and thus the duty cycle of the power receiver 100B is decreased in step S15.

FIG. 34D illustrates a state in which the duty cycle of the power receiver 100B has been decreased from that in the state that is illustrated in FIG. 34C. Note that in FIG. 34D, the transmitted electric power is maintained at the second level.

In FIG. 34D, the normalized received electric power of the power receiver 100C is between the lower limit value and the upper limit value. That is, the received electric power for each of the power receivers 100A, 100B, and 100C is appropriate.

Therefore, by adjusting the transmitted electric power of the power transmitter 300 and the duty cycles of the power receivers 100B and 100C, a state can be obtained in which all the power receivers 100A, 100B, and 100C can be charged at the same time.

### Third Embodiment

A flowchart according to a third embodiment is obtained by changing a part of the flowchart of FIG. 13 according to the first embodiment.

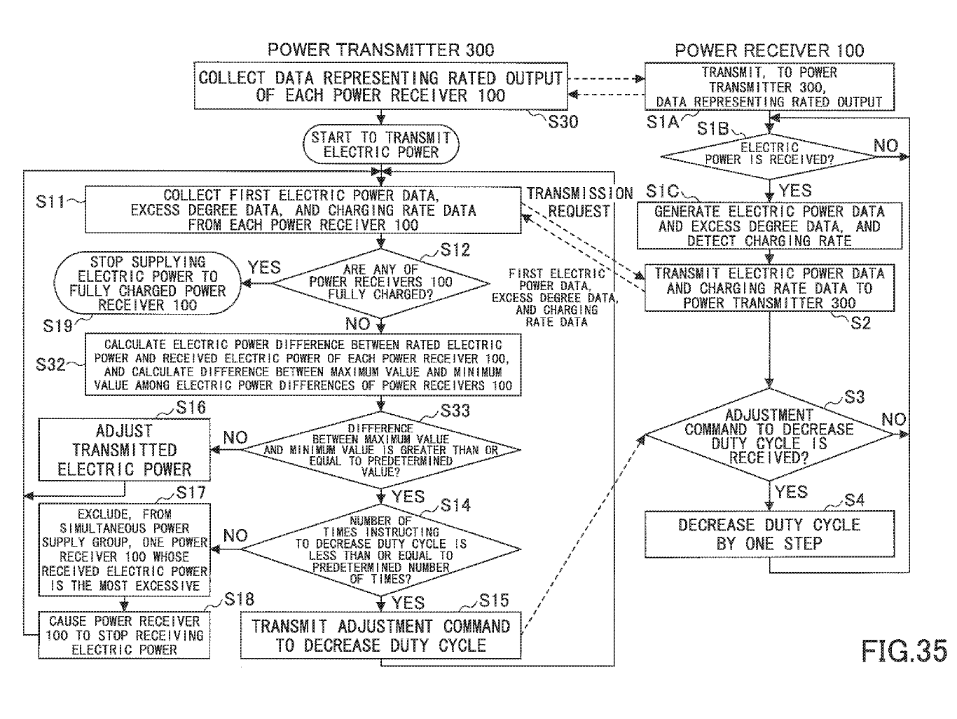

FIG. 35 is a flowchart illustrating a process that is executed by a power transmitter 300 and each power receiver 100 according to the third embodiment. Because configurations of the power transmitter 300 and the power receivers 100 are respectively similar to those of the power transmitter 300 and the power receivers 100, their descriptions are omitted here by incorporating the descriptions in the first embodiment.

Further, steps S2, S3, S4, S11, S12, and S14 to S19 illustrated in FIG. 35 are respectively similar to steps S2, S3, S4, S11, S12, and S14 to S19 illustrated in FIG. 13.

In the flowchart that is illustrated in FIG. 35, steps S1A, S1B, S30, S32, and S33 are added to the flowchart that is illustrated in FIG. 13. Therefore, the same reference numerals are given to the same elements as those in the first embodiment, and the description thereof will be omitted as appropriate.

Further, according to the third embodiment, electric power data includes first electric power data and second electric power data. In addition to data that indicates whether received electric power is excessive, appropriate, or insufficient, the first electric power data includes data that indicates the received electric power. The second electric power data includes data that indicates a rated output (rated electric power).

As a precondition for the third embodiment, the data that indicates the rated output (rated electric power) is stored in the memory 154 of each power receiver 100.

Before starting to transmit electric power, the power transmitter 300 collects data that indicates the rated output of each power receiver 100 in step S30. More specifically, the power transmitter 300 requests each power receiver 100 to transmit the data that indicates the rated output, and collects the data that indicates the rated output from each power receiver 100 in step S30. The data that indicates the rated output is the second electric power data, and is a part of electric power data.

Upon receiving, from the power transmitter 300, the request to transmit the data that indicates the rated output, each power receiver 100 transmits, to the power transmitter 300 in step S1A, the data that indicates the rated output stored in the memory 154.

Upon collecting the data that indicates the rated output from each power receiver 100, the power transmitter 300 starts to transmit electric power (START TO TRANSMIT ELECTRIC POWER).

Each power receiver 100 determines whether electric power has been received in step S1B. The process of step S1B is repeatedly executed until electric power reception is detected. For example, each power receiver 100 may determine whether electric power has been received by detecting the voltage of the secondary-side resonant coil 110.

Upon determining that electric power has been received (YES in step S1B), each power receiver 100 generates first electric power data and excess degree data, and detects a charging rate of the battery 220 in step S1C.

In step S11, the power transmitter 300 collects the first electric power data, the excess degree data, and the charging rate data from each power receiver 100.

Each power receiver 100 transmits in step S2, to the power transmitter 300, the first electric power data generated in step S1C and the charging rate data that indicates the detected charging rate, and determines in step S3 whether an adjustment command to decrease the duty cycle of the PWM drive pattern has been received.

In step S12, the power transmitter 300 determines whether any of the power receivers 100 are fully charged based on the charging rate data received from each power receiver 100. Upon determining that none of the power receivers 100 are fully charged (NO in step S12), the flow goes to step S32.

The power transmitter 300 calculates an electric power difference between the rated electric power and the received electric power of each power receiver 100 and further calculates the difference between the maximum value and the minimum value among the electric power differences of the plurality of respective power receivers 100 in step S32. The calculation in step S32 is executed by the main controller 320 of the power transmitter 300. The main controller 320 is an example of an electric power difference calculator. Note that the rated electric power (rated output) of each power receiver 100 has been collected by the power transmitter 300 in step S30, and the received electric power of each power receiver 100 is included in the first electric power data collected in step S11.

Subsequently, the power transmitter 300 determines whether the difference between the maximum value and the minimum value calculated in step S32 is greater than or equal to a predetermined value in step S33.

Upon determining that the difference between the maximum value and the minimum value calculated in step S32 is greater than or equal to the predetermined value (YES in step S33), the flow goes to step S14.

Upon determining that the difference between the maximum value and the minimum value calculated in step S32 is less than the predetermined value (NO in step S33), the flow goes to step S16.

Subsequently, a process similar to that of the flowchart of the first embodiment is performed.

Therefore it is possible to provide the power transmitting system 500 and the power transmitter 300 that can efficiently charge power receivers 100.

According to the process of the third embodiment that is illustrated in FIG. 35, a loop process, going from step S11 via steps S12, S32, S33, S14, and S15 to return to step S11, is repeatedly executed. Then, such that the difference between the maximum value and the minimum value calculated in step S32 is less than the predetermined value, the duty cycle(s) of the power receiver(s) 100 is decreased.

Then, after the difference between the maximum value and the minimum value calculated in step S32 becomes less than the predetermined value, the output of the power transmitter 300 is adjusted in step S16.

Hence, it is possible to prevent the power transmitter 300 from outputting transmitted electric power unable to be received by all power receivers 100 and to reduce loss of the transmitted electric power output from the power transmitter 300.

Note that the power transmitter 300 may receive electric power data that indicates an electric power difference between the received electric power and the rated output of each power receiver 100 in step S11, and may calculate in step S32 the difference between the maximum value and the minimum value among the plurality of electric power differences respectively indicated by the plurality of sets of electric power data received in step S11.

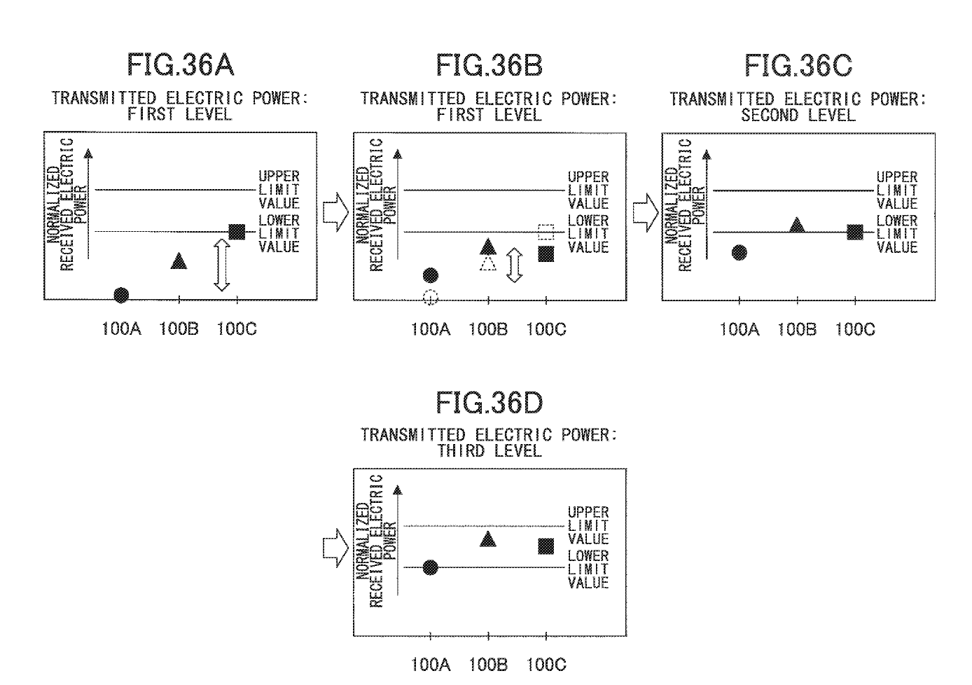

FIGS. 36A to 36D are diagrams illustrating cases in which received electric power of the power receivers 100 is adjusted by the power transmitter 300 and the power transmitting system 500 according to the third embodiment. In FIG. 36, similar to the first and second embodiments, three power receivers 100A, 100B, and 100C are used for description.

In FIG. 36A, the normalized received electric power of the power receiver 100A is the lowest, the normalized received electric power of the power receiver 100B is at an intermediate value, and the normalized received electric power of the power receiver 100C is the highest.

The normalized received electric power of the power receiver 100A and the normalized received electric power of the power receiver 100B are both lower than the lower limit value and the normalized received electric power of the power receiver 100C is at the lower limit value. That is, the received electric power for each of the power receivers 100A and 100B is insufficient, and the received electric power for the power receiver 100C is appropriate.

Note that the state that is illustrated in FIG. 36A is immediately after the power transmitter 300 starts transmitting electric power, and the transmitted electric power is at a predetermined low value. For this reason, the transmitted electric power is at the first level.

In such a state, in the flowchart that is illustrated in FIG. 35, YES is determined in step S33, YES is determined in step S14, and the duty cycle of the power receiver 100C is decreased in step S15. FIG. 36B illustrates a state in which the duty cycle of the power receiver 100C has been decreased from that in the state that is illustrated in FIG. 36A. Note that in FIG. 36B, the transmitted electric power is maintained at the first level.

Note that in the state that is illustrated in FIG. 36B, the difference between an electric power difference, between the rated electric power and the received electric power of the power receiver 100A, and an electric power difference, between the rated electric power and the received electric power of the power receiver 100B, is less than the predetermined value, which is used for determination in step S33.

In FIG. 36B, the normalized received electric power of each of the power receivers 100A and 100B is greater than that in FIG. 36A, and the normalized received electric power of the power receiver 100C is lower than that in FIG. 36A.

In FIG. 36B, all of the normalized received electric power of the power receivers 100A, 100B, and 100C are lower than the lower limit value. That is, the received electric power for each of the power receivers 100A, 100B, and 100C is insufficient.

Upon returning to step S11 and determining NO in step S33 of the flowchart that is illustrated in FIG. 35, the transmitted electric power of the power transmitter 300 is increased from the first level by the predetermined electric power in step S16. FIG. 36C illustrates a state in which the transmitted electric power has been increased from that in the state that is illustrated in FIG. 36B. In FIG. 36C, the transmitted electric power is at the second level.

In the state that is illustrated in FIG. 36C, the normalized received electric power of the power receiver 100A is lower than the lower limit value, and the normalized received electric power of each of the power receivers 100B and 100C is between the lower limit value and the upper limit value. That is, the received electric power for the power receiver 100A is insufficient, and the received electric power for each of the power receivers 100B and 100C is appropriate.

In such a state, in the flowchart that is illustrated in FIG. 35, NO is determined in step S33, and thus the transmitted electric power of the power transmitter 300 is further increased from the second level by the predetermined electric power in step S16. FIG. 36D illustrates a state in which the transmitted electric power has been increased from that in the state that is illustrated in FIG. 36C. In FIG. 36D, the transmitted electric power is at the third level.

In the state that is illustrated in FIG. 36D, the normalized received electric power of each of the power receivers 100A, 100B, and 100C is between the lower limit value and the upper limit value. That is, the received electric power for each of the power receivers 100A, 100B, and 100C is appropriate.

Therefore, by adjusting the transmitted electric power of the power transmitter 300 and the duty cycle of the power receiver 100C, a state can be obtained in which all the power receivers 100A, 100B, and 100C can be charged at the same time.

Although examples of the power transmitting system and the power transmitter according to the embodiments of the present invention have been described above, the present invention is not limited to the embodiments specifically disclosed and various variations and modifications may be made without departing from the scope of the present invention.

All examples and conditional language provided herein are intended for pedagogical purposes of aiding the reader in understanding the invention and the concepts contributed by the inventors to further the art, and are not to be construed as limitation to such specifically recited examples and conditions, nor does the organization of such examples in the specification relate to a showing of superiority and inferiority of the invention. Although one or more embodiments of the present invention have been described in detail, it should be understood that various changes, substitutions, and alterations could be made hereto without departing from the spirit and scope of the invention.

What is claimed is:

1. A power transmitting system comprising:
a power transmitter configured to transmit electric power; and
a plurality of power receivers configured to simultaneously receive the electric power from the power transmitter through magnetic field resonance or electric field resonance,
wherein each of the plurality of power receivers includes
a secondary-side resonant coil;
an adjuster configured to adjust an amount of electric power received by the secondary-side resonant coil; and
a power receiving side communication unit configured to perform communication with the power transmitter, and
wherein the power transmitter includes
a primary-side resonant coil configured to transmit, to the secondary-side resonant coil of each of the plurality of power receivers, the electric power through magnetic field resonance or electric field resonance;
a power transmitting side communication unit that is able to communicate with the plurality of power receivers;
a determination unit configured to determine, based on electric power data related to a rated electric power and received electric power received from each of the plurality of power receivers, whether a power receiver whose received electric power is excessive and a power receiver whose received electric power is insufficient are present; and
a command output unit configured, upon the determination unit determining that the power receiver whose received electric power is excessive and the power receiver whose received electric power is insufficient are present, to transmit, to the power receiver whose received electric power is excessive via the power transmitting side communication unit, a command to cause the adjuster to decrease the amount of the electric power.

2. The power transmitting system according to claim 1, wherein the electric power data is data that indicates whether the received electric power of the power receiver is excessive, appropriate, or insufficient.

3. The power transmitting system according to claim 1, wherein when the determination unit determines that the power receiver whose received electric power is excessive and the power receiver whose received electric power is insufficient are present and when a plurality of power receivers whose received electric power is excessive are present, the command output unit outputs, to the plurality of power receivers whose received electric power is excessive, the command.

4. The power transmitting system according to claim 1, wherein when the determination unit determines that the power receiver whose received electric power is excessive and the power receiver whose received electric power is insufficient are present and when a number of power receivers whose received electric power is excessive is one, the command output unit outputs, to the power receiver whose received electric power is excessive, the command.

5. The power transmitting system according to claim 4, wherein when the determination unit determines that the power receiver whose received electric power is excessive and the power receiver whose received electric power is insufficient are present and when a number of power receivers whose received electric power is excessive is not one, the command output unit decreases the electric power transmitted from the primary-side resonant coil.

6. A power transmitting system comprising:
a power transmitter configured to transmit electric power; and
a plurality of power receivers configured to simultaneously receive the electric power from the power transmitter through magnetic field resonance or electric field resonance,
wherein each of the plurality of power receivers includes
a secondary-side resonant coil;
an adjuster configured to adjust an amount of electric power received by the secondary-side resonant coil; and
a power receiving side communication unit configured to perform communication with the power transmitter, and
wherein the power transmitter includes
a primary-side resonant coil configured to transmit, to the secondary-side resonant coil of each of the plurality of power receivers, the electric power through magnetic field resonance or electric field resonance;
a power transmitting side communication unit that is able to communicate with the plurality of power receivers;
an electric power calculator configured to calculate, based on electric power data related to received electric power and rated electric power received from each of the plurality of power receivers via the power transmitting side communication unit, electric power differences for the plurality of respective power receivers, each of the electric power differences being a difference between the received electric power and the rated electric power;
a determination unit configured to determine whether a difference between a maximum value and a minimum value among the electric power differences calculated by the electric power calculator is greater than or equal to a predetermined value; and
a command output unit configured, upon the determination unit determining that the difference between the maximum value and the minimum value is greater than or equal to the predetermined value, to transmit, via the power transmitting side communication unit to a power receiver whose electric power difference is the maximum value, a command to cause the adjuster to decrease the amount of the electric power.

7. The power transmitting system according to claim 6, wherein the command output unit transmits the command to the power receiver whose electric power difference is the maximum value until the determination unit determines that the difference between the maximum value and the minimum value is less than the predetermined value.

8. The power transmitting system according to claim 1, wherein the command output unit excludes, from the plurality of power receivers that simultaneously receive the electric power, a power receiver, to which the command is transmitted a number of times greater than a predetermined number of times.

9. The power transmitting system according to claim 8, wherein the predetermined number of times is set to be a larger value as rated electric power of a power receiver is higher.

10. The power transmitting system according to claim 8, wherein the command output unit excludes, from among the plurality of power receivers that simultaneously receive the electric power, a power receiver whose electric power difference between the rated electric power and the received electric power is either maximum or minimum.

11. The power transmitting system according to claim 1, wherein as rated electric power of a power receiver is higher, the command output unit transmits a command whose degree of causing the adjuster to decrease the amount of the electric power is larger.

12. The power transmitting system according to claim 1,
wherein each of the power receivers includes a storage unit configured to store decrease degree data that indicates a degree by which the adjuster decreases the amount of the electric power, and
wherein the degree indicated by the decrease degree data is larger as rated electric power of a power receiver is higher.

13. The power transmitting system according to claim 1,
wherein each of the power receivers further includes
a rectifier circuit coupled to the secondary-side resonant coil and configured to rectify alternating-current power output from the secondary-side resonant coil;
a smoothing circuit coupled to an output side of the rectifier circuit; and
a switch inserted in series on a line between the rectifier circuit and the smoothing circuit and configured to switch a coupling state of the line, and
wherein the adjuster adjusts a duty cycle of a driving signal for PWM-driving the switch to adjust the amount of the electric power.

14. The power transmitting system according to claim 1,
wherein each of the power receivers further includes
a capacitor inserted in series in a resonant coil part of the secondary-side resonant coil;
a series circuit, coupled in parallel with the capacitor, of a first switch and a second switch;
a first rectifier coupled in parallel with the first switch, the first rectifier having a first rectification direction; and
a second rectifier coupled in parallel with the second switch, the second rectifier having a second rectification direction opposite to the first rectification direction; and
a detector configured to detect a voltage waveform or a current waveform of the electric power received by the secondary-side resonant coil, and
wherein the adjuster adjusts a phase difference between the voltage waveform or the current waveform detected by the detector and a driving signal that includes a first signal for switching on/off the first switch and includes a second signal for switching on/off the second switch to adjust the amount of the electric power.

15. The power transmitting system according to claim 1,
wherein each of the power receivers further includes a capacitor inserted in series with the secondary-side resonant coil;
wherein the adjuster adjusts capacitance of the capacitor to adjust the amount of the electric power.

16. A power transmitter for transmitting electric power to a plurality of power receivers, each of the plurality of power receivers including a secondary-side resonant coil; and an adjuster configured to adjust an amount of electric power received by the secondary-side resonant coil, the power transmitter comprising:
a primary-side resonant coil configured to transmit, to the secondary-side resonant coil of each of the plurality of power receivers, the electric power through magnetic field resonance or electric field resonance;
a power transmitting side communication unit that is able to communicate with the plurality of power receivers;
a determination unit configured to determine, based on electric power data about a rated electric power and received electric power received from each of the plurality of power receivers, whether a power receiver whose received electric power is excessive and a power receiver whose received electric power is insufficient are present; and
a command output unit configured, upon the determination unit determining that the power receiver whose received electric power is excessive and the power receiver whose received electric power is insufficient are present, to transmit, to the power receiver whose received electric power is excessive via the power transmitting side communication unit, a command to cause the adjuster to decrease the amount of the electric power.
